(19) United States
(12) Patent Application Publication
(10) Pub. No.: US 2025/0319945 A1
(43) Pub. Date: Oct. 16, 2025

(54) TRANSMISSION SYSTEM FOR A HUMAN-POWERED VEHICLE OR LIGHT ELECTRIC VEHICLE, SUCH AS A BICYCLE

(71) Applicant: Classified Cycling BV, Antwerpen (BE)

(72) Inventor: Roëll Marie VAN DRUTEN, Eindhoven (NL)

(21) Appl. No.: 19/065,877

(22) Filed: Feb. 27, 2025

Related U.S. Application Data
(63) Continuation of application No. PCT/EP2024/055002, filed on Feb. 27, 2024.
(63) Continuation of application No. PCT/EP2024/054997, filed on Feb. 27, 2024.

(30) Foreign Application Priority Data
Mar. 12, 2024 (NL) 2037237
Sep. 27, 2024 (NL) 2038731
Oct. 17, 2024 (NL) 2038860

(51) Int. Cl. B62M 23/00; B62M 1/36; B62M 6/55; B62M 9/131; B62M 25/08

(52) U.S. Cl. CPC B62M 23/00; B62M 25/08; B62M 1/36; B62M 6/55; B62M 9/131

(57) ABSTRACT

The disclosure relates to a bicycle transmission comprising a first transmission and a second transmission connected in series. The first transmission is multi-speed transmission operative between a transmission system input and a transmission system output. The second transmission is a multi-speed transmission. A transmission ratio step size between successive transmission ratios of the second transmission is smaller than a transmission ratio step size between successive transmission ratios of the first transmission.

### FIELD

The invention relates to a transmission for a human-powered vehicle or light electric vehicle, such as a bicycle, particularly an internal hub or crank transmission.

### BACKGROUND

Bicycle transmission systems traditionally include a derailleur for shifting a chain between a set of differently sized sprockets. More modern bicycle transmission systems include an internal transmission, wherein a gear mechanism is held by a housing. The housing can be arranged at the crank of the bicycle, or can be formed by a wheel hub shell of a bicycle driven wheel. Known gear mechanisms include a planetary transmission, and an actuatable clutch for changing a transmission ratio according to which the planetary transmission transmits rotary power.

### SUMMARY

It is an object to propose an improved transmission system for a human-powered vehicle or light electric vehicle, such as a bicycle, such as a bicycle hub transmission or a bicycle crank transmission. In a more general sense it is an object to overcome or ameliorate at least one of the disadvantages of the prior art, or at least provide alternative processes and structures that are more effective than the prior art. It is at the very least aimed to offering a useful choice and contribution to the existing art.

According to an aspect is provided a transmission system for a human-powered vehicle or light electric vehicle, such as a bicycle. The transmission system comprises a multi-speed first transmission operative between a transmission system input and a transmission system output. The transmission system comprises a multi-speed second transmission connected in series with the first transmission. The multi-speed second transmission may particularly be a two-speed transmission being selectively operable according to exactly two different transmission ratios, a three-speed transmission being selectively operable according to exactly three different transmission ratios or a four-speed transmission being selectively operable according to exactly four different transmission ratios. A transmission ratio step size between successive transmission ratios of the second transmission is smaller than a transmission ratio step size between successive transmission ratios of the first transmission. The second transmission can hence provide an intermediate transmission ratio step between successive transmission ratio steps of the first transmission. The transmission ratio step size between the transmission ratios of the second transmission may for example be approximately half of the transmission ratio step size between successive transmission ratios of the first transmission, in case the second transmission is a two-speed transmission. The transmission ratio step size between the transmission ratios of the second transmission may for example be approximately a third of the transmission ratio step size between successive transmission ratios of the first transmission, in case the second transmission is a three-speed transmission. The transmission ratio step size between the transmission ratios of the second transmission may for example be approximately a quarter of the transmission ratio step size between successive transmission ratios of the first transmission, in case the second transmission is a four-speed transmission.

The selected transmission ratio of the first transmission and the selected transmission ratio of the second transmission together determine the effective overall transmission ratio of the transmission system between the input and output of the transmission system, herein also referred to as the system transmission ratio.

It will be appreciated that each of the first transmission and the second transmission, being multi-speed transmissions, is selectively operable according to at least two different transmission ratios. Hence, an X-speed transmission, is selectively operable according to X, only X, different transmission ratios.

Optionally, the ratio-coverage of the first transmission is larger than the ratio-coverage of the second transmission. Preferably, the ratio-coverage of the first transmission is at least twice the ratio-coverage of the second transmission. The ratio-coverage of the first transmission can e.g. be at least 2.5 times, such as at least three times or at least four times, the ratio-coverage of the second transmission. The ration coverage of the first transmission can e.g. be 450% or more. Hence, very effectively a transmission with large ratio coverage, yet relatively small transmission ratio step sizes between transmission ratios of the transmission system can be provided.

Optionally, the second transmission is, at least partially, non-coaxial with the first transmission. In particular, the second transmission can be, at least partially, parallel and offset relative to the first transmission. For instance, a main rotation axis of the second transmission is, at least partially, non-coaxial, such as parallel and offset, with a main rotation axis of the first transmission. For instance, a central rotation axis of the second transmission is, at least partially, non-coaxial, such as parallel and offset, with a central rotation axis of the first transmission. The second transmission can include an offset gear transmission. The second transmission can include belt or chain transmission. The second transmission can include a continuously variable transmission, CVT. The second transmission can include a derailleur and sprockets. The second transmission can include a planetary gear system having a central axis offset relative to a central axis of the first transmission.

Optionally, the first transmission includes a planetary gear system. The planetary gear system can have three or more sun gears.

Optionally, the first transmission is a five-speed transmission, and the second transmission is a three-speed or four-speed transmission. Optionally, the first transmission is a seven-speed transmission, and the second transmission is a two-speed transmission. Optionally, the first transmission is a nine-speed transmission, and the second transmission is a two-speed transmission.

Optionally, the first transmission has more different ratios than the second transmission.

Optionally, the first transmission has at least twice as much different ratios than the second transmission.

Optionally, first transmission has four or more different ratios and the second transmission has four or less different ratios. In particular, the second transmission can have only two different ratios.

Optionally, the first transmission includes a speed reducing and/or a speed increasing transmission ratio, preferably both a speed reducing and speed increasing transmission ratio.

Optionally, the first transmission comprises or is an integrated hub transmission.

Optionally, the first transmission is integrated in a crank unit.

Optionally, the first transmission is placed laterally offset relative to a crank axle of the crank unit.

Optionally, the second transmission comprises a plurality of sprockets. Optionally, the second transmission comprises at least two sprockets and at most four sprockets. Optionally, the second transmission comprises an endless drive member, such as a chain or belt, configured to be engaged with either one of these sprockets. The sprockets can be mounted around an axis, e.g. coinciding with a wheel axis of the vehicle. The sprockets can be comprised by a cassette.

Optionally, the second transmission is integrated in a crank unit.

Optionally, the second transmission is concentric with the crank axle of the crank unit.

Optionally, the second transmission comprises, or is, an offset gear stage. The offset gear stage can have a first axis concentric with the crank axle and a second axis offset relative to the crank axle. The first transmission can be concentric with the second axis. The first axis can be an input of the second transmission, and the second axis can be an output of the second transmission. The first axis can be an output of the second transmission, and the second axis can be an input of the second transmission.

Optionally, the first transmission comprises or is an integrated hub transmission, and the second transmission comprises at least two sprockets and an endless drive member, such as a chain or belt, selectively engaged with either one of these sprockets.

Optionally, the first transmission comprises, or is, an integrated hub transmission, and the second transmission comprises an integrated crank transmission.

Optionally, the first transmission comprises, or is, an integrated crank transmission, and the second transmission comprises at least two sprockets and an endless drive member, such as a chain or belt, selectively engaged with either one of these sprockets.

Optionally, the first transmission and the second transmission are integrated in an integrated crank transmission.

Optionally, the transmission system comprises an electric propulsion motor. The electric propulsion motor can be connected to the input of the first transmission. The electric propulsion motor can be connected to the input of the second transmission. The electric propulsion motor can be connected to the output of the first transmission. The electric propulsion motor can be connected to the input of the second transmission.

The electric propulsion motor can be integrated in the crank unit. The electric propulsion motor can e.g. be mounted concentric with the crank axle.

The electric propulsion motor can be mounted concentric with a hub axle.

Optionally, the first transmission comprises or is an integrated hub transmission, the second transmission comprises at least two sprockets and an endless drive member, such as a chain or belt, selectively engaged with either one of these sprockets, and the electric propulsion motor is placed in the crank unit.

Optionally, the first transmission comprises, or is, an integrated hub transmission, and the second transmission and the electric propulsion motor are integrated in the crank unit.

Optionally, the first transmission and the electric propulsion motor are integrated in the crank unit, and the second transmission comprises at least two sprockets and an endless drive member, such as a chain or belt, selectively engaged with either one of these sprockets.

Optionally, the first transmission, the second transmission, and the electric propulsion motor are integrated in the crank unit.

Optionally, the sprockets are divided in segments and the segments can be actuated to shift the endless drive member from one of the sprockets to another.

Optionally, the at least two sprockets each have between 16 and 32, such as between 20 and 28, teeth. Optionally, the at least two sprockets have a teeth difference of at least two teeth and at most three teeth. Hence, a first sprocket has either two or three teeth more than a second sprocket. Preferably a first of two adjacent sprockets has either two or three teeth more than a second of the two adjacent sprockets. Optionally, the transmission system comprises not more or less than two sprockets, a first of the two adjacent sprockets having either two or three teeth more than a second of the two adjacent sprockets.

Optionally, the at least two sprockets have 21 and 24 teeth, or 22 and 25 teeth, or 23 and 26, or 25 and 28 teeth. Optionally, the at least two sprockets have 21 and 24 teeth, or 22 and 25 teeth, or 23 and 26, or 25 and 28 teeth. Optionally, a first of two adjacent sprockets has 22 teeth and a second of two adjacent sprockets has 25 teeth. Optionally, a first of two adjacent sprockets has 23 teeth and a second of two adjacent sprockets has 26 teeth. Optionally, a first of two adjacent sprockets has 25 teeth and a second of two adjacent sprockets has 28 teeth. Optionally, the transmission system comprises not more or less than two sprockets, the two sprockets having 21 and 24 teeth, or 22 and 25 teeth, or 23 and 26 teeth, or 25 and 28 teeth.

Optionally, the second transmission comprises a derailleur wheel, which derailleur wheel can be actuated to shift the endless drive member from one of the sprockets to another. Hence, the endless drive member can be selectively engaged with either one of the sprockets.

Optionally, the second transmission comprises a chain guide, which chain guide can be actuated to shift the endless drive member from one of the sprockets to another.

Optionally, the sprockets of the second transmission are connected to an input of the first transmission. Optionally, the sprockets of the second transmission are connected to a driver of the first transmission. The driver can form the input of the first transmission.

Optionally, the first transmission is located in or at a hub.

Optionally, the sprockets of the second transmission are connected to an output of the first transmission. Optionally, the sprockets of the second transmission are connected, such as via the endless drive member, to a chainring of the first transmission. The chainring can form the output of the first transmission.

Optionally, the first transmission is located near or around a crank.

Optionally, the derailleur wheel and/or the chain guide is movable in axial direction with respect to the sprockets. The derailleur wheel can e.g. be movable in axial direction with respect to a frame of the vehicle. The derailleur wheel can e.g. be movable in axial direction with respect to the wheel axis of the vehicle.

Optionally, wherein the derailleur wheel and/or the chain guide is movable in axial direction with respect to the sprockets between two end positions.

Optionally, a force for movement of the derailleur wheel and/or the chain guide in axial direction is created by a rotation of the derailleur wheel.

Optionally, movement of the derailleur wheel and/or the chain guide in axial direction is initiated by an electric actuator.

Optionally, the electric actuator is configured to be wirelessly controlled.

Optionally, the electric actuator is powered by an electric power storage element, such as a, e.g. small, battery or an ultra-capacitor.

Optionally, the electric actuator is powered via an electric wire by an electric power storage element of an E-bike propulsion battery.

Optionally, the transmission system comprises a solar cell electrically connected to the electric power storage element for charging the electric power storage element.

Optionally, the transmission system comprises a tensioner for tensioning the endless drive member.

Optionally, the tensioner includes the derailleur wheel.

Optionally, the tensioner is the derailleur wheel.

Optionally, the tensioner includes a tensioning wheel.

Optionally, at least one of the derailleur wheel and the tensioning wheel is movable in axial direction with respect to the sprockets. The at least one of the derailleur wheel and the tensioning wheel can e.g. be movable in axial direction with respect the frame. The at least one of the derailleur wheel and the tensioning wheel can e.g. be movable in axial direction with respect the wheel axis.

Optionally, the tensioner comprises a base member.

Optionally, the base member is movable in axial direction with respect to the sprockets. The base member can e.g. be movable in axial direction with respect to the frame. The base member can e.g. be movable in axial direction with respect to the wheel axis.

Optionally, the base member is rotatable with respect to the frame.

Optionally, the base member is rotatable with respect to the frame, but not axially movable with respect to the frame.

Optionally, the electric actuator is connected to the base member.

Optionally, a battery, controller, wireless electronics, and/or antenna of the electric actuator is connected to the base member.

Optionally, a battery, controller, wireless electronics, and/or antenna is connected to the base member.

Optionally, the derailleur wheel is rotatably mounted to the base member.

Optionally, the tensioning wheel is rotatably mounted to the base member.

Optionally, the derailleur wheel is rotatably mounted to the base member, and the tensioning wheel is rotatably mounted to the base member.

Optionally, one of, such as each of, the derailleur wheel and the tensioning wheel have between 10 and 20, preferably between 12 and 18, teeth.

Optionally, the tensioner is configured to be connected to the frame of the vehicle.

Optionally, the tensioner is configured to be connected to a dropout of the vehicle.

Optionally, the tensioner is configured to rotate with respect to the frame of the vehicle.

Optionally, the tensioner is configured to rotate with respect to the dropout of the vehicle.

Optionally, the transmission system comprises a damper for damping a rotating of the tensioner with respect to the frame in at least one rotational direction, or in both rotational directions.

Optionally, the transmission system comprises a damper for damping a rotating of the tensioner with respect to the dropout in at least one rotational direction, or in both rotational directions.

Optionally, the tensioner is configured to allow removal of a driven wheel from the vehicle.

Optionally, the first transmission having a planet carrier carrying a stepped planet gear with a plurality of planet radii, a plurality of sun gears respectively cooperating with the plurality of planet radii, and a ring gear cooperating with at least one of the plurality of planet radii.

Optionally, the transmission system comprises a switching mechanism arranged for being adjustable between a first state for establishing a torque transmission path from the transmission system input to the ring gear and from the planet carrier to the transmission system output, and a second state for establishing a torque transmission path from the transmission system input to the planet carrier and from the ring gear to the transmission system output.

According to an aspect is provided a transmission system for a human-powered vehicle or light electric vehicle, such as a bicycle, comprising a multi-speed planetary first transmission operative between a transmission system input and a transmission system output, wherein the first transmission has a planet carrier carrying a stepped planet gear with a plurality of planet radii, a plurality of sun gears respectively cooperating with the plurality of planet radii, and a ring gear cooperating with at least one of the plurality of planet radii. The transmission optionally comprises a switching mechanism arranged for being adjustable between a first state for establishing a torque transmission from the transmission system input to the ring gear and from the planet carrier to the transmission system output, and a second state for establishing a torque transmission from the transmission system input to the planet carrier and from the ring gear to the transmission system output. The transmission system further comprises a multi-speed second transmission connected in series with the first transmission. The multi-speed second transmission may particularly be a two-speed transmission being selectively operable according to exactly two different transmission ratios, a three-speed transmission being selectively operable according to exactly three different transmission ratios or a four-speed transmission being selectively operable according to exactly four different transmission ratios. A transmission ratio step size between successive transmission ratios of the second transmission is smaller than a transmission ratio step size between successive transmission ratios of the first transmission. The second transmission can hence provide an intermediate transmission ratio step between successive transmission ration steps of the first transmission. The transmission ratio step size between the transmission ratios of the second transmission may for example be approximately half of the transmission ratio step size between successive transmission ratios of the first transmission, in case the second transmission is a two-speed transmission. The transmission ratio step size between the transmission ratios of the second transmission may for example be approximately a third of the transmission ratio step size between successive transmission ratios of the first transmission, in case the second transmission is a three-speed transmission. The transmission ratio step size between the transmission ratios of the second transmission may for example be approximately a quarter of the transmission ratio step size between successive transmission ratios of the first transmission, in case the second transmission is a four-speed transmission.

The selected transmission ratio of the first transmission and the selected transmission ratio of the second transmission together determine the effective overall transmission ratio of the transmission system between the input and output of the transmission system, herein also referred to as the system transmission ratio.

It will be appreciated that the first transmission and the second transmission, being multi-speed transmissions, are selectively operable according to at least two different transmission ratios. Hence, an X-speed transmission, is selectively operable according to X, only X, different transmission ratios.

For this aspect, and the preceding aspect, the following applies.

The first transmission may be a suitable transmission as such for an electrically propellable bicycle or a city bicycle. The transmission ratio step size between successive transmission ratios of the first transmission may for example be approximately in a range of 18%-40%, such as 18%-30%. Hence, the first transmission is, by itself, usable as a proper multi-speed transmission in a bicycle.

The second transmission can be used as an optional add-on to provide intermediate shift steps between the successive transmission ratios of the first transmission, such as for bicycles without electric propulsion means or sports bicycles. The transmission ratio step size between the successive transmission ratios of the second transmission may for example be approximately in a range of 5%-20%, such as 8%-15%.

Optionally, a range of the first transmission, defining the difference in transmission ration between the smallest transmission ratio and the largest transmission ration of the first transmission, is between 300%-600%. Hence, the transmission system can be provided with a large range, and still be provided with relatively small transmission ratio steps between the system transmission ratios.

Optionally, the first transmission includes a 1:1 ratio.

Further, if the second transmission is a two-speed transmission, shifting the transmission system from a current transmission ratio to any other transmission ratio could involve either a single shift with the second transmission, or no shift with the second transmission at all.

Optionally, the first transmission is selectively operable according to more transmission ratios than the second transmission. The second transmission may for example be operable according to at most four different transmission ratios, such as at most three different transmission ratios, such as at most two different transmission ratios. The first transmission can e.g. be operable according to five, six, seven, eight, nine, ten, eleven, twelve, or more different transmission ratios.

Optionally, the transmission system comprises a control unit configured to upshift and/or downshift the transmission system. The control unit can be configured to upshift and/or downshift the transmission system to the next higher or next lower system transmission ratio according to an upshift sequence through the system transmission ratios, and/or a downshift sequence through the system transmission ratios. The upshift and/or downshift sequence can comprise a synchronous shift step of synchronously changing the transmission ratio of the first transmission and the transmission ratio of the second transmission, and a non-synchronous shift step of selectively changing either the transmission ratio of the first transmission or the transmission ratio of the second transmission.

Optionally, the upshift and/or downshift sequence comprises alternatingly the synchronous shift step and the non-synchronous shift step. This can particularly apply when the second transmission is a two-speed transmission.

Optionally, the control unit is configured to operate in a manual shifting mode, in which the control unit is configured to upshift and/or downshift the transmission system in response to receiving a user-initiated upshift and/or downshift command. The user-initiated command can be receive from one or more shifters.

Optionally, the control unit is configured to, in the manual shifting mode, upshift and/or downshift the first transmission in response to a user-initiated upshift and/or downshift command received from a first shifter, and to upshift and/or downshift the second transmission in response to a user-initiated upshift and/or downshift command received from a second shifter. Thus independent control of the first transmission and the second transmission can be provided to the user. Alternatively, or in a different mode, the control unit can be configured to, in the manual shifting mode, upshift and/or downshift the first and/or second transmission in response to a user-initiated upshift and/or downshift command received from a first shifter. Herein, the control unit can determine which one or both of the first and second transmissions is to be controlled, based on the current system transmission ratio and a target system transmission ratio to be upshifted or downshifted to.

Optionally, the control unit is configured to operate in an automatic shifting mode, in which the control unit is configured to automatically upshift and/or downshift the transmission system in response to determining a difference between a measured cadence and a target cadence. Herein, the control unit can determine which one or both of the first and second transmissions is to be controlled, based on the current system transmission ratio and the target system transmission ratio to be upshifted or downshifted to. The target system transmission ratio to be upshifted or downshifted to can be determined on the basis of the measured current cadence and the target cadence. The target system transmission ratio can be determined as the system transmission ratio that will result in the cadence, after the projected upshift or downshift, closest to the target cadence. The control unit may be biased to determine the target system transmission ratio as the system transmission ratio that will result in the cadence, after the projected upshift or downshift, closest to the target cadence, and higher than or equal to the target cadence. The control unit may be biased to determine the target system transmission ratio as the system transmission ratio that will result in the cadence, after the projected upshift or downshift, closest to the target cadence, and lower than or equal to the target cadence. The target system transmission ratio can be determined as a system transmission ratio that will result in the cadence, after the projected upshift or downshift, within a target cadence interval.

Optionally, the control unit is configured to, in the automatic shifting mode, determine to execute a fast automatic shifting mode if a measured acceleration of the vehicle is higher than a predetermined acceleration threshold or to execute a slow automatic shifting mode if the measured acceleration of the vehicle is lower than the predetermined acceleration threshold. The control unit can be configured to, in the fast automatic shifting mode, automatically upshift and/or downshift the transmission system in response to determining a difference between a measured cadence and a target cadence, by skipping system transmission ratios by only actuating the first transmission. Hence, a fast change of cadence can be achieved. Herein, the control unit may be configured to, in the fast automatic shifting mode, actuate the second transmission for fine-tuning the measured cadence towards the target cadence. This is especially helpful if the fast change of cadence, achieved by only shifting the first transmission, results in a cadence that could be changed to a cadence closer to the target cadence by shifting the second transmission. It will be clear that the second transmission can be actuated before, after, or during, actuating the first transmission. It will be appreciated that it is possible that the first transmission is configured to perform an upshift and/or downshift action faster than the second transmission performs an upshift and/or downshift action. For instance, optionally the first transmission comprising, or being, an integrated hub transmission or an integrated crank transmission can perform an upshift and/or downshift action faster than the second transmission comprising two or more sprockets and a derailleur can perform an upshift and/or downshift action.

Optionally, the control unit is configured to, in the slow automatic shifting mode, automatically upshift and/or downshift the transmission system in response to determining a difference between a measured cadence and a target cadence, by not skipping system transmission ratios. Hence, in the slow automatic shifting mode, the control unit can control the first and second transmissions to shift through consecutive system transmission ratios to the target system transmission ratio.

Optionally, the control unit is configured to operate in a semi-automatic shifting mode, in which the control unit is configured to upshift the first and/or second transmission in response to user-initiated upshift commands, and to automatically downshift the transmission system in response to determining a difference between a measured cadence and a target cadence. The control unit can be configured to, in the semi-automatic shifting mode, automatically downshift the transmission system in response to determining a difference between a measured cadence and a target cadence, by skipping system transmission ratios by only actuating the first transmission. Herein, the control unit may be configured to, in the semi-automatic shifting mode, actuate the second transmission for fine-tuning the measured cadence towards the target cadence.

More generally, according to an aspect is provided a transmission system for a human-powered vehicle or light electric vehicle, such as a bicycle, comprising a multi-speed planetary first transmission operative between a transmission system input and a transmission system output, the first transmission having a planet carrier carrying a stepped planet gear with a plurality of planet radii, a plurality of sun gears respectively cooperating with the plurality of planet radii, and a ring gear cooperating with at least one of the plurality of planet radii; and a multi-speed second transmission connected in series with the first transmission; wherein a transmission ratio step size between successive transmission ratios of the second transmission is smaller than a transmission ratio step size between successive transmission ratios of the first transmission. It will be appreciated that the above and below features and options also apply to the transmission system of this aspect.

Another aspect provides a method for shifting a transmission system as described herein from a current system transmission ratio to a target system transmission ratio, wherein the first transmission is selectively operable according to N different first transmission ratios, wherein the second transmission is selectively operable according to M different second transmission ratios, and wherein the transmission system is selectively operable according to N*M different system transmission ratios. The method comprises successively upshifting or downshifting the first transmission through the first transmission ratios by a first integer number of transmission ratio steps; successively upshifting or downshifting the second transmission through the second transmission ratios by a second integer number of transmission ratio steps; wherein for any current system transmission ratio and for any target system transmission ratio within the N*M system transmission ratios, the second integer number is at most M−1. Hence, the transmission system can be efficiently shifted with a minimal number shift actions steps, particularly when changing the system transmission ratio by multiple steps at once. The method particularly prevents needlessly repetitive cycling through the first or second transmission ratios when a multi-step shift action is commanded. N is preferably larger than M. M may for example be equal to two, three or four. N may for example be equal to three, four, five, six, seven, eight, nine, ten, eleven, twelve or thirteen or more.

Preferably, the second integer number of steps upshifting or downshifting the second transmission through the second transmission ratios includes only upshifting or only downshifting the second transmission, during the shifting the transmission system from the current system transmission ratio to the target system transmission ratio.

Optionally, the second transmission is upshifted or downshifted by the second integer number of steps, after the first transmission has been upshifted or downshifted by the first integer number of steps. Hence, the system transmission ratio can be quickly increased or decreased by the relatively large increments of the first transmission (skipping in-between transmission ratios that could have been formed using the second transmission), and subsequently fine-tuned by the relatively small increments of the second transmission.

Optionally, the first transmission is upshifted or downshifted by the first integer number of steps, after the second transmission has been upshifted or downshifted by the second integer number of steps.

Optionally, one or more of the first integer number of steps, is performed between two of the second integer number of steps, and/or one or more of the second integer number of steps, is performed between two of the first integer number of steps.

Optionally, the method comprises receiving a first operational shifter input for controlling a selection of gears of the first transmission and receiving a second operational shifter input for controlling the selection of gears of both the first and second transmission. Hence, the first operational shifter, e.g. mounted to a handlebar, can be used to specifically control the first transmission and the second operational shifter, e.g. mounted to the handlebar, can be used to control both the first transmission and the second transmission, e.g. simultaneously. Alternatively, the method comprises receiving a first operational shifter input for controlling a selection of gears of the second transmission and receiving a second operational shifter input for controlling the selection of gears of both the first and second transmission.

Optionally, the method includes always alternating the gear selection between the two gears of the second transmission at every gear shift in response to the second operational shifter input. Hence, when the second transmission includes only two gears, receiving the second operational shifter input results in alternatingly upshifting and downshifting of the second transmission.

Optionally, the method comprises simultaneously controlling the first transmission in response to the, e.g. every other, second operational shifter input. Hence, when the second transmission includes only two gears, receiving the second operational shifter input results in alternatingly upshifting and downshifting of the second transmission, while e.g. every second received second operational shifter input also, e.g. simultaneously, causes upshifting or downshifting of the first transmission.

Optionally, the first and second operational shifter are separate shifting units, e.g. mounted to the handlebars, such as to opposite sides of the handlebars.

Optionally, the first and second operational shifter are one integrated shifting unit.

Optionally, the first and second operational shifter each have a neutral position and two opposite actuation positions. The two actuation positions can correspond to upshifting and downshifting, respectively.

Optionally, the first and second operational shifter are biased towards the neutral position.

Optionally, the method comprises, in a manual shifting mode, upshift and/or downshift the transmission system in response to receiving a user-initiated upshift and/or downshift command. The method can comprise, in the manual shifting mode, upshift and/or downshift the first transmission in response to a first operational shifter input, and upshift and/or downshift the second transmission in response to a second operational shifter input.

Optionally, the method comprises, in an automatic shifting mode, automatically upshifting and/or downshifting the transmission system in response to determining a difference between a measured cadence and a target cadence. The method can comprise, in the automatic shifting mode, executing a fast automatic shifting mode if a measured acceleration of the vehicle is higher than a predetermined acceleration threshold, and executing a slow automatic shifting mode if the measured acceleration of the vehicle is lower than the predetermined acceleration threshold. The method can comprise, in the fast automatic shifting mode, automatically upshifting and/or downshifting the transmission system in response to determining a difference between a measured cadence and a target cadence, by skipping system transmission ratios by only actuating the first transmission. The method can comprise, in the fast automatic shifting mode, actuating the second transmission for fine-tuning the measured cadence towards the target cadence. The method can comprise, in the slow automatic shifting mode, automatically upshift and/or downshift the transmission system in response to determining a difference between a measured cadence and a target cadence, by not skipping any system transmission ratios.

Optionally, the method comprises, in a semi-automatic shifting mode, upshifting the first and/or second transmission in response to user-initiated upshift commands, and automatically downshifting the transmission system in response to determining a difference between a measured cadence and a target cadence. The method can comprise, in the semi-automatic shifting mode, automatically downshifting the transmission system in response to determining a difference between a measured cadence and a target cadence, by skipping system transmission ratios by only actuating the first transmission. The method can comprise, when automatically downshifting, actuating the second transmission for fine-tuning the measured cadence towards the target cadence.

Another aspect provides a method for shifting a transmission system to a target transmission ratio. The transmission system comprises a first transmission and a second transmission in series, wherein the first transmission is configured to switch between a plurality of discrete transmission ratios having a step-size between adjacent transmission ratios, and wherein the second transmission is a continuously variable transmission, CVT, having a ratio-coverage similar to or smaller than the step-size. When the first transmission provides N1 transmission ratios, the ratio coverage of the first transmission can be about N1−1 times the ratio coverage of the CVT. Hence, the first transmission can provide a ratio coverage that is larger than the ratio-coverage of the CVT. The method comprises shifting the first transmission to a transmission ratio that deviates from the target transmission ratio by less than the ratio-coverage of the CVT, determining a deviation ratio of the target transmission ratio divided by the transmission ratio set by the first transmission, and shifting the CVT to the deviation ratio. Hence, the transmission system can be set to a target transmission ratio anywhere in the range of transmission ratios of the transmission system, even though the ratio-coverage of the CVT is smaller than the range of transmission ratios of the transmission system. The transmission system can be controlled to shift between a plurality of discrete transmission systems. It is also possible to control the transmission system to provide a continuously variable transmission ratio within the entire range of transmission ratios of the transmission system.

Optionally, the transmission ratio set by the first transmission is always smaller than, or equal to, the target transmission ratio. It is also possible to set the first transmission to a transmission ratio closest to the target transmission ratio, i.e. being smaller, equal or larger than the target transmission ratio.

Optionally, in a first mode, when shifting to the target transmission ratio requires shifting multiple steps of the first transmission, the method comprises refraining from shifting the CVT while shifting the multiple steps of the first transmission. Hence, the target transmission ratio can be achieved very fast.

Optionally, in a second mode, when shifting to the target transmission ratio requires shifting multiple steps of the first transmission, the method comprises shifting the CVT between shifting each two adjacent steps of the multiple steps of the first transmission, so as to obtain a continuous transmission ratio change. Hence, the target transmission ratio is approached in a continuously variable fashion. Hence, the target transmission ratio can be achieved smoothly.

Optionally, the method comprises, executing the first mode if a measured acceleration of the vehicle is higher than a predetermined acceleration threshold, and executing the second mode if the measured acceleration of the vehicle is lower than the predetermined acceleration threshold. Hence, depending on the vehicle acceleration, the target transmission ratio can be achieved with an emphasis on fastness or smoothness.

Optionally, the method comprises measuring a cadence and a vehicle speed, and automatically maintaining the measured cadence at a target cadence, or at least within a target cadence interval, by automatically renewing the target transmission ratio on the basis of the measured cadence and vehicle speed.

Another aspect provides a shift sequence, such as an upshift and/or downshift sequence, through the successive system transmission ratios of the transmission system described herein, particularly wherein the second transmission is a two-speed transmission, the upshift and/or downshift sequence comprising a synchronous shift step of synchronously changing the transmission ratio of the first transmission and the transmission ratio of the second transmission; and a non-synchronous shift step of selectively changing either the transmission ratio of the first transmission or the transmission ratio of the second transmission; wherein the upshift and/or downshift sequence comprises alternatingly the synchronous shift step and the non-synchronous shift step. The upshift and/or downshift sequence may hence include a synchronous shift step followed by the non-synchronous shift step, followed by a synchronous shift step, followed by a non-synchronous shift step, etc. The synchronous shift step may particularly include an upshifting of one of the first and second transmission while downshifting the other one the first and second transmission. For example, the upshift sequence may include a non-synchronous shift step of upshifting only the second transmission, followed by a synchronous shift step of upshifting the first transmission while downshifting the second transmission, followed by a non-synchronous shift step of upshifting only the second transmission, followed by a synchronous shift step of upshifting the first transmission while downshifting the second transmission. The downshift sequence may for example include a non-synchronous shift step of downshifting only the second transmission, followed by a synchronous shift step of downshifting the first transmission while upshifting the second transmission, followed by a non-synchronous shift step of downshifting only the second transmission, followed by a synchronous shift step of downshifting the first transmission while upshifting the second transmission. The transmission system may hence include a control unit configured for controlling the first transmission and the second transmission such as to upshift and/or downshift through the successive transmission ratios of the transmission system in accordance with the predetermined shift sequence. The control unit may be arranged to refrain from shifting the second transmission in case the transmission system is to be upshifted or downshifted to another transmission ratio being X×M transmission ratio steps higher or lower than a current transmission ratio, wherein X is an integer. For instance X×M is an integer multiple of 2, such as 2, 4, 6, 8, etc., for the two-speed second transmission. For example, when shifting the transmission system to the second next higher or lower system transmission ratio, the first next higher or lower system transmission ratio may be skipped. Hence, the control unit may be arranged to only shift the first transmission and not shift the second transmission.

Optionally, the first transmission includes a speed reducing and/or a speed increasing transmission ratio, and optionally a unity (1:1) transmission ratio. Preferably, the first transmission includes both a speed reducing and speed increasing transmission ratio, and optionally a unity transmission ratio.

Optionally, the second transmission includes a speed reducing and/or a speed increasing transmission ratio, and optionally a unity (1:1) transmission ratio. Preferably, the second transmission includes a 1:1 and a speed increasing transmission ratio.

Optionally, the switching mechanism comprises a first actuatable clutch in a transmission path between the transmission input and the planet carrier, and a first freewheel in a transmission path between the input and the ring gear; and a second actuatable clutch in a transmission path between the ring gear and the output, and a second freewheel in a transmission path between the planet carrier and the output. Hence, torque can be transmitted through the planetary gear set in two opposing directions, e.g. from the ring gear to the planet carrier for obtaining a speed reduction, and from the planet carrier to the ring gear for obtaining a speed increase. This effectively increases the range of transmission ratios obtainable by the transmission, with minimal components.

Optionally, in the first state, the first actuatable clutch and the second actuatable clutch are both in an unclutched state, and wherein in the second state, the first actuatable clutch and the second actuatable clutch are both in a clutched state for transmitting torque in at least one rotation direction. In the first state, when both first and second actuatable clutches are unclutched, torque can be transmitted from the transmission input via the first freewheel to the ring gear, and from the planet carrier via the second freewheel to the transmission output. The torque transmission from the ring gear to the planet carrier provides a speed reduction. In the second state, when both the first and second actuatable clutches are clutched, torque can be transmitted from the transmission input via the first actuatable clutch to the planet carrier, and from the ring gear via the second actuatable clutch to the transmission output; with the first freewheel and the second freewheel being overrun. The torque transmission from the planet carrier to the ring gear provides a speed reduction.

Optionally, the second transmission includes a cassette comprising two, three or four sprockets.

Optionally, the second transmission includes a cassette consisting of two sprockets for engaging a chain or belt. The cassette may hence include exactly two sprockets. Optionally, the second transmission includes a cassette consisting of three sprockets. Optionally, the second transmission includes a cassette consisting of four sprockets.

Optionally, the transmission system comprises a derailleur for shifting the chain or belt from one sprocket to the other for changing the transmission ratio of the second transmission. The derailleur may of a relatively simple construction, as the derailleur may only shift the chain over a relatively small travel, such as between two sprockets. A movement range of the derailleur may thus be limited.

Optionally, the cassette is axially movable relative to first transmission for shifting the chain or belt from one sprocket to the other. A derailleur-less system may hence be obtained, providing a light-weight construction. The cassette may be movably driven by an actuator, e.g. an electric actuator, that is for example accommodated by a rear wheel hub shell of the bicycle. When the cassette consists of two, three or four sprockets only, the axial range of motion of the cassette can be minimalized. The transmission system may for example include a stationary-mounted pully for cooperating with the chain or belt to retaining the chain or belt at a fixed axial position relative to the bicycle frame. This allow for a smooth shift of the chain or belt from one sprocket to the other when the cassette is axially moved relative to the pully.

Optionally, the transmission system comprises a cassette actuator configured to move the cassette in an axial direction of a rotational axis about which the cassette is rotatable. The transmission system optionally includes a driver element configured and arranged to rotate about the rotational axis. The driver element can e.g. have the form of a hollow cylinder. The driver element can be arranged coaxially with respect to a bicycle wheel. The cassette of sprockets may be mounted on the driver element to rotate together about the rotational axis. It will be appreciated that the cassette of sprockets forms a cluster of sprockets. Some or all of the sprockets of the cassette may integrated with each other into a single body. Some or all of the sprockets of the cassette may be separate, and may be fixed or fixable to other sprockets of the cassette. The driver element for example comprises axial splines for cooperating with complementary splines of the cassette. The cassette of sprockets can be mounted on the driver element using locking means, such as a locking ring. The cassette of sprockets can be arranged to be translatable in axial direction relative to the driver element. The cassette actuator can be activated in response to a driver command, such as by means of a manually operable shifter of a bicycle. The cassette actuator may be accommodated by the hub shell of the bicycle rear wheel, and/or positioned between the driver element and the rotational axis. The cassette actuator may be at least partially positioned in axial direction next to the driver element. The transmission system hence enables a chain or belt for meshing with the cassette to be optimally aligned to any one of the sprockets. By axially moving the cassette, e.g. as opposed to the chain or belt, any one of the sprockets can be selected to mesh with the endless drive member, while, at least substantially, maintaining an optimal alignment of the chain or belt. In particular, the endless drive member can be, at least substantially, maintained in a drive plane, wherein any one of the sprockets of the cassette can be axially moved so as to align a sprocket plane in which a particular sprocket extends with the drive plane. Transfer of the chain or belt from one sprocket to another, upon axial movement of the cassette, may be induced by rotating the cassette about the axis. The transfer of the endless drive member may be facilitated by a geometry and relative arrangement of the sprockets, e.g. by means of shift ramps on one or more of the sprockets. An example of a system for moving the cassette of sprockets in axial direction for shifting gears is described in WO2023012188, incorporated herein by reference in its entirety.

Optionally, the cassette may provide an intermediate gear step between successive transmission ratios of the first transmission. Hence, the first transmission can for instance provide a relatively large range of transmission ratios with relatively large ratio steps between successive gears, while the cassette has a relatively small range of transmission ratios with a relatively small step between its two gears to hence provide intermediate gear steps between the gears obtained with the first transmission.

Optionally, the second transmission comprises a planetary gear set. The planetary gear set may be arranged for being a multi-speed, e.g. a two-speed or three-speed, transmission that is selectively operable according to multiple different transmission ratios.

Optionally, the second transmission comprises a continuously variable transmission. The continuously variable transmission (CVT) may be configured for being operated as a discrete multi-speed transmission, wherein the CVT is switched between multiple predetermined different transmission ratios within the continuous transmission ratio range of the CVT. The predetermined transmission ratios of the CVT may be pre-programmable by a user. An example of a suitable CVT is for example described in WO2022248136, the contents of which are hereby incorporated by reference in its entirety.

Optionally, the second transmission is selectively operable according to two different transmission ratios, preferably including at least a unitary transmission ratio. Hence, one speed of the multi-speed second transmission may be a 1:1 transmission ratio. Another speed of the multi-speed second transmission may be non-unitary transmission ratio, such as a speed-increasing or speed decreasing transmission ratio.

Optionally, the first and/or second transmission is electrically actuated. Optionally the first and second transmission are independently electrically actuated. The first and or second transmission can be controlled by one or more control units. The first and or second transmission can be wiredly and/or wirelessly controlled.

Optionally, the transmission system comprises an electro-mechanical gear changing mechanism for actuating the first transmission and/or the second transmission to shift from one transmission ratio to another. The first transmission and the second transmission are preferably independently actuatable. The electro-mechanical gear changing mechanism may for example include clutch actuators for actuating clutches of the transmission system, a derailleur for shifting a chain or belt between different sprockets, and/or a cassette actuator for axially moving a cassette of sprockets relative to the bicycle frame.

Optionally, the first transmission and the second transmission are accommodated by a common housing, such as a rear wheel hub shell or a crank housing.

Optionally, the first transmission and the second transmission are both accommodated by a rear wheel hub shell, or are both accommodated by a crank housing. The transmission system may hence be embodied as a crank transmission operative between a crank, e.g. of the bicycle, and a front chain or belt wheel, or a hub transmission operative between a rear chain or belt sprocket and the rear wheel hub, e.g. of the bicycle.

Optionally, the first transmission and the second transmission are accommodated by separate housings.

Optionally, one of the first transmission and the second transmission is accommodated by a rear wheel hub shell and another one of the first transmission and the second transmission is accommodated by a crank housing.

The transmission system may hence be embodied as a distributed transmission system having a crank transmission and a hub transmission, wherein the crank transmission includes the first transmission and the hub transmission includes the second transmission, or vice versa.

Optionally, the first transmission is operatively arranged in a transmission path between the transmission system input to an input of the second transmission. The first transmission may hence be operatively arranged at an input side of the second transmission.

Optionally, the first transmission is operatively arranged in a transmission path between an output of the second transmission and the transmission system output. The second transmission may hence be operatively arranged at an input side of the first transmission.

Optionally, the first and/or second transmission comprises a clutch mechanism arranged for selectively clutching at least one of the plurality of sun gears to a stationary axle. The first and/or second transmission can hence provide an effective range of transmission ratios while being constructively compact for being housed by a hub or crank housing.

Optionally, the first actuatable clutch and the second actuatable clutch are form closed clutches, configured for transferring torque in at least one, such as two, rotational directions.

Optionally, the first and/or second transmission comprises an electric actuator arranged for actuating the first actuatable clutch and the second actuatable clutch.

Optionally, the electric actuator comprises a first electric actuator arranged for actuating the first actuatable clutch, and a second electric actuator arranged for actuating the second actuatable clutch.

Optionally, the first actuatable clutch and the second actuatable clutch are independently actuatable.

Optionally, each one of the first actuatable clutch and the second actuatable clutch is configured for being coupled and decoupled under load.

Optionally, the clutch mechanism comprises at least one actuatable bidirectional clutch mechanism arranged for being selectively actuated to a first disposition for preventing rotation of a selective one of the plurality of sun gears relative the stationary axle in a first rotational direction, and to a second disposition for preventing rotation of the selective one sun gear relative to the stationary axle in a second, reverse, rotational direction. Hence, the one sun gear can be selectively braked in a selective one of two opposing rotational directions, respectively associated with the first and second dispositions of the switching mechanism. For example, the one sun gear is braked in one rotational direction when the switching mechanism is in the first disposition, whereas the one sun gear is braked in the opposite rotational direction when the switching mechanism is in the second disposition.

Optionally, the electric actuator is further arranged for actuating the at least one actuatable bidirectional clutch mechanism.

Optionally, the at least one actuatable bidirectional clutch mechanism in the first disposition allows freewheeling of the selective one sun gear in the second rotational direction. Hence, the bidirectional clutch can be arranged to brake the one sun gear in the first rotational direction while allowing to be overrun in the second rotational direction. The at least one bidirectional clutch can hence be overrun, e.g. when another bidirectional clutch of the clutch mechanism is engaged.

Optionally, the at least one actuatable bidirectional clutch mechanism is configured for being coupled and decoupled under load.

Optionally, the at least one actuatable bidirectional clutch mechanism in the second disposition allows freewheeling of the selective one sun gear in the first rotational direction. Hence, the bidirectional clutch can be arranged to brake the one sun gear in the second rotational direction while allowing to be overrun in the first rotational direction. The at least one bidirectional clutch can hence be overrun, e.g. when another bidirectional clutch of the clutch mechanism is engaged.

Optionally, the at least one actuatable bidirectional clutch mechanism is arranged for selectively being in a third disposition for allowing rotation of the sun gear relative to the stationary axle in the first and in the second rotational direction. The third disposition allows the sun to freely rotate relative to the stationary axle in two opposing rotation directions.

Optionally, the actuatable bidirectional clutch mechanism cannot simultaneously be in more than one disposition.

Optionally, the actuatable bidirectional clutch mechanism cannot simultaneously be in the first disposition as well as in the second disposition. Optionally, the actuatable bidirectional clutch mechanism cannot simultaneously be in the first disposition as well as in the third disposition. Optionally, the actuatable bidirectional clutch mechanism cannot simultaneously be in the second disposition as well as in the third disposition.

Optionally, the at least one actuatable bidirectional clutch mechanism comprises a first clutch member connected or connectable to the respective sun gear or the stationary axle, and having a first engagement surface; and a second clutch member connected or connectable to the stationery axle or the respective sun gear, and having a complementary first engagement surface, the first engagement surface and the complementary first engagement surface being arranged for selectively engaging each other in the first disposition for preventing rotation of the first clutch member relative to the second clutch member in the first rotational direction. The first clutch member may be rotatable relative to the second clutch member. The first and second clutch members may be concentrically arranged. The second clutch member may be within the first clutch member. Alternatively, the first clutch member may be within the second clutch member. The second clutch member may be non-rotationally mounted to the stationary axle.

Optionally, the complementary first engagement surface is formed by a complementary first pawl.

Optionally, the complementary first pawl is pivotable about a first pivot axis to have the first engagement surface and the complementary first engagement surface engage in the first disposition to prevent rotation of the first clutch member relative to the second clutch member in the first rotational direction, and wherein the complementary first pawl is pivotable about a second pivot axis to permit freewheeling of the first clutch member relative to the second clutch member in the second rotational direction. Hence, in the first disposition, the at least one actuatable bidirectional clutch mechanism can freewheel, or be overrun, in the second rotational direction.

Optionally, the first engagement surface is formed by a first pawl. The first pawl may be non-movably coupled to the first clutch member. The first pawl may for example be part of a teethed ratchet structure.

Optionally, the first pawl is pivotably arranged for, in the first disposition, permitting freewheeling of the first clutch member relative to the second clutch member in the second rotational direction. Hence, the first engagement surface and the complementary first engagement surface may both be formed by a respective pivotable pawl. The complementary first pawl may be actuatable, while the first pawl may be passive.

Optionally, the first clutch member further has a second engagement surface, and the second clutch member further has a complementary second engagement surface, the second engagement surface and the complementary second engagement surface being arranged for selectively engaging each other in the second disposition for preventing rotation of the first clutch member relative to the second clutch member in the second rotational direction.

Optionally, the complementary second engagement surface is formed by a complementary second pawl.

Optionally, the complementary second pawl is pivotable about a third pivot axis to have the second engagement surface and the complementary second engagement surface engage in the second disposition to prevent rotation of the first clutch member relative to the second clutch member in the second rotational direction, and wherein the complementary second pawl is pivotable about a fourth pivot axis to permit freewheeling of the first clutch member relative to the second clutch member in the first rotational direction. Hence, in the second disposition, the at least one actuatable bidirectional clutch mechanism can freewheel, or be overrun, in the first rotational direction.

Optionally, the second engagement surface is formed by a second pawl.

Optionally, the second pawl is pivotably arranged for, in the second disposition, permitting freewheeling of the first clutch member relative to the second clutch member in the first rotational direction. Hence, the second engagement surface and the complementary second engagement surface may both be formed by a respective pivotable pawl. The complementary second pawl may be actuatable, while the second pawl may be passive.

Optionally, in the first disposition, the second engagement surface and the complementary second engagement surface cannot engage each other. Hence, the actuatable bidirectional clutch mechanism in the first disposition may not simultaneously be also in the second disposition.

Optionally, in the second disposition, the first engagement surface and the complementary first engagement surface cannot engage each other. Hence, the actuatable bidirectional clutch mechanism in the second disposition may not simultaneously be also in the first disposition.

Optionally, in the third disposition, the second engagement surface and the first engagement surface and the complementary first engagement surface cannot engage each other, and the complementary second engagement surface cannot engage each other. Hence, the actuatable bidirectional clutch mechanism in the third disposition may not simultaneously be also in the first and/or second disposition.

Optionally, the first and/or second transmission comprises an actuation member including a cam, the cam being arranged for being adjusted between a first cam position associated with the first disposition or a second cam position associated with the second disposition, wherein the cam in the first cam position locks the complementary first abutment surface in engagement with the first abutment surface for preventing rotation of the second clutch member relative to the first clutch member in the first rotational direction, and the cam in the second cam position locks the complementary second abutment surface in engagement with the second abutment surface for preventing rotation of the second clutch member relative to the first clutch member in the second rotational direction. The actuation member may include a cam shaft.

Optionally, the cam is arranged for being adjusted to a third cam position associated with the third disposition, wherein the cam in the third cam position releases the complementary first abutment surface and the complementary second abutment surface for disengagement from the first abutment surface and the second abutment surface, for decoupling the second clutch member from the first clutch member.

Optionally, the planetary gear set comprises J sun gears, and wherein the clutch mechanism comprises J actuatable bidirectional clutch mechanisms or J−1 actuatable bidirectional clutch mechanisms. Each actuatable bidirectional clutch mechanism may be substantially identical. The actuatable bidirectional clutch mechanisms may be actuated by means of respective cam of the actuation member.

Optionally, the actuation member includes a plurality of cams, e.g. J or J−1 cams, wherein each cam is arranged for cooperating with a respective actuatable bidirectional clutch mechanism. Each cam may hence be associated with a respective sun gear of the planetary gear set, for use in selectively braking a sun gear in a selective one of two rotational directions. The actuation member, e.g. a cam shaft, may be rotationally actuated about an axis parallel to the stationary axle.

Optionally, the actuation member may be movable to a first actuation position in which a first cam is and a second cam are in a different cam position. The first cam may for example be in its first cam position while the second cam may be in its second or third cam position. The first cam may alternatively be, for example, in its second cam position while the second cam may be in its first or third cam position.

Optionally, the actuation member may be movable to a second actuation position in which both the first cam and the second cam are in the same cam position, e.g. both in in their first, both in their second or both in their third cam positions.

Optionally, the mechanism comprises an indexing mechanism arranged for adjusting the actuation member relative to the second clutch member between at least the first cam position and the second cam position.

Optionally, the indexing mechanism is configured to translates a continuous rotational motion, e.g. of output of an electric actuator, into an intermittent rotational motion of the actuation member. The indexing mechanism may for example include a Geneva drive, or Maltese cross drive.

Optionally, the clutch mechanism comprises a passive bidirectional clutch mechanism arranged for being passively adjustable between a first disposition for preventing rotation of a predetermined one of the plurality of sun gears relative to the stationary axle in a first rotational direction, and a second disposition for preventing rotation of the predetermined one sun gear relative to the stationary axle in a second, reverse, rotational direction. The passive bidirectional clutch mechanism may for example include a freewheel mechanism.

Optionally, the clutch mechanism comprises a passive unidirectional clutch mechanism arranged for preventing rotation of a predetermined one of the plurality of sun gears relative to the stationary axle in a first rotational direction or a second rotational direction. The passive unidirectional clutch mechanism may for example include a freewheel mechanism.

Optionally, the passive bidirectional clutch mechanism in the first disposition allows freewheeling of the predetermined one sun gear in the second rotational direction.

Optionally, the passive bidirectional clutch mechanism in the second disposition allows freewheeling of the predetermined one sun gear in the first rotational direction.

Optionally, the first and/or second transmission is selectively operable according to a plurality of different transmission ratios including a set of underdrive transmission ratios and a set of overdrive transmission ratios.

Optionally, the first and/or second transmission is operable according to the set of underdrive transmission ratios when the switching mechanism is in its first state, and wherein the transmission is operable according to the set of overdrive transmission ratios when the switching mechanism is in its second state.

Optionally, the underdrive transmission ratios and the overdrive transmission ratios are respectively inverse to each other.

Optionally, the first and/or second transmission comprises a predetermined upshift sequence and/or a predetermined downshift sequence through successive gears of the transmission, wherein the upshift sequence and/or the downshift sequence each includes a first sequence part of successive selective clutching of the plurality of sun gears to the stationary axle in a first predetermined order and a second sequence part of successive selective clutching of the plurality of sun gears to the stationary axle in a second predetermined order, wherein the first predetermined order is the reverse of the second predetermined order. Hence, for example, the first sequence part may include a selective clutching a first sun gear, a second sun gear and a third sun to the stationary axle in that order, whereas the second sequence part may include a selective clutching of the third sun gear, the second sun gear and the third sun gear to the stationary axle in that order. The upshift or downshift sequence may hence for example include a selective clutching of the sun gears in a predetermined order of: first, second, third, [ . . . ], third, second, first. The first sequence part may be associated with the set of underdrive transmission ratios and the second sequence part may be associated with the set of overdrive transmission ratios, or vice versa. The first sequence part may hence be associated with the switching mechanism being in the first state and the second sequence part may be associated with the switching mechanism being in the second state, or vice versa. The upshift sequence may be reverse to the downshift sequence.

More in general, according to an aspect is provided a first and/or second transmission comprising a predetermined upshift sequence and/or a predetermined downshift sequence through successive gears of the transmission, such as via successive planet radii of a stepped planet gear, wherein the upshift sequence and/or the downshift sequence each includes a first sequence part of successive selective transmission of torque via the successive planet radii in a first predetermined order and a second sequence part of successive selective transmission of torque via the successive planet radii in a second predetermined order, wherein the first predetermined order is the reverse of the second predetermined order.

Optionally, the first and/or second transmission is selectively operable according to a unitary transmission ratio.

Optionally, the switching mechanism is arranged for being adjustable to a third state for establishing a torque transmission from the input to the output according to a unitary transmission ratio.

Optionally, in the third state, one of the first actuatable clutch and the second actuatable clutch is in a clutched state, and another one of the first actuatable clutch and the second actuatable clutch is in the unclutched state. Hence, the transmission input and the transmission output may both be rotationally coupled to the same rotational member of the planetary gear set, e.g. both to the ring gear or both to the planet carrier.

Optionally, in the third state, each actuatable bidirectional clutch mechanism of the clutch mechanism is either in its third disposition or its second disposition for allowing the sun gears to freely rotate relative to the stationary axle in the first rotational direction.

Another aspect provides a human-powered vehicle or light electric vehicle, such as a bicycle, comprising a transmission system as described herein.

According to an aspect is provided a derailleur for an endless drive member, and configured to be mounted to a frame of a human-powered vehicle or light electric vehicle, such as a bicycle. The derailleur comprises a base member, and a derailleur wheel and/or chain guide mounted to the base member rotatable about an axis, wherein the derailleur wheel and/or chain guide is axially movable along its axis. In particular, the derailleur is configured to cooperate with sprockets mounted to a driven wheel of the vehicle. For example, the derailleur is a rear derailleur configured to cooperate with sprockets mounted to a rear wheel of a bicycle.

Optionally, the derailleur is configured for moving the derailleur wheel and/or chain guide between at least two and at most four axial positions. The derailleur wheel and/or chain guide can e.g. be moved axially for selectively engaging the endless drive member with one of at least two and at most four sprockets.

Optionally, the derailleur wheel and/or chain guide is movable in axial direction between two end positions.

Optionally, the derailleur and/or chain guide is configured such that a force for movement of the derailleur wheel and/or chain guide in axial direction is created by a rotation of the derailleur wheel.

Optionally, the derailleur is configured such that movement of the derailleur wheel and/or chain guide in axial direction is initiated by an electric actuator.

Optionally, the electric actuator is configured to be wirelessly controlled. The electric actuator can be powered by an electric power storage element, such as a battery or an ultra-capacitor.

Optionally, the derailleur comprises a solar cell electrically connected to the electric power storage element for charging the electric power storage element.

Optionally, the derailleur comprises a tensioner for tensioning the endless drive member.

Optionally, the tensioner includes the derailleur wheel.

Optionally, the tensioner is the derailleur wheel.

Optionally, the tensioner includes a tensioning wheel rotatable about an axis.

Optionally, at least one of the derailleur wheel and the tensioning wheel is movable in axial direction. Hence, the derailleur wheel can be movable in axial direction. Alternatively, the tensioning wheel can be movable in axial direction. Alternatively, both the derailleur wheel and the tensioning wheel can be movable in axial direction, such as simultaneously.

Optionally, the base member is movable in axial direction of the derailleur wheel. Hence, the base member can move the derailleur wheel and/or the tensioning wheel axially.

Optionally, the base member is rotatable with respect to the frame.

Optionally, the base member is rotatable with respect to the frame, but not axially movable with respect to the frame.

Optionally, the electric actuator is connected to the base member.

Optionally, a battery, controller, wireless electronics, and/or antenna of the electric actuator is connected to the base member.

Optionally, a battery, controller, wireless electronics, and/or antenna is connected to the base member.

Optionally, the tensioning wheel is rotatably mounted to the base member.

Optionally, the derailleur wheel is rotatably mounted to the base member, and the tensioning wheel is rotatably mounted to the base member.

Optionally, one of, such as each of, the derailleur wheel and the tensioning wheel have between 10 and 20, preferably between 12 and 18, teeth.

Optionally, the tensioner is configured to be connected to the frame of the vehicle.

Optionally, the tensioner is configured to be connected to a dropout of the vehicle.

Optionally, the tensioner is configured to rotate with respect to the frame of the vehicle.

Optionally, the tensioner is configured to rotate with respect to the dropout of the vehicle.

Optionally, the transmission system comprises a damper for damping a rotating of the tensioner with respect to the frame in at least one rotational direction, or in both rotational directions.

Optionally, the transmission system comprises a damper for damping a rotating of the tensioner with respect to the dropout in at least one rotational direction, or in both rotational directions.

Optionally, the tensioner is configured to allow removal of a driven wheel from the vehicle.

It will be appreciated that any of the aspects, features and options described herein can be combined. It will particularly be appreciated that any of the aspects, features and options described in view of the transmission systems apply equally to the human-powered vehicle or light electric vehicle, such as the bicycle, and the method and vice versa.

### BRIEF DESCRIPTION OF THE DRAWINGS

Embodiments of the present invention will now be described in detail with reference to the accompanying drawings in which:

FIGS. 1A and 1B show examples of a transmission system for a human-powered vehicle or light electric vehicle, such as a bicycle;

FIGS. 2A-2C and 3A-3C show examples of a transmission system for a human-powered vehicle or light electric vehicle, such as a bicycle;

FIGS. 4A, 4B, 4C, 5A, 5B, 5C 6A, 6B, 6C, 7A, 7B and 7C show examples of a transmission system embodied as a hub transmission;

FIGS. 8A, 8B, 9A, 9B, 10A and 10B show examples of a derailleur;

FIGS. 11A, 11B, 12, 13, 14A, 14B, 14C and 14D show examples of a transmission system embodied as a crank transmission;

FIGS. 15, 16 and 17 show a schematic example of a control system; and

FIGS. 18A and 18B show examples of a bicycle.

### DETAILED DESCRIPTION

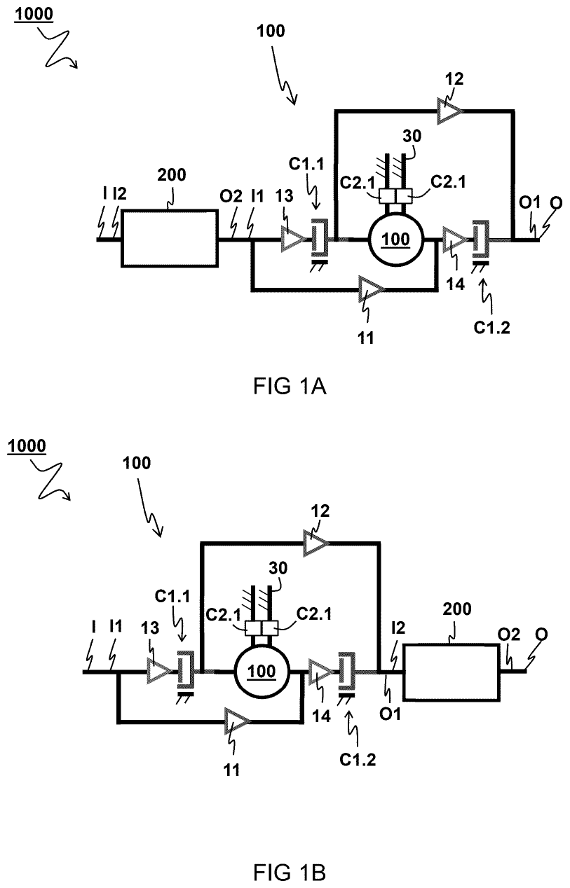

FIGS. 1A and 1B show schematic examples of a transmission system 1000 for a human-powered vehicle or light electric vehicle, such as a bicycle. The transmission system 1000 includes a transmission system input I and a transmission system output O.

In this example, the transmission system 1000 comprises a multi-speed planetary first transmission 100 arranged for being selectively operative according to a plurality of different transmission ratios. The transmission system 1000 also comprises a multi-speed second transmission 200, connected in series with the first transmission 100. Here, the second transmission 200 is a two-speed transmission selectively operable according to only two different transmission ratios. In FIG. 1A, the second transmission 200 is connected at an input side of the first transmission 100, whereas in FIG. 1B, the second transmission 200 is connected at an output side of the first transmission 100. The second transmission, being a two-speed transmission, is selectively operable according to exactly two different transmission ratios. The second transmission 200 may be a planetary transmission. The second transmission 200 may alternatively be an external sprocket-based or cassette-based transmission, comprising a plurality of sprockets, such as a cassette of sprockets, for selectively meshing with an endless drive member, such as a chain or belt. The second transmission 200 may alternatively be a continuously variable transmission, particularly a continuously variable transmission that is operated as a two-speed transmission, i.e. controlled so as to switch between two predetermined transmission ratios within the continuous transmission ratio range. The predetermined transmission ratios may be adjusted and/or (pre) programmable.

The second transmission 200 is particularly arranged to provide intermediate gear steps between the gear steps of the first transmission 100. The step size between the two transmission ratios of the second transmission 200 may for example be half the step size of successive transmission ratios of the first transmission 100. For example, successive transmission ratios of the first transmission 100 may differ by approximately Z percent, e.g. twenty percent, while the transmission ratios of the second transmission 200 may differ by approximately Z/2 percent, e.g. 10 percent. Preferably, a step size of the first transmission 100 is between 18% and 40%, such as between 20% and 30%. Preferably, a step size of the second transmission 200 is between 5% and 20%, such as between 8-15%.

A ratio-coverage, i.e. span of the smallest transmission ratio to the largest transmission ratio, of the first transmission 100 is at least five times, preferably at least ten times larger than a ratio-coverage of the second transmission 200. Hence, the first transmission 100 mainly determines a ratio-coverage of the transmission system 1000.

The first transmission 100 can have more different transmission ratios than the second transmission 200.

At least one of the two transmission ratios of the second transmission 200 may be a unitary transmission ratio, i.e. a 1:1 ratio. The other transmission ratio of the second transmission 200 may be speed-increasing transmission ratio or a speed-decreasing transmission ratio. Particularly if the second transmission 200 is connected at the input side of the first transmission 100, it can be beneficial that the second transmission 200 has a speed-increasing transmission ratio, in order to reduce torque on the first transmission 100.

It will be appreciated that the second transmission 200 can also be a continuously variable transmission, CVT. The CVT can have a ratio-coverage similar to or smaller than the step-size between two adjacent transmission ratios of the first transmission 100. The first transmission 100 can have a larger ratio-coverage than the second transmission 200. A ratio-coverage of the first transmission can be at least two times, such as at least three times, or at least four times as large as the ratio-coverage of the CVT. The CVT can be of a ratcheting type. An example of a suitable CVT is for example described in WO2022248136, the contents of which are hereby incorporated by reference in its entirety. The CVT may be operated according to a plurality of discrete transmission ratios, or according to a continuously variable range of transmission ratios.

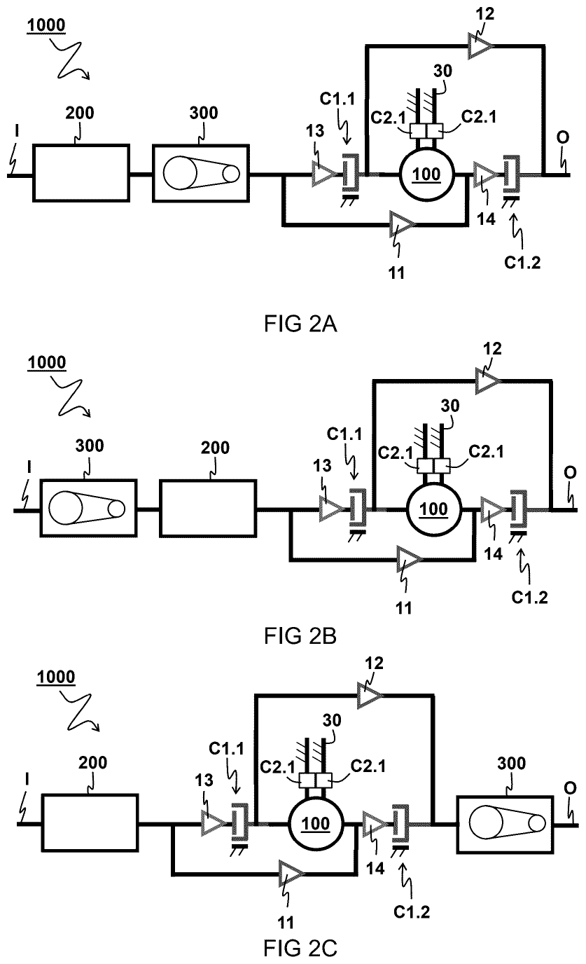

FIGS. 2A-2C show examples of the transmission system 1000, corresponding to the serial arrangement of FIG. 1A. In FIG. 2A, the first transmission 100 is embodied as an internal hub transmission while the second transmission 200 is embodied as an internal crank transmission. Torque is transferred from the second transmission 200 to the first transmission 100 via an endless drive member drive, such as chain or belt drive 300. In FIG. 2B, the first transmission 100 and the second transmission 200 are jointly embodied as an internal hub transmission. The first and second transmission 100, 200 may for example both be accommodated by a hub shell of the driven wheel of the bicycle, typically the rear wheel. Alternatively, in FIG. 2B, the first transmission 100 is embodied as an internal hub transmission, while the second transmission is embodied as an external sprocket-based, e.g. cassette-based, transmission. In FIG. 2C, the first transmission 100 and the second transmission are jointly embodied as an internal crank transmission. The first and second transmission 100, 200 may for example both be accommodated by a crank housing at the crank of the bicycle.

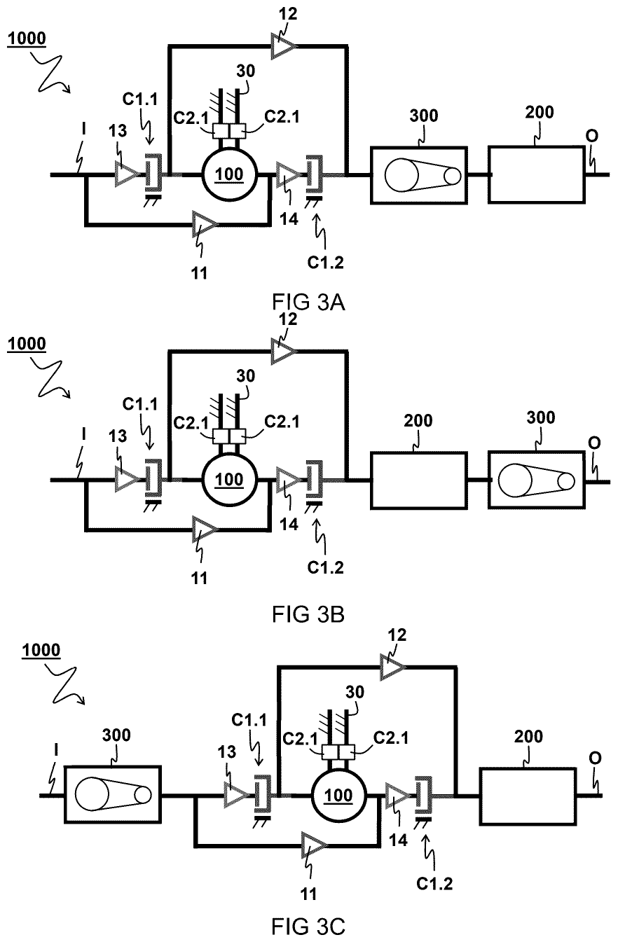

FIGS. 3A-3C show examples of the transmission system 1000, corresponding to the serial arrangement of FIG. 1B. In FIG. 3A, the first transmission 100 is embodied as an internal crank transmission while the second transmission 200 is embodied as an internal hub transmission. Alternatively, in FIG. 3A, the second transmission is embodied as an external cassette-based transmission. Torque is transferred from the first transmission 100 to the second transmission 200 via chain or belt drive 300. In FIG. 3B, the first transmission 100 and the second transmission 200 are jointly embodied as an internal crank transmission. The first and second transmission 100, 200 may for example both be accommodated by a crank housing at the crank of the bicycle. In FIG. 3C, the first transmission 100 and the second transmission are jointly embodied as an internal hub transmission. The first and second transmission 100, 200 may for example both be accommodated by a hub shell of the driven wheel of the bicycle, typically the rear wheel.

More in general, the first transmission can comprise, or be, an integrated hub transmission, and the second transmission can comprises at least two sprockets and an endless drive member, such as a chain or belt, selectively engaged with either one of these sprockets. Alternatively, the first transmission can comprise, or be, an integrated hub transmission, and the second transmission can comprise an integrated crank transmission. Alternatively, the first transmission can comprise, or be, an integrated crank transmission, and the second transmission can comprise at least two sprockets and an endless drive member, such as a chain or belt, selectively engaged with either one of these sprockets. Alternatively, the first transmission and the second transmission can be integrated in an integrated crank transmission. The first transmission and/or the second transmission can thus, e.g. be housed in a crank unit.

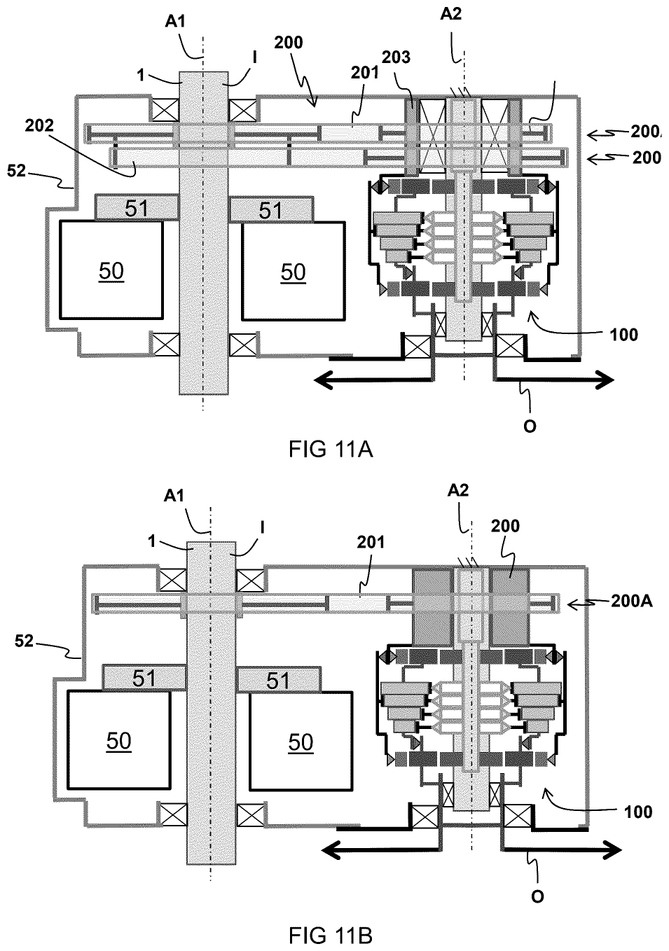

As described further below, e.g. in view of FIGS. 11A, 11B, 12, 14A, 14B, 14C and 14D, the transmission system 1000 can comprise an electric propulsion motor 50. It will be appreciated that the electric propulsion motor can be included in any of the examples described herein. The motor can e.g. be integrated in the crank unit. The motor can e.g. be mounted concentric with a crank axle of the crank unit.

More in general, the first transmission can comprise, or be, an integrated hub transmission, the second transmission can comprise at least two sprockets and an endless drive member, such as a chain or belt, selectively engaged with either one of these sprockets, and the electric propulsion motor can be placed in the crank unit. Alternatively, the first transmission can comprise, or be, an integrated hub transmission, and the second transmission and the electric propulsion motor can be integrated in the crank unit. Alternatively, the first transmission and the electric propulsion motor can be integrated in the crank unit, and the second transmission can comprise at least two sprockets and an endless drive member, such as a chain or belt, selectively engaged with either one of these sprockets. Alternatively, the first transmission, the second transmission, and the electric propulsion motor can be integrated in the crank unit.

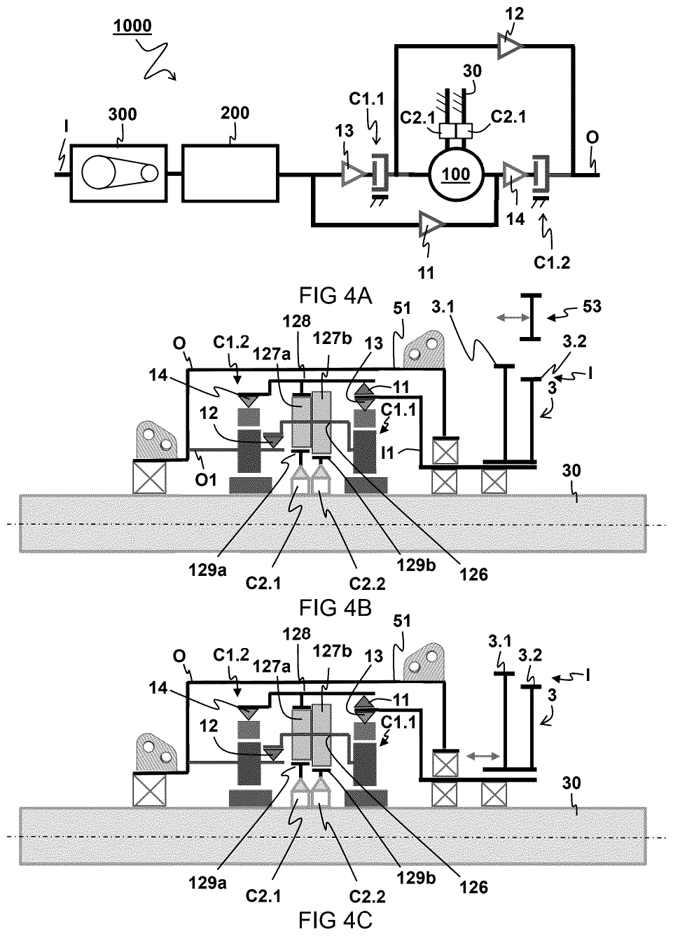

FIGS. 4A, 4B, 4C, 5A, 5B, 5C and 6A, 6B, 6C show examples of the transmission system 1000 corresponding to the arrangement of FIG. 2A, particularly wherein the first transmission 100 is embodied as an internal hub transmission accommodated by a hub shell 51 of the driven bicycle wheel, and wherein the second transmission 200 is embodied as an external sprocket-based, e.g. cassette-based, transmission. It will be clear that in the examples of FIGS. 4A, 4B, 4C, 5A, 5B, 5C and 6A, 6B, 6C, the first transmission 100 can be embodied differently. For instance, as described below, in the examples of FIGS. 4A, 4B, 4C, 5A, 5B, 5C and 6A, 6B, 6C, the first transmission 100 utilizes all different planet radii 127i both for a speed-up and speed-down transmission ratio. It is also possible that some or all of the different planet radii 127i can be utilized for only a speed-up or only a speed-down transmission ratio.

In these examples, the second transmission 200 includes a cassette 3 consisting of two sprockets 3.1, 3.2. The two sprockets 3.1, 3.2 can selectively cooperate with the chain or belt for imposing two different transmission ratios. The chain or belt may be shifted between the two sprockets using a derailleur 53 as shown in FIGS. 4B, 5B and 6B. The derailleur 53 can be relatively compact as its range of motion can be limited to the distance between the two sprockets. Alternatively, in the exemplary transmission system 1000 as shown in FIGS. 4C, 5C and 6C, the cassette 3 is axially movable relative to the hub shell 51, to shift the chain or belt between the two sprockets 3.1, 3.2.

In these examples, the planetary first transmission 100 comprises a ring gear 128 and a planet carrier 126 carrying one or more planet gears 127. The planet carrier 126 particularly carries one or more stepped planet gears 127 having multiple different planet radii 127i. The ring gear 128 meshes with one of the different planet radii 127i. The planetary first transmission 100 also comprises a plurality of different sun gears 129i. The plurality of sun gears respectively mesh with the plurality of different planet radii 127i.

The sun gears 129i are rotatably arranged about a stationary axle 30. The stationary axle 30 may be mounted to a frame of the vehicle, e.g. bicycle, for supporting torque thereon.

The transmission system 1000 comprises, in these examples, a switching mechanism C1, here including a first actuatable clutch mechanism C1.1 and a second actuatable clutch mechanism C1.2. The first actuatable clutch mechanism C1.1 is arranged in a transmission path between the transmission system input I and the planet carrier 126. The second actuatable clutch mechanism C1.2 is arranged in a transmission path between the ring gear 128 and the transmission system output O. The transmission system 1000 also comprises a first freewheel 11 in a transmission path between the transmission system input I and the ring gear 128. The first freewheel 11 is hence parallel to the first actuatable clutch mechanism C1.1. The transmission system 1000 also comprises a second freewheel 12 in a transmission path between the planet carrier 126 and the transmission system output O. The second freewheel 12 is hence parallel to the second actuatable clutch mechanism C1.2.

The switching mechanism C1 is configured for selectively being in a first state or a second state. In the first state, both the first and the second actuatable clutch mechanisms C1.1, C1.2 are in an unclutched state. Torque can accordingly be transmitted in the first state from the transmission system input I via the first freewheel 11 to the ring gear 128 and from the planet carrier 127 via the second freewheel 12 to the transmission system output O. The planetary first transmission 100 provides a speed reduction from the ring gear 128 to the planet carrier 126 in accordance with the relative dimensions of the cooperating rotational members of the planetary first transmission 100.

In the second state of the switching mechanism C1, both the first and the second actuatable clutch mechanisms C1.1, C1.2 are in a clutched state. Torque can accordingly be transmitted in the second state from the transmission system input I via the first actuatable clutch mechanism C1.1 to the planet carrier 126 and from the ring gear 128 via the second actuatable clutch mechanism C1.2 to the transmission system output O. The first freewheel 11 and the second freewheel 12 are overrun in the second state. The planetary first transmission 100 provides a speed increase from the planet carrier 126 to the ring gear 128 in accordance with the relative dimensions of the cooperating rotational members of the planetary first transmission 100.

Here, the transmission system 1000 also comprises a third freewheel 13 arranged in series with the first actuatable clutch C1.1, and a fourth freewheel 14 arranged in series with the second actuatable clutch C1.2. The third and fourth freewheels 13 and 14 can prevent lockup of the transmission system 1000 if the bicycle were to be rolled backwards.

The switching mechanism C1 enables for reversing a transmission path through the planetary first transmission 100, e.g. from ring gear 128 to carrier 126 or vice versa, to effectively increase the range of transmission ratios of the transmission system 1000 as whole. In the first state of the switching mechanism C1, the transmission system 1000 operates according to an underdrive transmission ratio, reducing the rotational speed from the system input I to the system output O. In the second state of the switching mechanism C1, the transmission system 1000 operates according to an overdrive transmission ratio, increasing the rotational speed from the system input I to the system output O.

The switching mechanism C1 may also be arranged for selectively being in a third state. In the third state, the first actuatable clutch mechanism C1.1 may be in its clutched state, while the second actuatable clutch mechanism C1.2 is in its unclutched state, or vice versa. In the third state, the transmission system input I and the transmission system output O are coupled to the same rotational member of the planetary first transmission 100, e.g. both to the planet carrier 126 or both to the ring gear 128. In the third state, the transmission may be operable according to a unitary transmission ratio, e.g. a transmission ratio of 1:1.

The transmission system 1000 further comprises a clutch mechanism C2. The clutch mechanism C2 is arranged for selectively clutching a selective one of the plurality of sun gears 129i to the stationary axle 30. Hereto, the clutch mechanism C2 comprises a plurality of actuatable bidirectional clutch mechanisms C2.i. Each actuatable bidirectional clutch mechanism C2.i is associated with respective sun gear 129i, for clutching the associated sun gear 129i to the stationary axle 30 in a selective one of two opposing rotation directions. Each actuatable bidirectional clutch mechanism C2.i is arranged for being selectively in a first disposition or a second disposition. In the first disposition, the actuatable bidirectional clutch mechanism C2.i prevents rotation of the respective sun gear 129i in the first rotation direction about the stationary axle 30. Herein, preventing rotation of the respective sun gear 129i in the first rotation direction about the stationary axle 30 is also referred to as braking the respective sun gear 129i in the first rotation direction. In the second disposition, the actuatable bidirectional clutch mechanism C2.i prevents rotation of the respective sun gear 129i in the second rotation direction about the stationary axle 30. Herein, preventing rotation of the respective sun gear 129i in the second rotation direction about the stationary axle 30 is also referred to as braking the respective sun gear 129i in the second rotation direction. The direction in which a sun gear 129i is to be braked is dependent on the state of the switching mechanism C1. For example, if the switching mechanism is in its first state, a selective one of the actuatable bidirectional clutch mechanisms C2.i may prevent rotation of a respective sun gear 129a in the second rotational direction, whereas if the switching mechanism is in its second state, a selective one of the actuatable bidirectional clutch mechanisms C2.i may prevent rotation of a respective sun gear 129a in the first rotational direction.

When the first transmission input I1 is driven in the first rotational direction about the stationary axle 30, while the switching mechanism C1 is in the first state, the ring gear 128 is also driven in the first rotational direction, and via the stepped planet gear 127, a rotational force is induced on the sun gears 129i in the second, reverse, rotational direction. By braking a selective one of the sun gears 129i with the clutch mechanism C2, torque can be transmitted from the ring gear 128 to the planet carrier 126, according to an underdrive transmission ratio. When the first transmission input I1 is driven in the first rotational about the stationary axle 30, while the switching mechanism C1 is in the second state however, the planet carrier 126 is also driven in the first rotational direction, and via the stepped planet gear 127, a rotational force is induced on the sun gears 129i in the first rotational direction. By braking a selective one of the sun gears 129i with the clutch mechanism C2, torque can be transmitted from the planet carrier 126 to the ring gear 128 according to an overdrive transmission ratio.

In each of the first and second dispositions, the actuatable bidirectional clutch mechanisms C2.i may be arranged to prevent rotation of the sun gear 129 in one direction, while allowing rotation of the sun gear in the opposite rotation direction, e.g. by freewheeling. Hence, in the first disposition, the actuatable bidirectional clutch mechanism C2.i may be configured for allowing freewheeling of the sun gear 129i in the second rotational direction while preventing rotation of that sun gear 129i in the first rotational direction. Also, in the second disposition, the actuatable bidirectional clutch mechanism C2.i may be configured for allowing freewheeling of the sun gear 129i in the first rotational direction while preventing rotation of that sun gear 129i in the second rotational direction.

One or more of the actuatable bidirectional clutch mechanisms C2.i of the clutch mechanism may also selectively be adjusted to a third disposition. In the third disposition, the actuatable bidirectional clutch mechanism C2.i may allow free rotation of the respective sun gear 129 in both rotational directions about the stationary axle 30. For instance, while one of the actuatable bidirectional clutch mechanisms C2.i is in the first disposition or the second disposition, other ones of the actuatable bidirectional clutch mechanisms can be in the third disposition.

One or more of the actuatable bidirectional clutch mechanisms C2.i may be configured to be adjustable to be in the third disposition, if the switching mechanism is in its third state, for allowing the ring gear 128 and the planet carrier 126 to corotate about the stationary axle 30. This way, the first transmission 100 may provide a unitary transmission ratio between the input I1 and output O1. If the switching mechanism is in its third state, one or more of the actuatable bidirectional clutch mechanisms C2.i may also be adjusted to be in the first disposition, for allowing the ring gear 128 and the planet carrier 126 to corotate about the stationary axle 30 in the first rotational direction.

It is possible that one (or more) of the actuatable bidirectional clutch mechanisms C2.i is a biased actuatable bidirectional clutch mechanism configured to be in the second disposition by default and configured to be actively actuated to the first disposition. The biased actuatable bidirectional clutch mechanism may be configured not to have a third disposition. The biased actuatable bidirectional clutch mechanism can be used to prevent that all actuatable bidirectional clutch mechanisms are in the third disposition while the switching mechanism is in the first or second state, which could lead to a state in which no torque is transferred by the transmission. Also, the biased actuatable bidirectional clutch mechanism C2.i may be configured for allowing freewheeling of the sun gear 129i in the first rotational direction while preventing rotation of that sun gear 129i in the second rotational direction. It is also possible that one (or more) of the actuatable bidirectional clutch mechanisms C2.i is a biased actuatable bidirectional clutch mechanism configured to be in the first disposition by default and configured to be actively actuated to the second disposition.

In the example of FIGS. 1-4C the planetary first transmission 100 comprises two sun gears 129a, 129b meshing with two respective planet radii 127a, 127b of the stepped planet gear 127. Also, the clutch mechanism C2 comprises two actuatable bidirectional clutch mechanisms C2.1, C2.2, arranged for selectively clutching the respective sun gears 129a, 129b to the stationary axle 30. The clutches C1.1, C1.2 of the exemplary switching mechanism C1 may for example be load-shifting clutch as described in WO2018199757A2 incorporated herein by reference in its entirety.

The transmission system 1000 as exemplified in FIGS. 4A, 4B can be a ten-speed transmission system 1000. Exemplary clutch states of the switching mechanism C1 and the and clutch mechanism C2 for the ten-speed transmission system 1000 are summarized in table 1.

TABLE 1

| | | | C2.1 | C2.2 | Sprocket | |
|---|---|---|---|---|---|---|
| Gear | C1.1 | C1.2 | (disposition) | (disposition) | 3.1 | 3.2 |
| 1 | unclutched | unclutched | 2^{nd}_{or freewheel} | 3^{rd} | X | |
| 2 | unclutched | unclutched | 2^{nd}_{or freewheel} | 3^{rd} | | X |
| 3 | unclutched | unclutched | 3^{rd} | 2^{nd} | X | |
| 4 | unclutched | unclutched | 3^{rd} | 2^{nd} | | X |
| 5 | unclutched | clutched | 3^{rd} | 3^{rd} | X | |
| 6 | unclutched | clutched | 3^{rd} | 3^{rd} | | X |
| 7 | clutched | clutched | 3^{rd} | 1^{st} | X | |
| 8 | clutched | clutched | 3^{rd} | 1^{st} | | X |
| 9 | clutched | clutched | 1^{st} | 3^{rd} | X | |
| 10 | clutched | clutched | 1^{st} | 3^{rd} | | X |

With the first transmission 100 having five different transmission ratios (N=5) and the second transmission having two different transmission ratios (M=2), the transmission system of FIGS. 4A-4C has ten different transmission ratios. For example, successive transmission ratios of the first transmission 100 can differ by about 40 percent, and successive transmission ratios of the second transmission 200 can differ by about 18 percent, resulting in a ten-speed transmission having a total range of 455%. It will be clear that the transmission ratio step sizes are indicated as ‘about’ a certain percentage, since e.g. mechanical, constraints like number of teeth on a gear or sprocket may dictate that the actual achievable ratio step size deviates somewhat from the theoretically ideal step size. It will be clear that here the ratio-coverage of the first transmission is about 384% (=1.44), while the ratio-coverage of the second transmission is about 118% (=1.181). Hence, in this example, the ratio-coverage of the first transmission is about 3.25 times the ratio-coverage of the second transmission.

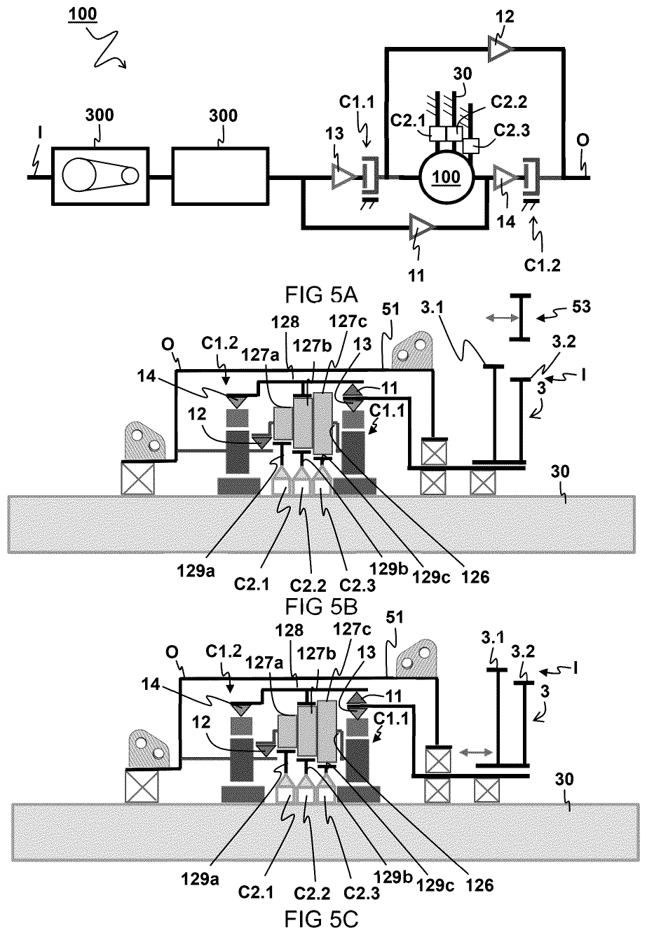

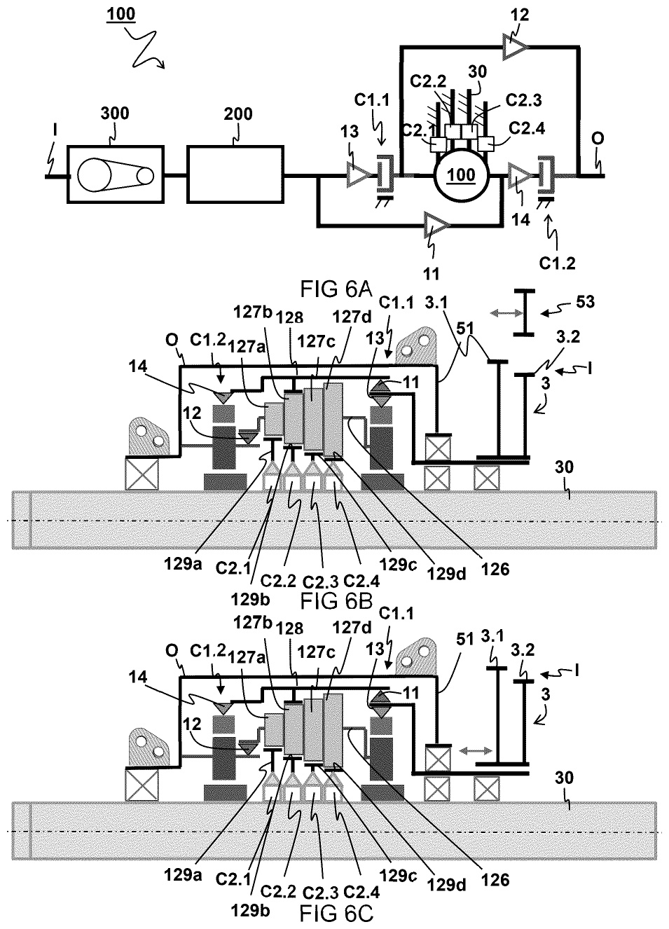

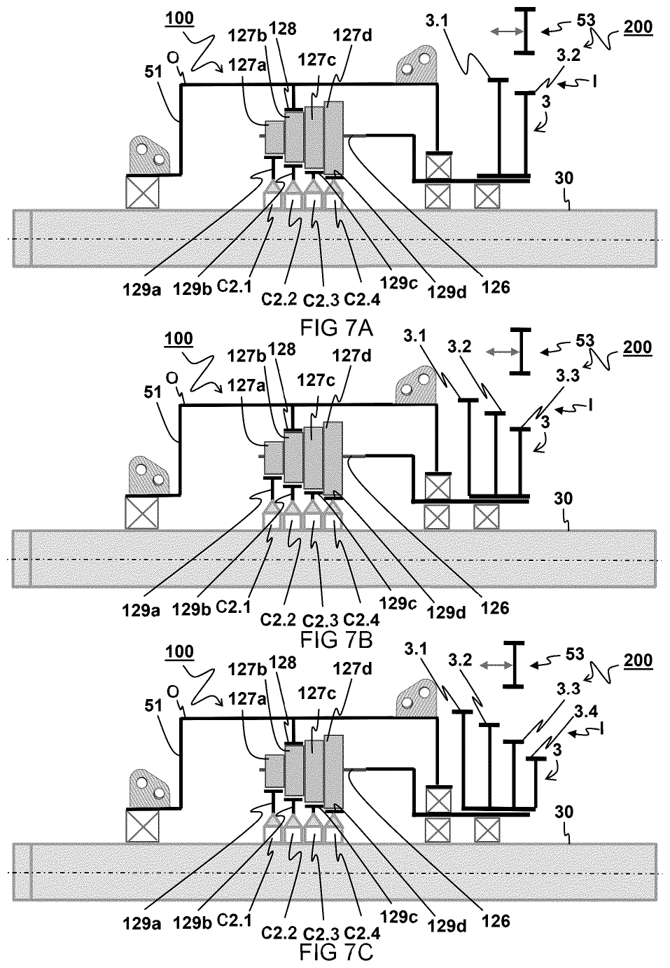

In FIGS. 5A, 5B and 5C, the planetary first transmission 100 comprises three sun gears 129a, 129b, 129c meshing with three respective planet radii 127a, 127b, 127c of the stepped planet gear 127. Also, the clutch mechanism C2 comprises three actuatable bidirectional clutch mechanisms C2.1, C2.2, C2.3, arranged for selectively clutching the respective sun gears 129a, 129b, 129c to the stationary axle 30. A fourteen-speed transmission system 1000 can be hence be obtained. Exemplary clutch states of the first and clutch mechanisms C1, C2 for the fourteen-speed transmission system 1000 are summarized in table 2.

TABLE 2

| | | | C2.1 | C2.2 | C2.3 | sprocket | |
|---|---|---|---|---|---|---|---|
| Gear | C1.1 | C1.2 | (disposition) | (disposition) | (disposition) | 3.1 | 3.2 |
| 1 | unclutched | unclutched | 2^{nd}_{or freewheel} | 3^{rd} | 3^{rd} | X | |
| 2 | unclutched | unclutched | 2^{nd}_{or freewheel} | 3^{rd} | 3^{rd} | | X |
| 3 | unclutched | unclutched | 3^{rd} | 2^{nd} | 3^{rd} | X | |
| 4 | unclutched | unclutched | 3^{rd} | 2^{nd} | 3^{rd} | | X |
| 5 | unclutched | unclutched | 3^{rd} | 3^{rd} | 2^{nd} | X | |
| 6 | unclutched | unclutched | 3^{rd} | 3^{rd} | 2^{nd} | | X |
| 7 | unclutched | clutched | 3^{rd} | 3^{rd} | 3^{rd} | X | |
| 8 | unclutched | clutched | 3^{rd} | 3^{rd} | 3^{rd} | | X |
| 9 | clutched | clutched | 3^{rd} | 3^{rd} | 1^{st} | X | |
| 10 | clutched | clutched | 3^{rd} | 3^{rd} | 1^{st} | | X |
| 11 | clutched | clutched | 3^{rd} | 1^{st} | 3^{rd} | X | |
| 12 | clutched | clutched | 3^{rd} | 1^{st} | 3^{rd} | | X |
| 13 | clutched | clutched | 1^{st} | 3^{rd} | 3^{rd} | X | |
| 14 | clutched | clutched | 1^{st} | 3^{rd} | 3^{rd} | | X |

With the first transmission 100 having seven different transmission ratios (N=7) and the second transmission having two different transmission ratios (M=2), the transmission system of FIGS. 5A-5C has fourteen different transmission ratios. For example, successive transmission ratios of the first transmission 100 can differ by about 28 percent, and successive transmission ratios of the second transmission 200 can differ by about 13 percent, resulting in a fourteen-speed transmission having a total range of about 498%. It will be clear that the ratio-coverage of the first transmission is about 440% (=1.28⁶), while the ratio-coverage of the second transmission is about 113% (=1.13¹). Hence, in this example, the ratio-coverage of the first transmission is about 3.89 times the ratio-coverage of the second transmission. For example, successive transmission ratios of the first transmission 100 can differ by about 29 percent, and successive transmission ratios of the second transmission 200 can differ by about 13.6 percent, resulting in a fourteen-speed transmission having a total range of about 523%. A transmission ratio of the first transmission may e.g. range from about 0.47 to about 2.15.

In FIGS. 6A, 6B and 6C, the planetary first transmission 100 comprises four sun gears 129a, 129b, 129c, 129d meshing with four respective planet radii 127a, 127b, 127c, 127d of the stepped planet gear 127. Also, the clutch mechanism C2 comprises four actuatable bidirectional clutch mechanisms C2.1, C2.2, C2.3, C2.4, arranged for selectively clutching the respective sun gears 129a, 129b, 129c, 129d to the stationary axle 30. An eighteen-speed transmission system 1000 can be hence be obtained. Exemplary clutch states of the first and clutch mechanisms C1, C2 for the eighteen-speed transmission system 1000 are summarized in table 3.

TABLE 3

| | | | C2.1 | C2.2 | C2.3 | C2.4 | Sprocket | |
|---|---|---|---|---|---|---|---|---|
| Gear | C1.1 | C1.2 | (disposition) | (disposition) | (disposition) | (disposition) | 3.1 | 3.2 |
| 1 | un-clutched | un-clutched | 2^{nd}_{or freewheel} | 3^{rd} | 3^{rd} | 3^{rd} | X | |
| 2 | un-clutched | un-clutched | 2^{nd}_{or freewheel} | 3^{rd} | 3^{rd} | 3^{rd} | | X |
| 3 | un-clutched | un-clutched | 3^{rd} | 2^{nd} | 3^{rd} | 3^{rd} | X | |
| 1 | un-clutched | un-clutched | 3^{rd} | 2^{nd} | 3^{rd} | 3^{rd} | | X |
| 5 | un-clutched | un-clutched | 3^{rd} | 3^{rd} | 2^{nd} | 3^{rd} | X | |
| 6 | un-clutched | un-clutched | 3^{rd} | 3^{rd} | 2^{nd} | 3^{rd} | | X |
| 7 | un-clutched | un-clutched | 3^{rd} | 3^{rd} | 3^{rd} | 2^{nd} | X | |
| 8 | un-clutched | un-clutched | 3^{rd} | 3^{rd} | 3^{rd} | 2^{nd} | | X |
| 9 | un-clutched | clutched | 3^{rd} | 3^{rd} | 3^{rd} | 3^{rd} | X | |
| 10 | un-clutched | clutched | 3^{rd} | 3^{rd} | 3^{rd} | 3^{rd} | | X |
| 11 | clutched | clutched | 3^{rd} | 3^{rd} | 3^{rd} | 1^{st} | X | |
| 12 | clutched | clutched | 3^{rd} | 3^{rd} | 3^{rd} | 1^{st} | | X |
| 13 | clutched | clutched | 3^{rd} | 3^{rd} | 1^{st} | 3^{rd} | X | |
| 14 | clutched | clutched | 3^{rd} | 3^{rd} | 1^{st} | 3^{rd} | | X |
| 15 | clutched | clutched | 3^{rd} | 1^{st} | 3^{rd} | 3^{rd} | X | |
| 16 | clutched | clutched | 3^{rd} | 1^{st} | 3^{rd} | 3^{rd} | | X |
| 17 | clutched | clutched | 1^{st} | 3^{rd} | 3^{rd} | 3^{rd} | X | |
| 18 | clutched | clutched | 1^{st} | 3^{rd} | 3^{rd} | 3^{rd} | | X |

With the first transmission 100 having nine different transmission ratios (N=9) and the second transmission having two different transmission ratios (M=2), the transmission system of FIGS. 6A-6C has eighteen different transmission ratios. For example, successive transmission ratios of the first transmission 100 can differ by about 21 percent, and successive transmission ratios of the second transmission 200 can differ by about 10 percent, resulting in an eighteen-speed transmission having a total range of 505%. It will be clear that the ratio-coverage of the first transmission is about 459% (=1.218), while the ratio-coverage of the second transmission is about 110% (=1.11). Hence, in this example, the ratio-coverage of the first transmission is about 4.17 times the ratio-coverage of the second transmission.

In tables 1-3, the transmission system 1000 is operable according to a unitary transmission ratio, but this gear may optionally be omitted. The shifting mechanism may for example not include the third state, but may be adjusted only between the first state and the second state. Without the unitary gear, the first actuatable clutch C1.1 and the second actuatable clutch C1.2 can be actuated in synchrony with each other, switching both clutches C1.1, C1.2 simultaneously between their clutched and their unclutched state. This may simplify the actuation construction. A benefit of the unitary gear is an increase in transmission ratio range. Also, with the unitary gear, each upshift or downshift to a next higher or lower gear may involve only shifting one the first and second actuatable clutch mechanisms C1.1, C1.2.

In tables 1-3, the actuatable bidirectional clutch mechanisms include the optional third disposition. Instead, the actuatable bidirectional clutch mechanisms C2.i may be adjusted between the only the first disposition and the second disposition. The transmission of FIGS. 4A-6C can also be used for providing a five-speed transmission. For a six-speed, eight-speed, or ten-speed transmission, respectively, the clutch mechanisms C2.1, C2.2, C2.3 and C2.4 may omit the first disposition, i.e. provide the second disposition and the third disposition, or omit the second disposition, i.e. provide the first disposition and the third disposition.

In the examples relating to tables 1-3, the first transmission 100 is selectively operable according to N different first transmission ratios, and the second transmission 200 is selectively operable according to M different second transmission ratios. The transmission system 1000 is hence selectively operable according to N*M different system transmission ratios. In view of table 1, N=5 and M=2. In view of table 2, N=7 and M=2. In view of table 3, N=9 and M=2.

FIGS. 7A, 7B and 7C show a further example of a transmission system 1000. In these examples, the first transmission 100 comprises a ring gear 128 and a planet carrier 126 carrying one or more planet gears 127. The planet carrier 126 particularly carries one or more stepped planet gears 127 having multiple different planet radii 127i, here four different planet radii 127a-127d. The ring gear 128 meshes with one of the different planet radii 127i. The planetary first transmission 100 also comprises a plurality of different sun gears 129i, here four different sun gears 1269a-129d. The plurality of sun gears respectively mesh with the plurality of different planet radii 127i.

The sun gears 129i are rotatably arranged about the stationary axle 30. The stationary axle 30 may be mounted to a frame of the vehicle, e.g. bicycle, for supporting torque thereon.

In these examples, the first transmission 100 does not include a switching mechanism as shown in relation to FIGS. 1-6C. However, it will be appreciated that the first transmission 100 may include such switching mechanism also in the examples of FIGS. 7A-7C. In the absence of the switching mechanism, it suffices if the sun gears 129i can be braked in one rotational direction only. Hence, in this example, the clutch mechanisms C2.i can be unidirectional clutch mechanism. The unidirectional clutch mechanisms C2.i can be configured to, in a first condition, selectively prevent rotation of the respective sun gear 129i in one rotational direction. The unidirectional clutch mechanism C2.i may, e.g, in the first condition, allow freewheeling of the respective sun gear 129i in the opposite rotational direction. In a second condition, the respective sun gear 129i may be allowed to freely rotate in both rotational directions (similar to the third disposition of the actuatable bidirectional clutch mechanism C2.i).

In the example of FIG. 7A, the second transmission 200 includes two sprockets 3.1, 3.2. The sprockets 3.1, 3.2 can form part of a cassette 3. A derailleur 53 selectively engages the endless drive member, such as the chain or belt, with one of the sprockets 3.1, 3.2.

With the first transmission 100 having four different transmission ratios (N=4) and the second transmission having two different transmission ratios (M=2), the transmission system of FIG. 7A has eight different transmission ratios. Table 4 summarizes the configuration of the transmission system 100 in the eight gears.

TABLE 4

| | | | | | Sprocket | |
|---|---|---|---|---|---|---|
| Gear | C2.1 (mode) | C2.2 (mode) | C2.3 (mode) | C2.4 (mode) | 3.1 | 3.2 |
| 1 | 2^{nd} | 2^{nd} | 2^{nd} | 1^{st} | X | |
| 2 | 2^{nd} | 2^{nd} | 2^{nd} | 1^{st} | | X |
| 3 | 2^{nd} | 2^{nd} | 1^{st} | 2^{nd}_{(or freewheel)} | X | |
| 4 | 2^{nd} | 2^{nd} | 1^{st} | 2^{nd}_{(or freewheel)} | | X |
| 5 | 2^{nd} | 1^{st} | 2^{nd}_{(or freewheel)} | 2^{nd}_{(or freewheel)} | X | |
| 6 | 2^{nd} | 1^{st} | 2^{nd}_{(or freewheel)} | 2^{nd}_{(or freewheel)} | | X |
| 7 | 1^{st} | 2^{nd}_{(or freewheel)} | 2^{nd}_{(or freewheel)} | 2^{nd}_{(or freewheel)} | X | |
| 8 | 1^{st} | 2^{nd}_{(or freewheel)} | 2^{nd}_{(or freewheel)} | 2^{nd}_{(or freewheel)} | | X |

The second transmission 200 is particularly arranged to provide intermediate gear steps between the gear steps of the first transmission 100. The step size between the two transmission ratios of the second transmission 200 may in this example be about half the step size of successive transmission ratios of the first transmission 100. For example, successive transmission ratios of the first transmission 100 may differ by approximately Z percent, while the transmission ratios of the second transmission 200 may differ by approximately Z/2 percent. More accurately, if desired, if successive transmission ratios of the first transmission 100 differ by Z percent, the transmission ratios of the second transmission 200 may differ by approximately

$$100 ( \sqrt{1 + \frac{Z}{100}} - 1 ) percent .$$

Alternatively put, if desired, if successive transmission ratios of the second transmission 200 differ by Y percent, the transmission ratios of the first transmission 100 may differ by approximately

$$100 ( 2 \frac{Y}{100} + {( \frac{Y}{100} )}^{2} ) percent .$$

Preferably, a step size of the first transmission 100 is between 18% and 40%, such as between 20% and 30%. Preferably, a step size of the second transmission 200 is between 5% and 20%, such as between 8-15%. For example, successive transmission ratios of the first transmission 100 differ by about 32 percent, and successive transmission ratios of the second transmission 200 differ by about 15 percent, resulting in an eight-speed transmission having a total range of 265%. It will be clear that the ratio-coverage of the first transmission is about 230% (=1.323), while the ratio-coverage of the second transmission is about 15% (=1.151). Hence, in this example, the ratio-coverage of the first transmission is about two times the ratio-coverage of the second transmission.

It will be appreciated that more advantage may be obtained if the ratio-coverage of the first transmission is more larger than the ratio-coverage of the second transmission. For instance, a sixteen speed transmission can be provided with the first transmission 100 having eight different transmission ratios (N=8) and the second transmission having two different transmission ratios (M=2). Then, for example, successive transmission ratios of the first transmission 100 can differ by about 24 percent, and successive transmission ratios of the second transmission 200 differ by about 11.4 percent, resulting in a sixteen-speed transmission having a total range of 502%. It will be clear that the ratio-coverage of the first transmission is about 451% (=1.247), while the ratio-coverage of the second transmission is about 111% (=1.1141). Hence, in this example, the ratio-coverage of the first transmission is about 4.06 times the ratio-coverage of the second transmission.

Advantageously, the ratio-coverage of the first transmission 100 is larger, such as at least two times larger, e.g. at least three times larger or at least four times larger, than the ratio-coverage of the second transmission 200. The first transmission, advantageously, has more different ratios than the second transmission, such as at least twice as much different ratios than the second transmission. For instance, the first transmission has more than four different ratios and the second transmission has less than four different ratios.

In the example of FIG. 7B, the second transmission 200 includes three sprockets 3.1, 3.2, 3.3. The sprockets 3.1, 3.2, 3.3 can form part of a cassette 3. A derailleur 53 selectively engages the endless drive member, such as the chain or belt, with one of the sprockets 3.1, 3.2, 3.3.

With the first transmission 100 having four different transmission ratios (N=4) and the second transmission having three different transmission ratios (M=3), the transmission system of FIG. 7B has twelve different transmission ratios. Table 5 summarizes the configuration of the transmission system 100 in the twelve gears.

TABLE 5

| | | | | | Sprocket | | |
|---|---|---|---|---|---|---|---|
| Gear | C2.1 (mode) | C2.2 (mode) | C2.3 (mode) | C2.4 (mode) | 3.1 | 3.2 | 3.3 |
| 1 | 2^{nd} | 2^{nd} | 2^{nd} | 1^{st} | X | | |
| 2 | 2^{nd} | 2^{nd} | 2^{nd} | 1^{st} | | X | |
| 3 | 2^{nd} | 2^{nd} | 2^{nd} | 1^{st} | | | X |
| 4 | 2^{nd} | 2^{nd} | 1^{st} | 2^{nd}_{(or freewheel)} | X | | |
| 5 | 2^{nd} | 2^{nd} | 1^{st} | 2^{nd}_{(or freewheel)} | | X | |
| 6 | 2^{nd} | 2^{nd} | 1^{st} | 2^{nd}_{(or freewheel)} | | | X |
| 7 | 2^{nd} | 1^{st} | 2^{nd}_{(or freewheel)} | 2^{nd}_{(or freewheel)} | X | | |
| 8 | 2^{nd} | 1^{st} | 2^{nd}_{(or freewheel)} | 2^{nd}_{(or freewheel)} | | X | |
| 9 | 2^{nd} | 1^{st} | 2^{nd}_{(or freewheel)} | 2^{nd}_{(or freewheel)} | | | X |
| 10 | 1^{st} | 2^{nd}_{(or freewheel)} | 2^{nd}_{(or freewheel)} | 2^{nd}_{(or freewheel)} | X | | |
| 11 | 1^{st} | 2^{nd}_{(or freewheel)} | 2^{nd}_{(or freewheel)} | 2^{nd}_{(or freewheel)} | | X | |
| 12 | 1^{st} | 2^{nd}_{(or freewheel)} | 2^{nd}_{(or freewheel)} | 2^{nd}_{(or freewheel)} | | | X |

The second transmission 200 is particularly arranged to provide intermediate gear steps between the gear steps of the first transmission 100. The step size between the two transmission ratios of the second transmission 200 may in this example be about a third of the step size of successive transmission ratios of the first transmission 100. For example, successive transmission ratios of the first transmission 100 may differ by approximately Z percent, while the transmission ratios of the second transmission 200 may differ by approximately Z/3 percent. More accurately, if desired, if successive transmission ratios of the first transmission 100 differ by Z percent, the transmission ratios of the second transmission 200 may differ by approximately

$$100 ( \sqrt[3]{\frac{\frac{Z}{100} + 1}{2} + \sqrt{{( \frac{\frac{Z}{100} + 1}{2} )}^{2} + 1}} + \sqrt[3]{\frac{\frac{Z}{100} + 1}{2} - \sqrt{{( \frac{\frac{Z}{100} + 1}{2} )}^{2} + 1}} - 1 )$$

percent. Alternatively put, if desired, if successive transmission ratios of the second transmission 200 differ by Y percent, the transmission ratios of the first transmission 100 may differ by approximately

$$100 ( 3 \frac{Y}{100} + 3 {( \frac{Y}{100} )}^{2} + {( \frac{Y}{100} )}^{3} ) percent .$$

Preferably, a step size of the first transmission 100 is between 18% and 40%, such as between 20% and 30%. Preferably, a step size of the second transmission 200 is between 5% and 20%, such as between 8-15%. For example, successive transmission ratios of the first transmission 100 differ by about 40 percent, and successive transmission ratios of the second transmission 200 differ by about 12 percent, resulting in a twelve-speed transmission having a total range of 348%. It will be clear that the ratio-coverage of the first transmission is about 274% (=1.403), while the ratio-coverage of the second transmission is about 125% (=1.122). Hence, in this example, the ratio-coverage of the first transmission is about 2.19 times the ratio-coverage of the second transmission.

It will be appreciated that more advantage may be obtained if the ratio-coverage of the first transmission is more larger than the ratio-coverage of the second transmission. For instance, an eighteen speed transmission can be provided with the first transmission 100 having six different transmission ratios (N=6) and the second transmission having three different transmission ratios (M=3). Then, for example, successive transmission ratios of the first transmission 100 can differ by about 32 percent, and successive transmission ratios of the second transmission 200 differ by about 10 percent, resulting in an eighteen-speed transmission having a total range of 485%. It will be clear that the ratio-coverage of the first transmission is about 401% (=1.325), while the ratio-coverage of the second transmission is about 121% (=1.102). Hence, in this example, the ratio-coverage of the first transmission is about 3.65 times the ratio-coverage of the second transmission.

In the example of FIG. 7C, the second transmission 200 includes four sprockets 3.1, 3.2, 3.3, 3.4. The sprockets 3.1, 3.2, 3.3, 3.4 can form part of a cassette 3. A derailleur 53 selectively engages the endless drive member, such as the chain or belt, with one of the sprockets 3.1, 3.2, 3.3, 3.4.

With the first transmission 100 having four different transmission ratios (N=4) and the second transmission having four different transmission ratios (M=4), the transmission system of FIG. 7C has sixteen different transmission ratios. Table 6 summarizes the configuration of the transmission system 100 in the sixteen gears.

TABLE 6

| | | | | | Sprocket | | | |
|---|---|---|---|---|---|---|---|---|
| Gear | C2.1 (mode) | C2.2 (mode) | C2.3 (mode) | C2.4 (mode) | 3.1 | 3.2 | 3.3 | 3.4 |
| 1 | 2^{nd} | 2^{nd} | 2^{nd} | 1^{st} | X | | | |
| 2 | 2^{nd} | 2^{nd} | 2^{nd} | 1^{st} | | X | | |
| 3 | 2^{nd} | 2^{nd} | 2^{nd} | 1^{st} | | | X | |
| 4 | 2^{nd} | 2^{nd} | 2^{nd} | 1^{st} | | | | X |
| 5 | 2^{nd} | 2^{nd} | 1^{st} | 2^{nd}_{(or freewheel)} | X | | | |
| 6 | 2^{nd} | 2^{nd} | 1^{st} | 2^{nd}_{(or freewheel)} | | X | | |
| 7 | 2^{nd} | 2^{nd} | 1^{st} | 2^{nd}_{(or freewheel)} | | | X | |
| 8 | 2^{nd} | 2^{nd} | 1^{st} | 2^{nd}_{(or freewheel)} | | | | X |
| 9 | 2^{nd} | 1^{st} | 2^{nd}_{(or freewheel)} | 2^{nd}_{(or freewheel)} | X | | | |
| 10 | 2^{nd} | 1^{st} | 2^{nd}_{(or freewheel)} | 2^{nd}_{(or freewheel)} | | X | | |
| 11 | 2^{nd} | 1^{st} | 2^{nd}_{(or freewheel)} | 2^{nd}_{(or freewheel)} | | | X | |
| 12 | 2^{nd} | 1^{st} | 2^{nd}_{(or freewheel)} | 2^{nd}_{(or freewheel)} | | | | X |
| 13 | 1^{st} | 2^{nd}_{(or freewheel)} | 2^{nd}_{(or freewheel)} | 2^{nd}_{(or freewheel)} | X | | | |
| 14 | 1^{st} | 2^{nd}_{(or freewheel)} | 2^{nd}_{(or freewheel)} | 2^{nd}_{(or freewheel)} | | X | | |
| 15 | 1^{st} | 2^{nd}_{(or freewheel)} | 2^{nd}_{(or freewheel)} | 2^{nd}_{(or freewheel)} | | | X | |
| 16 | 1^{st} | 2^{nd}_{(or freewheel)} | 2^{nd}_{(or freewheel)} | 2^{nd}_{(or freewheel)} | | | | X |

The second transmission 200 is particularly arranged to provide intermediate gear steps between the gear steps of the first transmission 100. The step size between the two transmission ratios of the second transmission 200 may in this example be about a quarter of the step size of successive transmission ratios of the first transmission 100. For example, successive transmission ratios of the first transmission 100 may differ by approximately Z percent, while the transmission ratios of the second transmission 200 may differ by approximately Z/4 percent. More accurately, if desired, if successive transmission ratios of the second transmission 200 differ by Y percent, the transmission ratios of the first transmission 100 may differ by approximately

$$100 ( 4 \frac{Y}{100} + 6 {( \frac{Y}{100} )}^{2} + 4 {( \frac{Y}{100} )}^{3} + 4 {( \frac{Y}{100} )}^{4} ) percent .$$

Preferably, a step size of the first transmission 100 is between 18% and 40%, such as between 20% and 30%. Preferably, a step size of the second transmission 200 is between 5% and 20%, such as between 8-15%. For example, successive transmission ratios of the first transmission 100 differ by about 52 percent, and successive transmission ratios of the second transmission 200 differ by about 11 percent, resulting in a sixteen-speed transmission having a total range of 478%. It will be clear that the ratio-coverage of the first transmission is about 351% (=1.523), while the ratio-coverage of the second transmission is about 137% (=1.113). Hence, in this example, the ratio-coverage of the first transmission is about 2.56 times the ratio-coverage of the second transmission.

It will be appreciated that more advantage may be obtained if the ratio-coverage of the first transmission is more larger than the ratio-coverage of the second transmission. For instance, a twenty-four-speed transmission can be provided with the first transmission 100 having six different transmission ratios (N=6) and the second transmission having four different transmission ratios (M=4). Then, for example, successive transmission ratios of the first transmission 100 can differ by about 31 percent, and successive transmission ratios of the second transmission 200 differ by about 7 percent, resulting in a twenty-four-speed transmission having a total range of 473%. It will be clear that the ratio-coverage of the first transmission is about 386% (=1.315), while the ratio-coverage of the second transmission is about 122% (=1.073). Hence, in this example, the ratio-coverage of the first transmission is about 3.16 times the ratio-coverage of the second transmission.

When shifting from a current system transmission ratio to a target system transmission ratio a method comprises successively upshifting or downshifting the first transmission 100 through the first transmission ratios by a first integer number of transmission ratio steps; and upshifting or downshifting the second transmission 200 through the second transmission ratios by a second integer number of transmission ratio steps. In this example, for any current system transmission ratio and for any target system transmission ratio within the N*M system transmission ratios, the second integer number is at most M−1. Hence, the transmission system can be efficiently shifted with a minimal number of shift actions steps, particularly when changing the system transmission ratio by multiple steps at once. The method particularly prevents needlessly repetitive cycling through the first or second transmission ratios when a multi-step shift action is commanded. N is preferably larger than M. M may for example be equal to two three or four. N may for example be equal to three, four, five, six, seven, eight, nine, ten, eleven, twelve or thirteen or more. Preferably, the second integer number of steps upshifting or downshifting the second transmission through the second transmission ratios includes only upshifting or only downshifting the second transmission, during the shifting the transmission system 1000 from the current system transmission ratio to the target system transmission ratio.

The transmission system 1000 can comprise a control unit configured to upshift and/or downshift the transmission system. The control unit can be configured to upshift the transmission system to the next higher system transmission ratio according to an upshift sequence through the system transmission ratios, and/or downshift the transmission system to the next lower system transmission ratio according to a downshift sequence through the system transmission ratios. The upshift and/or downshift sequence can comprise a synchronous shift step of synchronously changing the transmission ratio of the first transmission 100 and the transmission ratio of the second transmission 200, and a non-synchronous shift step of selectively changing either the transmission ratio of the first transmission 100 or the transmission ratio of the second transmission 200. Optionally, the upshift sequence comprises alternatingly the synchronous shift step and the non-synchronous shift step. Optionally, the downshift sequence comprises alternatingly the synchronous shift step and the non-synchronous shift step. This can particularly apply when the second transmission is a two-speed transmission.

The method may comprise a manual shifting mode. In the manual shifting mode, the transmission system 1000 can be upshifted in response to receiving a user-initiated upshift command. In the manual shifting mode, the transmission system 1000 can be downshifted in response to receiving a user-initiated downshift command. Thereto, a control unit may be configured to operate in a manual shifting mode, in which the control unit is configured to upshift and/or downshift the transmission system in response to receiving a user-initiated upshift and/or downshift command. In the manual shifting mode, the first transmission 100 may be upshifted and/or downshifted in response to a first operational shifter input, and the second transmission 200 may be upshifted and/or downshifted in response to a second operational shifter input.

The method may comprise an automatic shifting mode. In the automatic shifting mode, the transmission system can be automatically upshifted in response to determining a difference between a measured cadence, or a parameter representative thereof, and a target cadence. In the automatic shifting mode, the transmission system can be automatically downshifted in response to determining a difference between a measured cadence and a target cadence, or a parameter representative thereof.

In the automatic shifting mode, a fast automatic shifting mode or slow automatic shifting mode can be executed. The fast automatic shifting mode can be executed if a measured acceleration of the vehicle, or a parameter representative thereof, is higher than a predetermined acceleration threshold. The slow automatic shifting mode can be executed if the measured acceleration of the vehicle, or the parameter representative thereof, is lower than the predetermined acceleration threshold. The fast automatic shifting mode can be executed if a torque applied by a user, such as to a crank of the vehicle, or a parameter representative thereof, is higher than a predetermined torque threshold. The slow automatic shifting mode can be executed if the torque applied by the user, or the parameter representative thereof, is lower than the predetermined torque threshold. The fast automatic shifting mode can be executed if a rotational acceleration of the crank, i.e. an increase or decrease of cadence, or a parameter representative thereof, is higher than a predetermined crank acceleration threshold. The slow automatic shifting mode can be executed if the rotational acceleration of the crank, or the parameter representative thereof, is lower than the predetermined crank acceleration threshold. The fast automatic shifting mode can be executed if an inclination of the vehicle, or a parameter representative thereof, is higher than a predetermined inclination threshold. The slow automatic shifting mode can be executed if the inclination of the vehicle, or the parameter representative thereof, is lower than the predetermined inclination threshold.

In the fast automatic shifting mode, the transmission system can be automatically upshifted and/or downshifted in response to determining a difference between a measured cadence, or a parameter representative thereof, and a target cadence, by skipping system transmission ratios by only actuating the first transmission 100. Hence, a fast change of cadence can be achieved. In the fast automatic shifting mode, the second transmission 200 can be actuated for fine-tuning the cadence towards the target cadence. This is especially helpful if the fast change of cadence, achieved by only shifting the first transmission 100, results in a cadence that could be changed to a cadence closer to the target cadence by shifting the second transmission 200. The fine-tuning by actuating the second transmission 200 can be performed prior to, simultaneous with, or after actuating the first transmission 100. In the slow automatic shifting mode, transmission system 1000 can be automatically upshift and/or downshift the in response to determining a difference between a measured cadence, or a parameter representative thereof, and a target cadence, by not skipping any system transmission ratios. Hence, in the slow automatic shifting mode, the control unit can control the first and second transmissions 100, 200 to shift through consecutive system transmission ratios to the target system transmission ratio.

The method may comprise a semi-automatic shifting mode. In the semi-automatic shifting mode, the first and/or second transmission 100, 200 can be upshifted in response to user-initiated upshift commands. In the semi-automatic shifting mode, the transmission system 1000 can be downshifted automatically in response to determining a difference between a measured cadence, or a parameter representative thereof, and a target cadence. In the semi-automatic shifting mode, the transmission system can be automatically downshifted in response to determining a difference between a measured cadence, or a parameter representative thereof, and a target cadence, by skipping system transmission ratios by only actuating the first transmission 100. When automatically downshifting, the second transmission 200 can be actuated for fine-tuning the measured cadence towards the target cadence.

Table 7 shows an example of gear shifts in a transmission system wherein N=3 and M=2, for simplicity. The first transmission (TM1) 100 hear has three different gear ratios (gear 1, gear 2, gear 3). The second transmission (TM2), 200 has two different transmission ratios (gear A, gear B).

TABLE 7

| current | | | target gear | | | | | |
|---|---|---|---|---|---|---|---|---|
| gear | TM1 | TM2 | 1 | 2 | 3 | 4 | 5 | 6 |
| 1 | Gear 1 | Gear A | | TM2→B | TM1→2 | TM1→2 | TM1→2, 3 | TM1→2, 3 |
| | | | | | | TM2→B | | TM2→B |
| 2 | Gear 1 | Gear B | TM2→A | | TM1→2 | TM1→2 | TM1→2, 3 | TM1→2, 3 |
| | | | | | TM2→A | | TM2→A | |
| 3 | Gear 2 | Gear A | TM1→1 | TM1→1 | | TM2→B | TM1→3 | TM1→3 |
| | | | | TM2→B | | | | TM2→B |
| 4 | Gear 2 | Gear B | TM1→1 | TM1→1 | TM2→A | | TM1→3 | TM1→3 |
| | | | TM2→A | | | | TM2→A | |
| 5 | Gear 3 | Gear A | TM1→2, 1 | TM1→2, 1 | TM1→2 | TM1→2 | | TM2→B |
| | | | | TM2→B | | TM2→B | | |
| 6 | Gear 3 | Gear B | TM1→2, 1 | TM1→2, 1 | TM1→2 | TM1→2 | TM2→A | |
| | | | TM2→A | | TM2→A | | | |

In table 7 transmission changes from one of the six possible current transmission ratios to a target (different) one of the transmission rations are indicated. For instance, a gear ratio change from current gear 1 to target gear 6 would require the first transmission 100 to shift from gear 1 to gear 2 and from gear 2 to gear 3 (indicated as TM1→2,3), and the second transmission 200 to shift from gear A to gear B (indicated as TM2→B). This can be done by first shifting the first transmission from gear 1 to gear 2, i.e. from system transmission ratio 1 to 3, then shifting the first transmission from gear 2 to gear 3, i.e. from system transmission ratio 3 to 5, and finally shifting the second transmission from gear A to gear B, i.e. from system transmission ratio 5 to 6. From table 7 it is clear that for any transmission ratio change, the second transmission 200 shifts at most once (M−1). In this way, some system transmission ratios are skipped (here system transmission ratios 2 and 4). Hence, the transmission system can be efficiently shifted with a reduced number of shift actions steps while maintaining a good ‘feel’ of the transmission ratio change.

In an alternative example, for example, the first transmission (TM1) 100 here has seven different gear ratios (gear 1, gear 2, gear 3, gear 4, gear 5, gear 6, gear 7), and the second transmission (TM2), 200 has three different transmission ratios (gear A, gear B, gear C). Hence, N=7 and M=3, resulting in N×M=21 different system transmission ratios. Table 8 shows how the 21 possible transmission ratios can be obtained from the first and second transmission 100, 200.

TABLE 8

| current | | | target gear | | | | | |
|---|---|---|---|---|---|---|---|---|
| gear | TM1 | TM2 | 1 | 2 | 4 | . . . | 6 | 8 |
| 1 | Gear 1 | Gear A | | TM2→B | TM1→2 | . . . | TM1→2 | TM1→2, 3 |
| | | | | | | | TM2→B, C | TM2→B |
| 2 | Gear 1 | Gear B | TM2→A | | TM1→2 | . . . | TM2→C | TM1→2, 3 |
| | | | | | TM2→A | | | TM2→B |
| 3 | Gear 1 | Gear C | TM2→B, A | TM2→B | . . . | . . . | TM1→2 | TM1→2, 3 |
| | | | | | | | | TM2→C |
| 4 | Gear 2 | Gear A | TM1→1 | TM1→1 | | . . . | TM2→B, C | TM1→3 |
| | | | | TM2→B | | | | TM2→B |
| 5 | Gear 2 | Gear B | TM1→1 TM2→A | TM1→1 | TM2→A | . . . | TM2→C | TM1→3 |
| 6 | Gear 2 | Gear C | TM1→1 | TM1→1 | TM2→B, A | . . . | | TM1→3 |
| | | | TM2→B, A | TM2→B | | | | TM2→B |
| 7 | Gear 3 | Gear A | TM1→2, 1 | . . . | . . . | . . . | . . . | . . . |
| 8 | Gear 3 | Gear B | TM1→2, 1 | . . . | . . . | . . . | . . . | |
| | | | TM2→A | | | | | |
| 9 | Gear 3 | Gear C | TM1→2, 1 | . . . | . . . | . . . | . . . | . . . |
| | | | TM2→B, A | | | | | |
| 10 | Gear 4 | Gear A | TM1→3, 2, 1 | . . . | . . . | . . . | . . . | . . . |
| 11 | Gear 4 | Gear B | TM1→3, 2, 1 | . . . | . . . | . . . | . . . | . . . |
| | | | TM2→A | | | | | |
| 12 | Gear 4 | Gear C | TM1→3, 2, 1 | . . . | . . . | . . . | . . . | . . . |
| | | | TM2→B, C | | | | | |
| 13 | Gear 5 | Gear A | TM1→4, 3, 2, 1 | . . . | . . . | . . . | . . . | . . . |
| 14 | Gear 5 | Gear B | TM1→4, 3, 2, 1 | . . . | . . . | . . . | . . . | . . . |
| | | | TM2→A | | | | | |
| 15 | Gear 5 | Gear C | TM1→4, 3, 2, 1 | . . . | . . . | . . . | . . . | . . . |
| | | | TM2→B, A | | | | | |
| 16 | Gear 6 | Gear A | TM1→5, 4, 3, 2, 1 | . . . | . . . | . . . | . . . | . . . |
| 17 | Gear 6 | Gear B | TM1→5, 4, 3, 2, 1 | . . . | . . . | . . . | . . . | . . . |
| | | | TM2→A | | | | | |
| 18 | Gear 6 | Gear C | TM1→5, 4, 3, 2, 1 | . . . | . . . | . . . | . . . | . . . |
| | | | TM2→B, AC | | | | | |
| 19 | Gear 7 | Gear A | TM1→6, 5, 4, 3, 2, 1 | . . . | . . . | . . . | . . . | . . . |
| 20 | Gear 7 | Gear B | TM1→6, 5, 4, 3, 2, 1 | . . . | . . . | . . . | . . . | . . . |
| | | | TM2→A | | | | | |
| 21 | Gear 7 | Gear C | TM1→6, 5, 4, 3, 2, 1 | . . . | . . . | . . . | . . . | . . . |
| | | | TM2→B, A | | | | | |

Table 8 also shows some transitions from some current transmission ratios to some target transmission ratios. Even though not all possible transitions are written out in table 8, it will be appreciated that in principle all transitions are possible.

Although rather extreme, for instance, a gear ratio change from current gear 21 to target gear 1 would require the first transmission 100 to shift from gear 7 to gear 6 to gear 5 to gear 4 to gear 3 to gear 2 to gear 1 (indicated as TM1→6,5,4,3,2,1), and the second transmission 200 to shift from gear C to gear B to gear A (indicated as TM2→B,A). This can be done by first shifting the first transmission from gear 7 to gear 6, i.e. from system transmission ratio 21 to 18, then shifting the first transmission from gear 6 to gear 5, i.e. from system transmission ratio 18 to 15, and so on until the first transmission arrives at gear 1, i.e. system transmission ration 3, and finally shifting the second transmission from gear C to gear B, i.e. from system transmission ratio 3 to 2, and from gear B to gear A, i.e. to system transmission ration 1. From table 8 it is clear that for any transmission ratio change, the second transmission 200 shifts at most two times (M−1). In this way, some system transmission ratios are skipped. Hence, the transmission system can be efficiently shifted with a reduced number of shift actions steps while maintaining a good ‘feel’ of the transmission ratio change.

In the above examples, the second transmission 200 is upshifted or downshifted by the second integer number of steps, after the first transmission 100 has been upshifted or downshifted by the first integer number of steps. Hence, the system transmission ratio can be quickly increased or decreased by the relatively large increments of the first transmission (skipping in-between transmission ratios that could have been formed using the second transmission), and subsequently fine-tuned by the relatively small increments of the second transmission.

It will be appreciated that it is also possible that the first transmission 100 is upshifted or downshifted by the first integer number of steps, after the second transmission 200 has been upshifted or downshifted by the second integer number of steps. Optionally, one or more of the first integer number of steps, is performed between two of the second integer number of steps, and/or one or more of the second integer number of steps, is performed between two of the first integer number of steps.

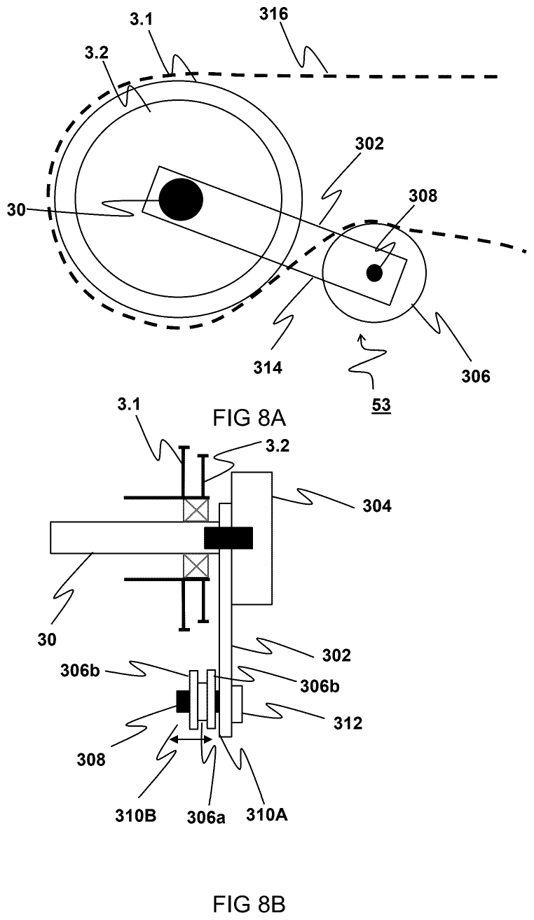

FIGS. 8A and 8B show an example of a derailleur 53 for use with the transmission system 1000, e.g. as described in view of FIGS. 4A-7C. In this example, the derailleur comprises a base member 302. The base member 302 is mounted to the frame 304 of the vehicle, such as a bicycle. Here, the base member 302 is mounted pivotally to the frame 304. In this example, the base member 302 is mounted pivotally about the axle 30.

The derailleur 53 further comprises a derailleur wheel 306. The derailleur wheel 306 is mounted to the base member 302. The derailleur wheel 306 is rotatable about an axis 308. The axis 308 is in this example parallel to the axle 30. The derailleur wheel 306 is axially movable along the axis 308. By moving the derailleur wheel 306 axially along the axis 308, the derailleur wheel can be positioned in alignment with a selected one of the sprockets 3.1, 3.2. In the example of FIGS. 8A and 8B, the derailleur wheel is axially movable between two positions. Hence, the derailleur 53 can e.g. be used with the transmission system of FIG. 4B, 5B, 6B or 7A. It will be appreciated that the derailleur wheel 306 can also be configured to be movable between three positions, e.g. for use with the transmission system of FIG. 7B, or four positions, e.g. for use with the transmission system of FIG. 7C. In this example, the derailleur wheel 306 is movable in axial direction between two end positions 310A, 310B. The end positions 310A, 310B can provide that the derailleur wheel 306 is positively positioned against a mechanical stop in either of the end positions. Hence, correct positioning of the derailleur wheel 306 is made very simple. The end positions 301A, 310B, can be adjustable, so as to adjust a correct position of the derailleur wheel 306 in the end positions relative to the endless drive member and the sprockets 3.1, 3.2.

In the example of FIG. 8B, the derailleur wheel 306 comprises a central portion 306a and two flanges 306b. The central portion 306a is configured to contact the endless drive member 316 along its perimeter. The central portion 306a may comprise teeth for engaging a chain or belt. The flanges 306b are configured to guide the endless drive member 316 laterally while moving from one sprocket to another.

In this example, a force for movement of the derailleur wheel 306 in axial direction is created by a rotation of the derailleur wheel 306. Hence, only a very limited external force is required for shifting the derailleur wheel from one axial position to another. A movement of the derailleur wheel 306 in axial direction can be initiated by an electric actuator 312. Hence, the electric actuator 312 can e.g. release the derailleur wheel 306 for axial movement, so that the force derived from rotation of the derailleur wheel 306 can provide the motive force for moving of the derailleur wheel to the other axial position. The electric actuator 312 can be configured to be controlled wirelessly. Thereto, the electric actuator can comprise, or be connected to a receiver. The electric actuator can be powered by an electric power storage element, such as a battery or an ultra-capacitor. Additionally, the derailleur 53 can comprise a solar cell electrically connected to the electric power storage element for charging the electric power storage element.

In this example, the derailleur 53 comprises a tensioner 314 for tensioning the endless drive member 316. Here, the tensioner 314 includes the derailleur wheel 306. In this example, the tensioner 314 comprises a resilient member, such as a spring, for biasing the derailleur wheel 306 to tension the endless drive member 316. In the view of FIG. 8A, the resilient member biases the base member 302 in counterclockwise rotation.

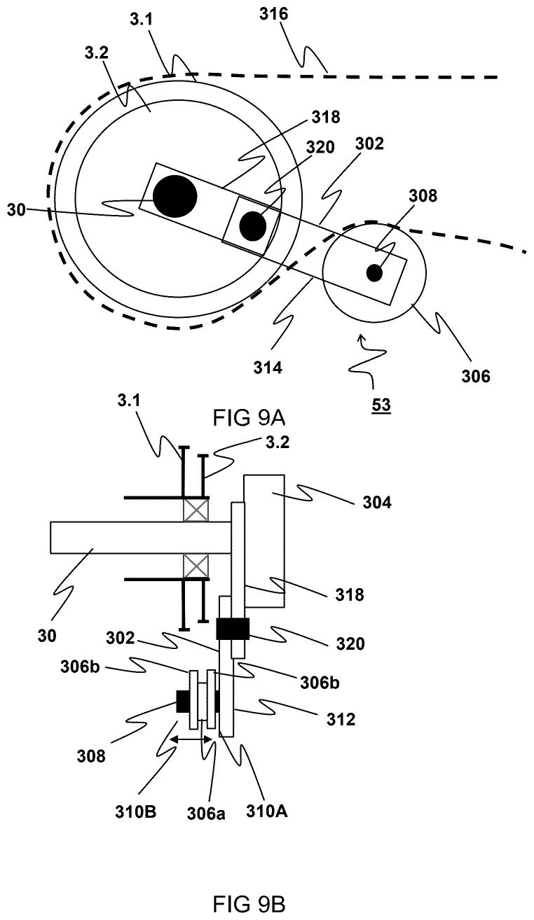

FIGS. 9A and 9B show another example of a derailleur 53 for use with the transmission system 1000, e.g. as described in view of FIGS. 4A-7C. In this example, the derailleur comprises a bracket 318. The bracket 318 is mounted to the frame 304 of the vehicle, such as a bicycle. Here, the bracket 318 is mounted around the axle 30. Here, the base member 302 is mounted pivotally to the bracket 318. In this example, the base member 302 is mounted pivotally about a pivot axis 320 on the bracket 318. The pivot axis 320 is parallel to and offset from the axle 30 in this case. For the remainder, the derailleur of FIGS. 9A and 9B is similar to the derailleur 53 as described in view of FIGS. 8A and 8B.

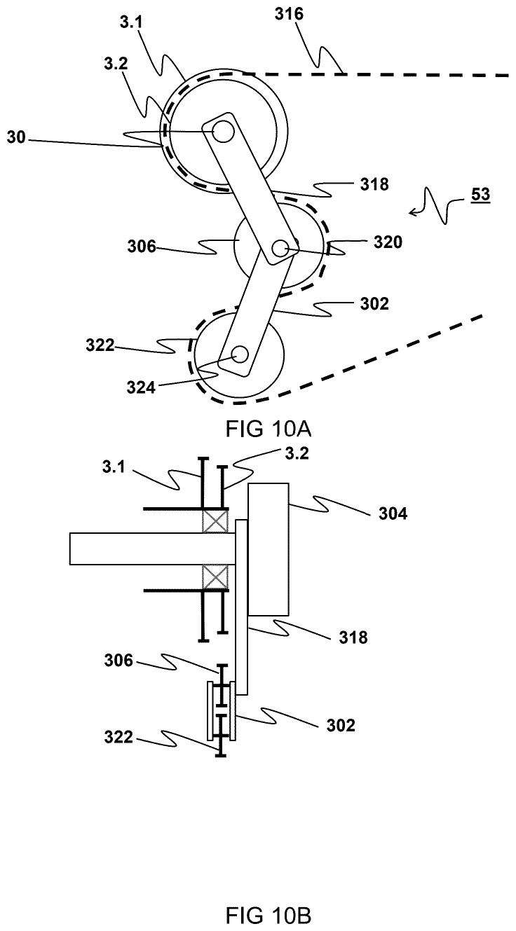

FIGS. 10A and 10B show another example of a derailleur 53 for use with the transmission system 1000, e.g. as described in view of FIGS. 4A-7C. In this example, the derailleur comprises a bracket 318. The bracket 318 is mounted to the frame 304 of the vehicle, such as a bicycle. Here, the bracket 318 is mounted around the axle 30. Here, the base member 302 is mounted pivotally to the bracket 318. In this example, the base member 302 is mounted pivotally about a pivot axis 320 on the bracket 318. The pivot axis 320 is parallel to and offset from the axle 30 in this case.

In the example of FIGS. 10A and 10B, the derailleur 53 comprises a tensioning wheel 322. The tensioning wheel 322 rotatable about an axis 324. In the view of FIG. 10A, the resilient member biases the base member 302 in clockwise rotation, so that the tensioning wheel 322 tensions the endless drive member 316. In this example, at least one of the derailleur wheel 306 and the tensioning wheel 322 is movable in axial direction. More specifically, here both the derailleur wheel 306 and the tensioning wheel 322 are movable in axial direction.

In view of the examples of FIGS. 8A-10B, the following can apply. The electric actuator 312 can be connected to the base member 302. The derailleur wheel 306 can have between 10 and 20, preferably between 12 and 18, teeth. The tensioning wheel 322 have between 10 and 20, preferably between 12 and 18, teeth. The derailleur can be configured to be connected to the frame or a dropout of the vehicle. The derailleur 53 can comprise a damper for damping a rotating of the tensioner with respect to the frame or dropout in at least one rotational direction, or in both rotational directions. The tensioner can be configured to allow removal of a driven wheel from the vehicle.

FIGS. 11A and 11B show two examples of a transmission system 1000 corresponding to the arrangement of FIG. 2C. Here, the transmission system 1000 is embodied as a crank transmission, wherein the first transmission 100 and the second transmission 200 are accommodated in a crank housing 52. The transmission system is here an offset crank transmission having an input axis A1 and an output axis A2 that are parallel and spaced apart from each other. The bicycle crank drives an input shaft 1 about the input axis A1. Here, the input shaft 1 is also drivable by an electric propulsion motor 50, here via a reduction gearing 51. The first transmission 100 is associated with the output axis A2. Here, the first transmission 100 is a nine-speed transmission as shown in FIGS. 6A, 6B.

In the example of FIG. 11A, the second transmission 200 is operative between the input axis A1 and the output axis A2. Here, the second transmission 200 includes two cooperating gear pairs 200A, 200B, each cooperating via a respective chain or belt 201, 202. It will be appreciated that the second transmission 200 here is, at least partially, non-coaxial with the first transmission 100. The first transmission 100 is coaxial about the second axis A2, while the second transmission 200 is partly coaxial about the first axis A1. A clutch mechanism 203 selectively connects either one of the two gear pairs 201, 202 with the input of the first transmission 100.

In the example of FIG. 11B, the second transmission 200 is associated with the output axis A2. Here the second transmission 200 includes a planetary gear set. Torque is transmitted in this example via a cooperating gear pair 200A, here via a chain or belt 201.

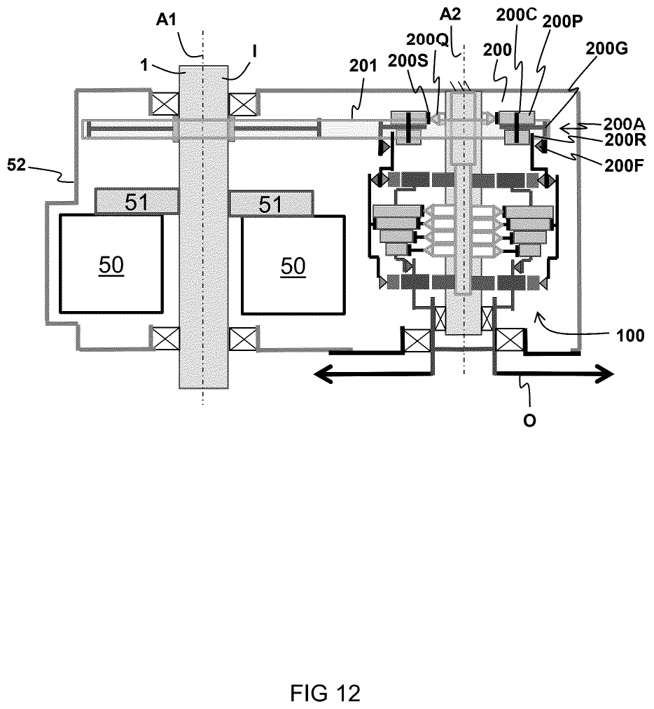

FIG. 12 shows an example of a transmission system 1000. Here, the transmission system 1000 is embodied as a crank transmission, wherein the first transmission 100 and the second transmission 200 are accommodated in a crank housing 52. The transmission system is here an offset crank transmission having an input axis A1 and an output axis A2 that are parallel and spaced apart from each other. The bicycle crank drives an input shaft 1 about the input axis A1. Here, the input shaft 1 is also drivable by an electric propulsion motor 50, here via a reduction gearing 51. The first transmission 100 is associated with the output axis A2. Here, the first transmission 100 is a nine-speed transmission as shown in FIGS. 6A, 6B and 6C.

In the example of FIG. 12, the second transmission 200 is associated with the output axis A2. Here the second transmission 200 includes a planetary gear set. In this example, the planetary gear set of the second transmission 200 is coaxial with the planetary gear set of the first transmission 100. In this example, the chain or belt 201 drives a pully 200G. The other pully, connected to the input shaft 1, is non-coaxial with the first transmission 100. The pully 200G is connected to a planet carrier 200C of the planetary gear set. The planet carrier 200C carries one or more stepped planet gears 200P. The smaller portion of the stepped planet gear 200P meshes with a ring gear 200R. The ring gear 200R drives the input of the first transmission 100. The larger portion of the stepped planet gear 200P meshes with a sun gear 200S. The sun gear 200S can be braked in at least one rotational direction, so as to prevent rotation of the sun gear 200S with respect to the axle 30 in that rotational direction. The braking can e.g. be performed with a clutch, for instance similar to the clutches C2.i. The braking can e.g. be performed with a brake pawl. The planet carrier 200C or pully 200G is further connected to the ring gear 200R or the input of the first transmission 100 via a freewheel 200F.

In a first mode, the sun gear 200S is not braked, and thus free to rotate. In that case, the pully 200G will drive the input of the first transmission 100 via the freewheel 200F. Hence, a 1:1 transmission is obtained from the pully 200G to the input I1 of the first transmission. In a second mode, the sun gear 200S is braked. In that case, the pully 200G will drive the ring gear 200R (via the planet carrier 200C and planet gears 200P) according to a speed increasing transmission ratio. Hence, the freewheel 200F will be overrun. Thus, in a very simple manner, the second transmission 200 can provide the two different transmission ratios.

In the example of FIG. 12, the planetary gear set of the second transmission 200 is coaxial with the second axis A2. It will be clear that alternatively the planetary gear set of the second transmission 200 can be coaxial with the first axis A1. In that case, the output of the planetary gear set will be connected to the pully that drives the chain or belt 201. The chain or belt 201 then in turn drive the pully 200G connected to the input 11 of the first transmission.

In the example of FIG. 12, the first transmission 100 and second transmission 200 are both housed in a crank unit. It will be appreciated that the first transmission 100 and second transmission 200 as described in view of FIG. 12 can also both be housed in a wheel hub. In that case, the pully 200G can e.g. be driven in rotation by a chain or belt by a front sprocket.

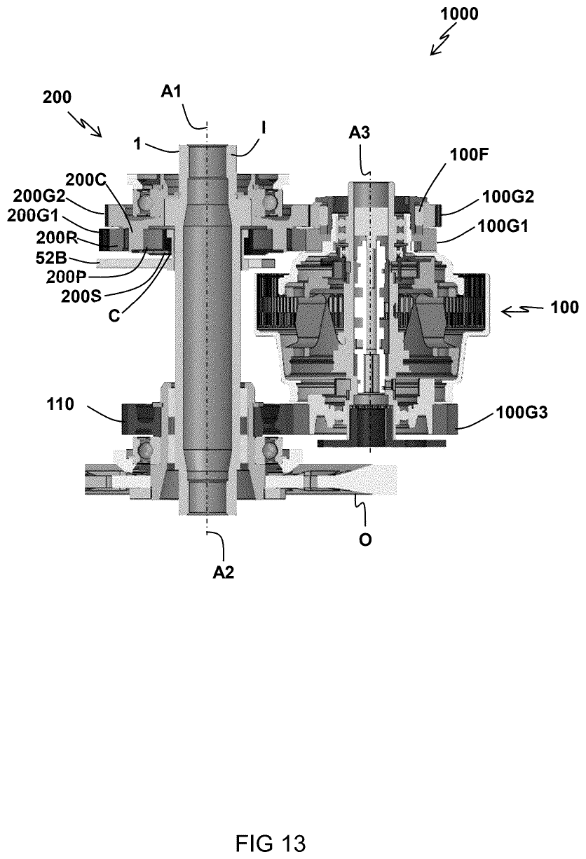

FIG. 13 shows an example of a transmission system 1000. Here, the transmission system 1000 is embodied as a crank transmission, wherein the first transmission 100 and the second transmission 200 are accommodated in a crank housing (not shown). The transmission system is here a crank transmission having an input axis A1 and an output axis A2 that are concentric to each other. The bicycle crank drives an input shaft 1 about the input axis A1. The input shaft 1 could also be driven by an electric propulsion motor, e.g. via a reduction gearing. The first transmission 100 is associated with an offset axis A3. The offset axis A3 is parallel to the input axis A1. Here, the first transmission 100 is a seven-speed transmission, e.g. as shown in FIGS. 5A, 5B and 5C.

In the example of FIG. 13, the second transmission 200 is associated with the input axis A1. Here the second transmission 200 includes a planetary gear set. In this example, the input shaft 1 is connected to a planet carrier 200C of the planetary gear set. The planet carrier 200C carries one or more planet gears 200P. The planet gears 200P mesh with a ring gear 200R. The planet gear 200P also meshes with a sun gear 200S. The sun gear 200S can be braked in at least one rotational direction, so as to prevent rotation of the sun gear 200S with respect to the crank housing, e.g. to a bracket 52B fixed to the crank housing, in that rotational direction. The braking can e.g. be performed with a clutch C, for instance similar to the clutches C2.i. The braking can e.g. be performed with a brake pawl. The ring gear 200R in this example has a first external gear 200G1 connected thereto. The first external gear 200G1 drives a first input gear 100G1 connected to the input of the first transmission 100. The planet carrier 200C in this example has a second external gear 200G2 connected thereto. The second external gear drives a second input gear 100G2 connected to the input of the first transmission 100 via a freewheel 100F. It will be appreciated that in this example, the second transmission 200 is non-coaxial with the first transmission 100. In particular, here, the second transmission 200 is parallel and offset relative to the first transmission 100.

In a first mode, the sun gear 200S is not braked, and thus free to rotate. In that case, the second external gear 200G2 will drive the input of the first transmission 100 via the freewheel 100F. In a second mode, the sun gear 200S is braked. In that case, the input shaft will drive the ring gear 200R (via the planet carrier 200C and planet gears 200P) according to a speed increasing transmission ratio. Hence, the first external gear 200G1 will drive the first input gear 100G1 of the first transmission 100. Herein, the freewheel 100F will be overrun. Thus, in a very simple manner, the second transmission 200 can provide the two different transmission ratios.

The first transmission further comprises an output gear 100G3. The output gear 100G3 meshes with a gear 110. The gear 110 is fixed to the output O of the transmission system. Here the output O includes the chain ring 10019 in this example.

It will be appreciated that instead of meshing gears transferring torque from the input axis A1 to the offset axis A3 and then to the output axis A2, torque may also be transferred by pulleys and belts as described in view of FIGS. 11A, 11B and 12.

The transmission system 1000 comprising the first transmission 100 and second transmission 200, as described herein, can be used in a human-powered vehicle or light electric vehicle, such as a bicycle, with an electric propulsion motor. In particular, the electric propulsion motor can be housed in a crank unit. For bicycles this is often referred to as a mid-motor configuration.

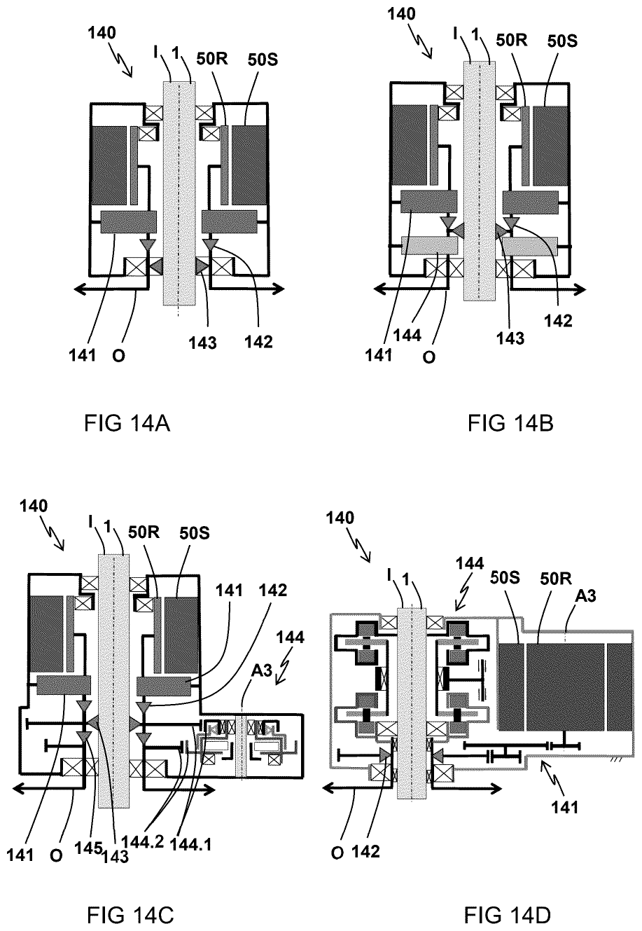

FIG. 14A shows an example of a crank unit 140. The input I of the crank unit 140 is formed by the input shaft 1. The input shaft drives the output O, here including the chain ring. The crank unit 140 comprises a propulsion motor 50. In this example, the motor 50 is concentric with the input shaft 1. The motor 50 has a stator 50S and a rotor 50R. Torque from the motor 50 can be fed through a speed reduction 141 to the output O. A first freewheel 142 may be interposed between the motor 50 and the output O to allow rotation of the output while the rotor 50R rotates at a lower speed than the output, or when the rotor 50R does not rotate. A second freewheel 143 may be interposed between the input shaft 1 and the output O, to allow rotation of the output while the input shaft 1 rotates at a lower speed than the output, or when the input shaft 1 does not rotate.

FIG. 14B shows an example of a crank unit 140 similar to the crank unit of FIG. 14A. In the example of FIG. 14B the crank unit 140 comprises a transmission 144. Here an input of the transmission 144 is connected to an output of the motor 50 (e.g. via the first freewheel 142). Here the input of the transmission 144 is connected to the input shaft 1 (e.g. via the second freewheel 143). In this example, the transmission 144 is concentric with the input shaft 1. The transmission 144 can e.g. be the first transmission 100 and/or the second transmission 200 as described herein.

FIG. 14C shows an example of a crank unit 140 similar to the crank unit of FIG. 14B. In the example of FIG. 14C the crank unit 140 comprises a transmission 144. Here an input of the transmission 144 is connected to an output of the motor 50 (e.g. via the first freewheel 142). Here the input of the transmission 144 is connected to the input shaft 1 (e.g. via the second freewheel 143). In this example, the transmission 144 is concentric with an offset axis A3. The transmission 144 can e.g. be the first transmission 100 and/or the second transmission 200 as described herein. In this example, torque can be transferred from the input I and/or motor 50 to the output O via the transmission 144 (e.g. via first gear pair 144.1 and second gear pair 144.2) or via a third freewheel 145. It will be appreciated that the transmission 144 can comprise a clutch for selectively coupling the gears associated with the offset axis A3 of the gear pairs 144.1 and 144.2.

FIG. 14D shows an example of a crank unit 140. The input I of the crank unit 140 is formed by the input shaft 1. The input shaft drives the output O, here including the chain ring. The crank unit 140 comprises a propulsion motor 50. In this example, the motor 50 is offset with respect the input shaft 1. Torque from the motor 50 can be fed through a speed reduction 141 to the output O. A first freewheel 142 may be interposed between the motor 50 and the output O to allow rotation of the output while the rotor 50R rotates at a lower speed than the output, or when the rotor 50R does not rotate. In this example, a transmission 144 is interposed between the input I and the output O. Here, the transmission 144 is embodied as a continuously variable transmission, CVT. An example of a suitable CVT is for example described in WO2022248136, the contents of which are hereby incorporated by reference in its entirety. In this example, the motor 50 is connected to an output of the transmission 144. Hence, the transmission 144 need not transfer torque from the motor 50.

Thus, in an embodiment, the transmission system 1000 can comprise a first transmission 100 and a second transmission 200 in series, wherein the first transmission 100 is configured to switch between a plurality of discrete transmission ratios having a step-size between adjacent transmission ratios, and wherein the second transmission 200 is a continuously variable transmission, CVT, having a ratio-coverage similar to or smaller than the step-size. When the first transmission 100 provides N1 transmission ratios, the ratio coverage of the first transmission 100 can be about N1−1 times the ratio coverage of the CVT. Hence, the first transmission 100 can provide a ratio coverage that is larger than the ratio-coverage of the CVT. A method for shifting such transmission system 1000 to a target transmission ratio is described next. The target transmission ratio can be determined on the basis of user input, such as a user-initiated upshift and/or downshift command. The target transmission ratio can be determined automatically, e.g. on the basis of measured parameters, such as a measured cadence and a measured vehicle speed.

The method can comprise shifting the first transmission 100 to a transmission ratio that deviates from the target transmission ratio by less than a transmission ratio that is within the continuous range of transmission ratios of the CVT. The method can comprise determining a deviation ratio of the target transmission ratio divided by the transmission ratio (to be) set by the first transmission 100. The method can comprise shifting the CVT to the deviation ratio. Hence, the transmission system 1000 can be set to a target transmission ratio anywhere in the range of transmission ratios of the transmission system 1000, even though the ratio-coverage of the CVT is smaller than the range of transmission ratios of the transmission system 1000. The transmission system 1000 can be controlled to shift between a plurality of discrete transmission systems. It is also possible to control the transmission system 1000 to provide a continuously variable transmission ratio within the entire range of transmission ratios of the transmission system.

The transmission ratio (to be) set by the first transmission 100 can be selected to always be smaller than, or equal to, the target transmission ratio. This can be advantageous when using a CVT of the ratcheting type, e.g. a CVT as described in WO2022248136, the contents of which are hereby incorporated by reference in its entirety. It is also possible to set the first transmission 100 to a transmission ratio closest to the target transmission ratio, i.e. being smaller, equal or larger than the target transmission ratio. This can be useful when using a CVT that can provide both speed-increasing and speed-decreasing transmission ratios.

The method may comprise a first mode. In the first mode, when shifting to the target transmission ratio requires shifting multiple steps of the first transmission 100, the method can comprise refraining from shifting the CVT while shifting the multiple steps of the first transmission. Hence, the target transmission ratio can be achieved very fast.

The method may comprise a second mode. In the second mode, when shifting to the target transmission ratio requires shifting multiple steps of the first transmission, the method can comprise shifting the CVT between shifting each two adjacent steps of the multiple steps of the first transmission, so as to obtain a continuous transmission ratio change. Hence, the target transmission ratio is approached in a continuously variable fashion. Hence, the target transmission ratio can be achieved smoothly.

The method can comprise determining an acceleration of the vehicle, or a parameter representative thereof. The first mode can e.g. be executed if a measured acceleration of the vehicle is higher than a predetermined acceleration threshold. The second mode can e.g. be executed if the measured acceleration of the vehicle is lower than the predetermined acceleration threshold. Hence, depending on the vehicle acceleration, the target transmission ratio can be achieved with an emphasis on fastness or smoothness.

The method can comprise determining torque applied by a user, such as to a crank of the vehicle, or a parameter representative thereof. The first mode can e.g. be executed if a measured torque is higher than a predetermined torque threshold. The second mode can e.g. be executed if the measured torque is lower than the predetermined torque threshold. Hence, depending on the torque, the target transmission ratio can be achieved with an emphasis on fastness or smoothness.

The method can comprise determining a rotational acceleration of the crank, i.e. an increase or decrease of cadence, or a parameter representative thereof. The first mode can e.g. be executed if a measured rotational acceleration of the crank is higher than a predetermined crank acceleration threshold. The second mode can e.g. be executed if the measured rotational acceleration of the crank is lower than the predetermined crank acceleration threshold. Hence, depending on the crank acceleration, the target transmission ratio can be achieved with an emphasis on fastness or smoothness.

The method can comprise determining an inclination of the vehicle, or a parameter representative thereof. The first mode can e.g. be executed if a measured inclination of the vehicle is higher than a predetermined inclination threshold. The second mode can e.g. be executed if the measured inclination of the vehicle is lower than the predetermined inclination threshold. Hence, depending on the vehicle inclination, the target transmission ratio can be achieved with an emphasis on fastness or smoothness.

The method can comprises measuring a cadence and a vehicle speed, or parameters representative thereof, and automatically maintain the measured cadence at a target cadence, or at least within a target cadence interval, by automatically renewing the target transmission ratio on the basis of the measured cadence and vehicle speed.

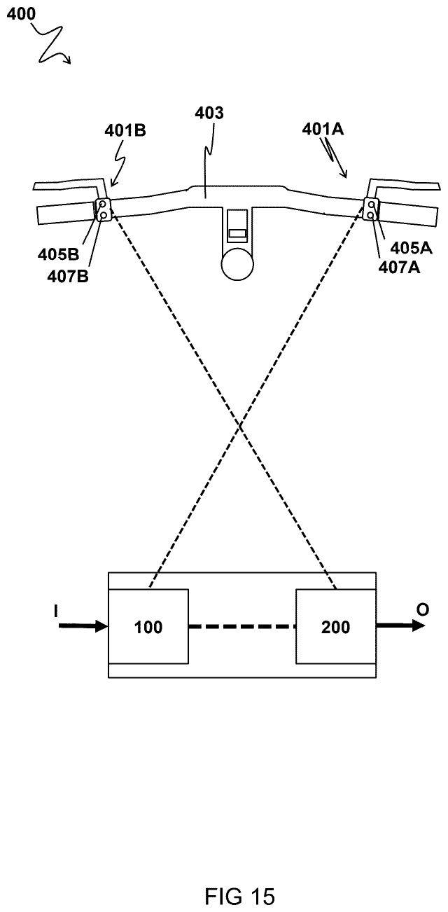

FIG. 15 shows a schematic example of a control system 400 for controlling a the transmission system 1000.

In this example, the transmission 1000 includes the first transmission 100 connected to the input of the second transmission 200. However, it will be appreciated that it is also possible that the second transmission 200 is connected to the input of the first transmission 100 as explained above. The first transmission 100 and the second transmission 200 are here both electrically actuatable. The first transmission 100 includes a first electrically actuatable shift actuator. The second transmission 200 includes a second electrically actuatable shift actuator.

In this example, the control system 400 comprises a first control device 401A, and a second control device 401B. Here the control devices 401A, 401B are mounted to handlebar 403. In this example the first control device 401A is mounted to the right hand grip portion. In this example the second control device 401B is mounted to the left hand grip portion. Each control device 401A, 401B comprises one or more operating elements 405A, 405B, 407A, 407B. The operating elements can e.g. be buttons, sliders, levers, rotatable rings, or the like. In this example the first control device 401A includes the first operating elements 405A, 407A. In this example the second control device 401B includes the second operating elements 405B, 407B.

In the example of FIG. 15, the first control device 401A is configured for controlling the first transmission 100, and the second control device 401B is configured for controlling the second transmission 200. For example, e.g. a user, actuating the first second operating element 405B can shift the second transmission 200 to the next higher second transmission transmission ratio. For example, e.g. a user, actuating the second second operating element 407B can shift the second transmission 200 to the next lower second transmission transmission ratio. For example, e.g. a user, actuating the first first operating element 405A can shift the first transmission 100 to the next higher first transmission transmission ratio. For example, e.g. a user, actuating the second first operating element 407A can shift the first transmission 100 to the next lower first transmission transmission ratio. It will be appreciated that it is also possible that the first control device 401A is configured for controlling the second transmission 200, and the second control device 401B is configured for controlling the first transmission 100.

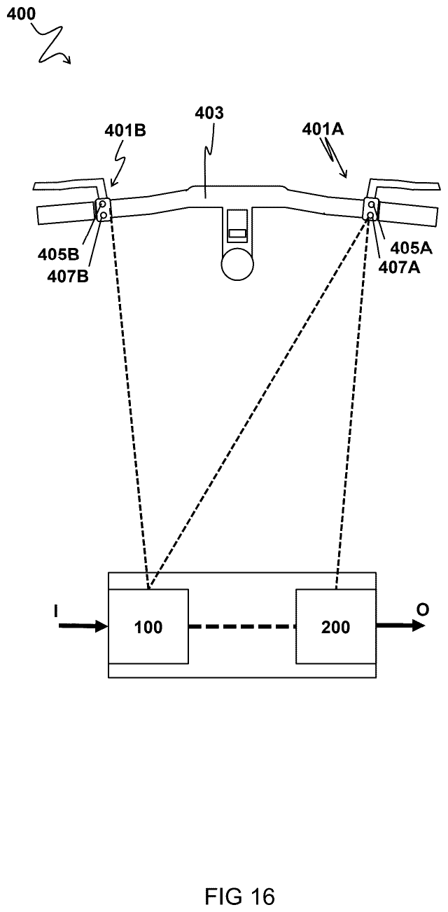

FIG. 16 shows a schematic example of a control system 400 for controlling a the transmission system 1000. In this example, the transmission 1000 includes the first transmission 100 connected to the input of the second transmission 200. However, it will be appreciated that it is also possible that the second transmission 200 is connected to the input of the first transmission 100 as explained above. The first transmission 100 and the second transmission 200 are here both electrically actuatable. The first transmission 100 includes a first electrically actuatable shift actuator. The second transmission 200 includes a second electrically actuatable shift actuator.

In the example of FIG. 16, the second control device 401B is configured for controlling the first transmission 100. In the example of FIG. 16, the first control device 401A is configured for controlling both the first transmission 100 and the second transmission 200. For example, e.g. a user, actuating the first second operating element 405B can shift the first transmission 100 to the next higher first transmission transmission ratio. For example, e.g. a user, actuating the second second operating element 407B can shift the first transmission 100 to the next lower first transmission transmission ratio. For example, e.g. a user, actuating the first first operating element 405A can shift the first transmission 100 and/or second transmission 200 to the next higher system transmission ratio. For example, e.g. a user, actuating the second first operating element 407A can shift the first transmission 100 and/or the second transmission to the next lower system transmission ratio. It will be appreciated that it is also possible that the first control device 401A is configured for controlling the first transmission 100, and the second control device 401B is configured for controlling both the first transmission 100 and the second transmission 200. More in general, one of the first and the second control devices 401A, 401B can be configured for controlling one of the first and second transmissions 100, 200, and the other one of the first and the second control devices 401A, 401B can be configured for controlling both the first and second transmissions.

In this example, the first control device 401A is configured to determine, on the basis of the current system transmission ratio, and the first next higher or first next lower system transmission ratio to be switched to, which one(s) of the first transmission 100 and the second transmission 200 should be activated to change its gear ratio. It will be appreciated that an upshift to the first next higher system transmission ratio of the transmission system 1000 may involve a downshift of the gear ratio of one of the first or second transmission 100, 200 in combination with an upshift of the gear ratio of the other one of the first and second transmission 100, 200. Similarly, a downshift to the first next lower system transmission ratio of the transmission system 1000 may involve an upshift of the gear ratio of one of the first or second transmission 100, 200 in combination with a downshift of the gear ratio of the other one of the first and second transmission 100, 200. The first control device 401A thus controls one or more shift actuators of the transmission system 1000 in response to the upshift or downshift command provided by the cyclist. Depending on the system transmission ratio used at that point in time, the next higher system transmission ratio can be obtained by actuating one or more shift actuators. The first control device 401A may be configured to select and actuate the appropriate shift actuator(s) of the first and second transmission 100, 200.

In the examples of FIGS. 15 and 16, the first control device 401A and the second control device 401B are in direct communicative connection with the first and/or second transmission 100, 200. The communicative connection can be wired and/or wireless.

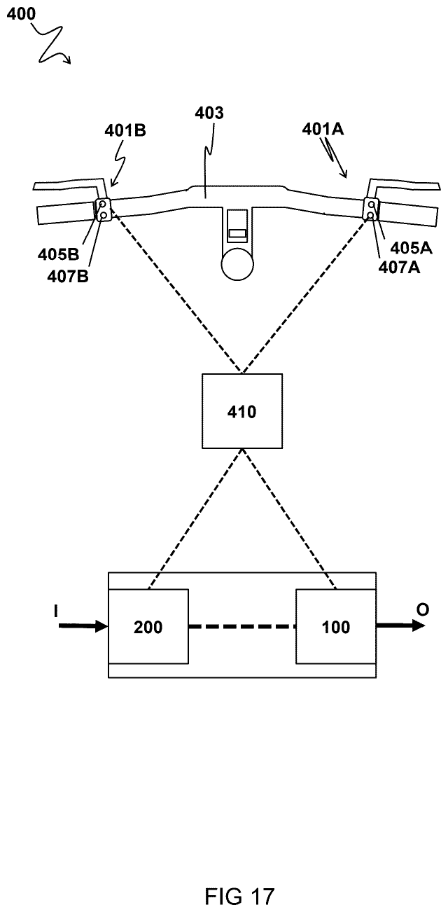

FIG. 17 shows a schematic example of a control system 400 for controlling a the transmission system 1000. In this example, the transmission 1000 includes the first transmission 100 connected to the output of the second transmission 200. However, it will be appreciated that it is also possible that the second transmission 200 is connected to the output of the first transmission 100 as explained above. The first transmission 100 and the second transmission 200 are here both electrically actuatable. The first transmission 100 includes a first electrically actuatable shift actuator. The second transmission 200 includes a second electrically actuatable shift actuator. The example of FIG. 17 includes a control unit 410. In this example, the first control device 401A and the second control device 401B are in communicative connection the control unit 410. The communicative connection can be wired and/or wireless. In this example, the transmission 100 and the second transmission 200 are in communicative connection with the control unit 410. The communicative connection can be wired and/or wireless.

The control unit 410 can be a separate unit on the vehicle. The control unit 410 can be integrated with the first control device 401A. The control unit 410 can be integrated with the second control device 401B. The control unit 410 can be integrated with the first transmission 100. The control unit 410 can be integrated with the second transmission 200. The control unit 410 can e.g. be housed in, or connected to, a crank gearbox housing. The control unit 410 can e.g. be housed in, or connected to, a hub assembly. The control unit 410 can e.g. be housed in, or connected to, a rear derailleur.

In the example of FIG. 17, the first control device 401A can be configured for controlling the first transmission 100, and the second control device 401B can be configured for controlling the second transmission 200, or vice versa, as explained in relation to FIG. 15. In the example of FIG. 16, one of the first and the second control devices 401A, 401B can be configured for controlling one of the first and second transmissions 100, 200, and the other one of the first and the second control devices 401A, 401B can be configured for controlling both the first and second transmissions 100, 200, e.g. as explained in relation to FIG. 16.

It will be appreciated that the first and second control devices 401A, 401B can include transmitters for wirelessly transmitting a gear shift command to the control unit 410 or to the transmissions 100, 200. It will be appreciated that control unit 410 can include a transmitter for wirelessly transmitting a gear shift command to transmissions 100, 200. It will be appreciated that control unit 410 can include a receiver for wirelessly receiving a gear shift command from the first and second control devices 401A, 401B. It will be appreciated that transmission 100, 200 can include a receiver for wirelessly receiving a gear shift command from the first and second control devices 401A, 401B or the control unit 410.

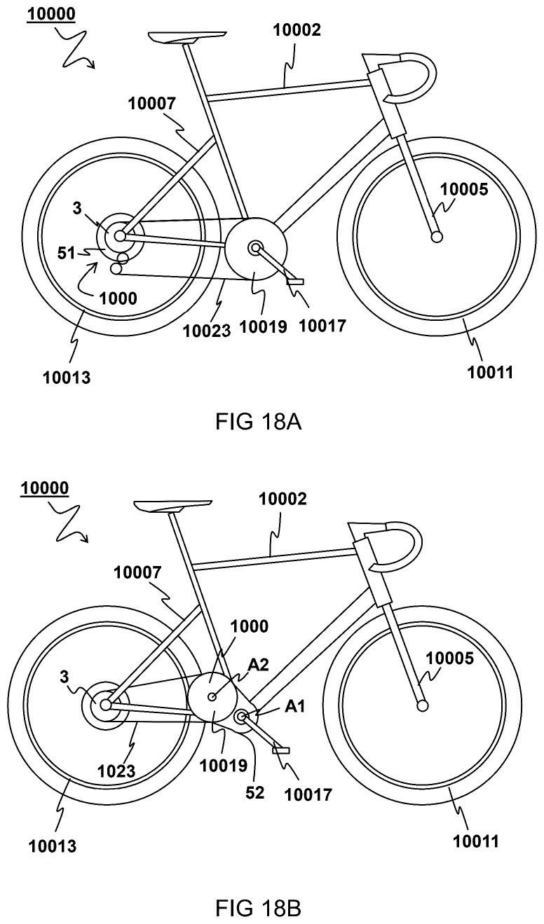

FIGS. 18A and 18B show a bicycle 10000. The bicycle 10000 comprises a frame 10002 with a front fork 10005 and a rear fork 10007, as well as a front wheel and a rear wheel 10011, 10013 located in the front and rear fork respectively. The bicycle 10000 further comprises a crank 10017, and a front chain wheel 10019. The bicycle 10000 comprises a transmission system 1000 as described herein. In the example of FIG. 18A, the first transmission 100 is embodied as a hub transmission, and the second transmission 200 is embodied as an external cassette-based transmission, here including a derailleur. In the example of FIG. 18B, the transmission system 1000 is embodied as a crank transmission, wherein the first transmission 100 and the second transmission 200 are accommodated in a crank housing 52, e.g. as shown in FIG. 11A, 11B or 12. The bicycle 10000 also comprises chain 10023 connecting a front chain wheel 10019 with a rear sprocket 3.

### Embodiments

The disclosure will now further describe the following numbered embodiments. It will be appreciated that some or all of the embodiments summarize aspects of the disclosure as provided in the detailed description and the figures. Accordingly, the embodiments are also to be read in connection with the preceding paragraphs and the appended figures, and do not limit the disclosure. The features and preferences as described hereinabove apply also to the following embodiments.

Embodiment 1. A transmission system for a human-powered vehicle or light electric vehicle, such as a bicycle, comprising
a multi-speed first transmission operative between a transmission system input and a transmission system output; and
a multi-speed second transmission connected in series with the first transmission;
wherein a transmission ratio step size between successive transmission ratios of the second transmission is smaller than a transmission ratio step size between successive transmission ratios of the first transmission.

Embodiment 2. The transmission system of embodiment 1, wherein the ratio-coverage of the first transmission is larger, such as at least two times larger, e.g. at least three times larger, than the ratio-coverage of the second transmission.

Embodiment 3. The transmission system of embodiment 1 or 2, wherein the second transmission is non-coaxial with the first transmission.

Embodiment 4. The transmission system of embodiment 1, 2 or 3, wherein the second transmission includes an offset gear transmission, a belt or chain transmission, a continuously variable transmission, a derailleur and sprockets, and/or a planetary gear system having a central axis offset relative to a central axis of the first transmission.

Embodiment 5. The transmission system of any of embodiments 1-4, wherein the first transmission includes a planetary gear system having three or more sun gears.

Embodiment 6. The transmission system of any of embodiments 1-5, wherein the first transmission has more different ratios than the second transmission.

Embodiment 7. The transmission system of embodiment 6, wherein the first transmission has at least twice as much different ratios than the second transmission.

Embodiment 8. The transmission system of embodiment 6 or 7, wherein the first transmission has four or more different ratios and the second transmission has four or less than four different ratios.

Embodiment 9. The transmission system of any of embodiments 1-8, wherein the ratio-coverage of the first transmission is 450% or more.

Embodiment 10. The transmission system according to any of embodiments 1-9, wherein the first transmission includes a speed reducing and/or a speed increasing transmission ratio, preferably both a speed reducing and speed increasing transmission ratio.

Embodiment 11. The transmission system according to any of embodiments 1-10, wherein the first transmission comprises or is an integrated hub transmission.

Embodiment 12. The transmission system according to any of embodiments 1-10, wherein the first transmission is integrated in a crank unit.

Embodiment 13. The transmission system according to embodiment 12, wherein the first transmission is placed laterally offset relative to a crank axle of the crank unit.

Embodiment 14. The transmission system according to any of embodiments 1-13, wherein the second transmission comprises at least two sprockets and at most four sprockets and an endless drive member, such as a chain or belt, selectively engaged with either one of these sprockets.

Embodiment 15. The transmission system according to any of embodiments 1-13, wherein the second transmission is integrated in a crank unit.

Embodiment 16. The transmission system according to embodiment 15, wherein the second transmission is concentric with the crank axle of the crank unit.

Embodiment 17. The transmission system according to embodiments 13 and 15, wherein the second transmission comprises, or is, an offset gear stage.

Embodiment 18. The transmission system according to any of embodiments 1-17, wherein:
a) the first transmission comprises, or is, an integrated hub transmission, and the second transmission comprises at least two sprockets and an endless drive member, such as a chain or belt, selectively engaged with either one of these sprockets; or
b) the first transmission comprises, or is, an integrated hub transmission, and the second transmission comprises an integrated crank transmission; or
c) the first transmission comprises, or is, an integrated crank transmission, and the second transmission comprises at least two sprockets and an endless drive member, such as a chain or belt, selectively engaged with either one of these sprockets; or
d) the first transmission and the second transmission are integrated in an integrated crank transmission.

Embodiment 19. The transmission system according to any of embodiments 1-18, further comprising an electric propulsion motor, wherein the electric propulsion motor can e.g. be connected to the input of the first transmission, the input of the second transmission, the output of the first transmission, or the output of the second transmission.

Embodiment 20. The transmission system of embodiment 19, wherein the electric propulsion motor is integrated in the crank unit, e.g. mounted concentric with a crank axle.

Embodiment 21. The transmission system of embodiment 19, wherein the electric propulsion motor is mounted concentric with a hub axle.

Embodiment 22. The transmission system according to embodiment 19, 20 or 21, wherein:
A) the first transmission comprises, or is, an integrated hub transmission, the second transmission comprises at least two sprockets and an endless drive member, such as a chain or belt, selectively engaged with either one of these sprockets, and the electric propulsion motor is placed in the crank unit; or
B) the first transmission comprises, or is, an integrated hub transmission, and the second transmission and the electric propulsion motor are integrated in the crank unit; or
C) the first transmission and the electric propulsion motor are integrated in the crank unit, and the second transmission comprises at least two sprockets and an endless drive member, such as a chain or belt, selectively engaged with either one of these sprockets; or
D) the first transmission, the second transmission, and the electric propulsion motor are integrated in the crank unit.

Embodiment 23. The transmission system according to embodiment 14, or any of embodiments 15-22 as far as dependent on embodiment 14, wherein the sprockets are divided in segments and the segments can be actuated to shift the endless drive member from one of the sprockets to another.

Embodiment 24. The transmission system according to any of embodiments embodiment 14-23, wherein the at least two sprockets each have between 16 and 32, such as between 20 and 28, teeth.

Embodiment 25. The transmission system according to any of embodiments 14-24, wherein the at least two sprockets have a teeth difference of at least two teeth and at most three teeth.

Embodiment 26. The transmission system according to any of embodiments 14-25, wherein the at least two sprockets have 21 and 24 teeth, or 22 and 25 teeth, or 23 and 26, or 25 and 28 teeth.

Embodiment 27. The transmission system according to any of embodiments 14-26, comprising a derailleur wheel, which derailleur wheel can be actuated to shift the endless drive member from one of the sprockets to another.

Embodiment 28. The transmission system according to any of embodiments 14-27, comprising a chain guide, which chain guide can be actuated to shift the endless drive member from one of the sprockets to another.

Embodiment 29. The transmission system according to any of embodiments 14-28, wherein the sprockets of the second transmission are connected to an input, such as a driver, of the first transmission.

Embodiment 30. The transmission system according to any of embodiments 14-29, wherein the sprockets of the second transmission are connected, such as via the endless drive member, to an output, such as a chainring, of the first transmission.

Embodiment 31. The transmission system according to embodiment 29 or 30, wherein the first transmission is located near or around the crank.

Embodiment 32. The transmission system according to any of embodiments 27-31, wherein the derailleur wheel and/or the chain guide is movable in axial direction with respect to the sprockets.

Embodiment 33. The transmission system according to embodiment 32, wherein the derailleur wheel and/or chain guide is movable in axial direction with respect to the sprockets between two end positions.

Embodiment 34. The transmission system according to any of embodiments 27-33, wherein a force for movement of the derailleur wheel and/or chain guide in axial direction is created by a rotation of the derailleur wheel.

Embodiment 35. The transmission system according to any of embodiments 27-34, wherein movement of the derailleur wheel and/or chain guide in axial direction is initiated by an electric actuator.

Embodiment 36. The transmission system according to embodiment 35, wherein the electric actuator is configured to be wirelessly controlled.

Embodiment 37. The transmission system according to embodiment 35 or 36, wherein the electric actuator is powered by an electric power storage element, such as a battery or an ultra-capacitor.

Embodiment 38. The transmission system according to embodiment 35, 36 or 37, wherein the electric actuator is powered via an electric wire by an electric power storage element of an E-bike propulsion battery.

Embodiment 39. The transmission system according to embodiment 37 or 38, comprising a solar cell electrically connected to the electric power storage element for charging the electric power storage element.

Embodiment 40. The transmission system according to any of embodiments 14-39, comprising a tensioner for tensioning the endless drive member.

Embodiment 41. The transmission system according to embodiment 40, wherein the tensioner includes the derailleur wheel.

Embodiment 42. The transmission system according to embodiment 40, wherein the tensioner is the derailleur wheel.

Embodiment 43. The transmission system according to embodiment 40 or 42, wherein the tensioner includes a tensioning wheel.

Embodiment 44. The transmission system according to embodiment 41 and 43, wherein at least one of the derailleur wheel and the tensioning wheel is movable in axial direction with respect to the sprockets.

Embodiment 45. The transmission system according to any of embodiments 40-44, wherein the tensioner comprises a base member.

Embodiment 46. The transmission system according to embodiment 45, wherein the base member is movable in axial direction with respect to the sprockets.

Embodiment 47. The transmission system according to embodiment 45 or 46, wherein the base member is rotatable with respect to the frame.

Embodiment 48. The transmission system according to any of embodiments 45-47, as far as dependent from embodiment 35, wherein the electric actuator is connected to the base member.

Embodiment 49. The transmission system according to any of embodiments 45-48, as far as dependent from embodiments 43 and 45, wherein the derailleur wheel is rotatably mounted to the base member, and the tensioning wheel is rotatably mounted to the base member.

Embodiment 50. The transmission system according to any of embodiments 27-49, wherein the derailleur wheel and the tensioning wheel have between 10 and 20, preferably between 12 and 18, teeth.

Embodiment 51. The transmission system according to any of embodiments 40-50, wherein the tensioner is configured to be connected to a frame or dropout of the vehicle.

Embodiment 52. The transmission system according to any of embodiments 40-51, wherein the tensioner is configured to rotate with respect to a frame or dropout of the vehicle.

Embodiment 53. The transmission system according to embodiment 52, comprising a damper for damping a rotating of the tensioner with respect to the frame or dropout in at least one rotational direction, or in both rotational directions.

Embodiment 54. The transmission system according to any of embodiments 40-53, wherein the tensioner is configured to allow removal of a driven wheel from the vehicle.

Embodiment 55. The transmission system according to any of the preceding embodiments, the first transmission having a planet carrier carrying a stepped planet gear with a plurality of planet radii, a plurality of sun gears respectively cooperating with the plurality of planet radii, and a ring gear cooperating with at least one of the plurality of planet radii.

Embodiment 56. The transmission system according to embodiment 55, comprising a switching mechanism arranged for being adjustable between a first state for establishing a torque transmission path from the transmission system input to the ring gear and from the planet carrier to the transmission system output, and a second state for establishing a torque transmission path from the transmission system input to the planet carrier and from the ring gear to the transmission system output.

Embodiment 57. The transmission system according to any of the preceding embodiments, wherein the multi-speed second transmission is a two-speed transmission, selectively operable according to exactly two transmission ratios.

Embodiment 58. The transmission system according to any of the preceding embodiments, wherein the transmission ratio step size of the first transmission is between 18-40%.

Embodiment 59. The transmission system according to any of the preceding embodiments, wherein the transmission ratio step size of the second transmission is between 5-20%.

Embodiment 60. The transmission system according to any of the preceding embodiments, wherein the first transmission has a range of 300-600%, in particular 450-600%.

Embodiment 61. The transmission system according to any of the preceding embodiments, wherein the first transmission includes a speed reducing and/or a speed increasing transmission ratio, preferably both a speed reducing and speed increasing transmission ratio.

Embodiment 62. The transmission system according to any of the preceding embodiments, wherein the first transmission includes a 1:1 ratio.

Embodiment 63. The transmission system according to any of the preceding embodiments, wherein the second transmission includes a speed reducing and/or a speed increasing transmission ratio, preferably a 1:1 and a speed increasing transmission ratio.

Embodiment 64. The transmission system according to any preceding embodiment, wherein the second transmission comprises a planetary gear set.

Embodiment 65. The transmission system according to any preceding embodiment, wherein the second transmission comprises a continuously variable transmission, CVT.

Embodiment 66. The transmission system according to embodiment 65, wherein the CVT has a ratio-coverage similar to or smaller than the step-size between two adjacent transmission ratios of the first transmission.

Embodiment 67. The transmission system according to embodiment 65 or 66, wherein the CVT is of ratcheting type.

Embodiment 68. The transmission system according to embodiment 65, 66 or 67, wherein the CVT is concentric with the crank axle.

Embodiment 69. The transmission system according to any of embodiments 65-68, wherein the continuously variable transmission is controlled to be operated according to a plurality of predetermined discrete transmission ratios.

Embodiment 70. The transmission system according to any preceding embodiment, wherein the second transmission is selectively operable according to two different transmission ratios, optionally including at least a unitary transmission ratio.

Embodiment 71. The transmission system according to embodiment 70, wherein the first transmission and the second transmission are both accommodated by a rear wheel hub shell, or are both accommodated by a crank housing.

Embodiment 72. The transmission system according to any of the preceding embodiments, wherein the first transmission and the second transmission are accommodated by separate housings.

Embodiment 73. The transmission system according to embodiment 72, wherein one of the first transmission and the second transmission is accommodated by a rear wheel hub shell and another one of the first transmission and the second transmission is accommodated by a crank housing.

Embodiment 74. The transmission system according to any preceding embodiment as far as dependent from embodiment 10, wherein the sprockets are included by a cassette.

Embodiment 75. The transmission system according to any preceding embodiment, wherein the sprockets, e.g. the cassette, are axially movable relative to first transmission for shifting the endless drive member, such as the chain or belt, from one sprocket to the other.

Embodiment 76. The transmission system according to any preceding embodiment, wherein the first and/or second transmission is electrically actuated.

Embodiment 77. The transmission system according to embodiment 76, wherein the first and second transmission are independently electrically actuated.

Embodiment 78. The transmission system according to any preceding embodiment, comprising an electro-mechanical gear changing mechanism for actuating the first transmission and/or the second transmission to shift from one transmission ratio to another, preferably wherein the first transmission and the second transmission are independently actuatable.

Embodiment 79. The transmission system according to any preceding embodiment, wherein the first transmission is operatively arranged in a transmission path between the transmission system input and an input of the second transmission.

Embodiment 80. The transmission system according to any of embodiments 1-78, wherein the first transmission is operatively arranged in a transmission path between an output of the second transmission and the transmission system output.

Embodiment 81. The transmission system according to any preceding embodiment, as far as dependent from embodiment 56, wherein the switching mechanism comprises a first actuatable clutch in a transmission path between the transmission input and the planet carrier, and a first freewheel in a transmission path between the input and the ring gear; and a second actuatable clutch in a transmission path between the ring gear and the output, and a second freewheel in a transmission path between the planet carrier and the output.

Embodiment 82. The transmission system according to embodiment 81, wherein in the first state, the first actuatable clutch and the second actuatable clutch are both in an unclutched state, and wherein in the second state, the first actuatable clutch and the second actuatable clutch are both in a clutched state for transmitting torque in at least one rotation direction.

Embodiment 83. The transmission system according to any preceding embodiment, as far as dependent from embodiment 55, comprising a clutch mechanism arranged for selectively clutching at least one of the plurality of sun gears to a stationary axle, and preferably an actuation member for actuating the clutch mechanism, wherein the actuation member is movably accommodated in the stationary axle.

Embodiment 84. The transmission system according to embodiment 83, wherein the clutch mechanism comprises at least one actuatable bidirectional clutch mechanism arranged for being selectively actuated to a first disposition for preventing rotation of a selective one of the plurality of sun gears in a first rotational direction, and to a second disposition for preventing rotation of the selective one sun gear in a second, reverse, rotational direction.

Embodiment 85. The transmission system according to embodiment 84, wherein the at least one actuatable bidirectional clutch mechanism in the first disposition allows freewheeling of the selective one sun gear in the second rotational direction.

Embodiment 86. The transmission system according to embodiment 84 or 85, wherein the at least one actuatable bidirectional clutch mechanism in the second disposition allows freewheeling of the selective one sun gear in the first rotational direction.

Embodiment 87. The transmission system according to any of embodiments 84-86, wherein the at least one actuatable bidirectional clutch mechanism is arranged for selectively being in a third disposition for allowing rotation of the sun gear relative to the stationary axle in the first and in the second rotational direction.

Embodiment 88. The transmission system according to any of embodiments 84-87, wherein the first transmission comprises N sun gears, and wherein the clutch mechanism comprises N or N−1 actuatable bidirectional clutch mechanisms.

Embodiment 89. The transmission system according to any of embodiments 83-88, wherein the clutch mechanism comprises a passive bidirectional clutch arranged for being passively adjustable between a first disposition for clutching a predetermined one of the plurality of sun gears to the stationary axle in a first rotational direction, and a second disposition for clutching the predetermined one sun gear to the stationary axle in a second, reverse, rotational direction.

Embodiment 90. The transmission system according to embodiment 89, wherein the passive bidirectional clutch in the first disposition allows freewheeling of the predetermined one sun gear in the second rotational direction, and wherein the passive bidirectional clutch in the second disposition allows freewheeling of the predetermined one sun gear in the first rotational direction.

Embodiment 91. The transmission system according to any of embodiments 55-90, wherein the first transmission comprises at least three sun gears cooperating with a respective plurality of planet radii of the planet gear.

Embodiment 92. The transmission system according to any preceding embodiment, wherein the first transmission and/or the second transmission is/are configured for upshifting and downshifting under load.

Embodiment 93. The transmission system according to any of the preceding embodiments, comprising a control unit configured to upshift and/or downshift the transmission system.

Embodiment 94. The transmission system according to embodiment 93, wherein the control unit is configured to upshift and/or downshift the transmission system to the next higher or next lower system transmission ratio according to an upshift sequence through the system transmission ratios, and/or a downshift sequence through the system transmission ratios.

Embodiment 95. The transmission system according to embodiment 94, wherein the upshift and/or downshift sequence comprises a synchronous shift step of synchronously changing the transmission ratio of the first transmission and the transmission ratio of the second transmission; and a non-synchronous shift step of selectively changing either the transmission ratio of the first transmission or the transmission ratio of the second transmission.

Embodiment 96. The transmission system according to embodiment 95, wherein the upshift and/or downshift sequence comprises alternatingly the synchronous shift step and the non-synchronous shift step.

Embodiment 97. The transmission system according to any of embodiments 93-95, wherein the control unit is configured to operate in a manual shifting mode, in which the control unit is configured to upshift and/or downshift the transmission system in response to receiving a user-initiated upshift and/or downshift command.

Embodiment 98. The transmission system according to embodiment 97, wherein the control unit is configured to, in the manual shifting mode, upshift and/or downshift the first transmission in response to a user-initiated upshift and/or downshift command received from a first shifter, and to upshift and/or downshift the second transmission in response to a user-initiated upshift and/or downshift command received from a second shifter.

Embodiment 99. The transmission system according to any of embodiments 93-98, wherein the control unit is configured to operate in an automatic shifting mode, in which the control unit is configured to automatically upshift and/or downshift the transmission system in response to determining a difference between a measured cadence and a target cadence.

Embodiment 100. The transmission system according to embodiment 99, wherein the control unit is configured to, in the automatic shifting mode, determine to execute a fast automatic shifting mode if a measured acceleration of the vehicle is higher than a predetermined acceleration threshold or to execute a slow automatic shifting mode if the measured acceleration of the vehicle is lower than the predetermined acceleration threshold.

Embodiment 101. The transmission system according to embodiment 100, wherein the control unit is configured to, in the fast automatic shifting mode, automatically upshift and/or downshift the transmission system in response to determining a difference between a measured cadence and a target cadence, by skipping system transmission ratios by only actuating the first transmission.

Embodiment 102. The transmission system according to embodiment 101, wherein the control unit is configured to, in the fast automatic shifting mode, actuate the second transmission for fine-tuning the measured cadence towards the target cadence.

Embodiment 103. The transmission system according to embodiment 100, 101 or 102, wherein the control unit is configured to, in the slow automatic shifting mode, automatically upshift and/or downshift the transmission system in response to determining a difference between a measured cadence and a target cadence, by not skipping system transmission ratios.

Embodiment 104. The transmission system according to any of embodiments 93-103, wherein the control unit is configured to operate in a semi-automatic shifting mode, in which the control unit is configured to upshift the first and/or second transmission in response to user-initiated upshift commands, and to automatically downshift the transmission system in response to determining a difference between a measured cadence and a target cadence.

Embodiment 105. The transmission system according to embodiment 104, wherein the control unit is configured to, in the semi-automatic shifting mode, automatically downshift the transmission system in response to determining a difference between a measured cadence and a target cadence, by skipping system transmission ratios by only actuating the first transmission.

Embodiment 106. Derailleur for an endless drive member, and configured to be mounted to a frame of a human-powered vehicle or light electric vehicle, such as a bicycle, comprising:

a base member, and a derailleur wheel and/or chain guide mounted to the base member rotatable about an axis, wherein the derailleur wheel and/or chain guide is axially movable along its axis.

Embodiment 107. The derailleur according to embodiment 106, wherein the derailleur is configured for moving the derailleur wheel and/or chain guide between at least two and at most four axial positions.

Embodiment 108. The derailleur according to embodiment 106 or 107, wherein the derailleur wheel and/or chain guide is movable in axial direction between two end positions.

Embodiment 109. The derailleur according to embodiment 106, 107 or 108, wherein a force for movement of the derailleur wheel and/or chain guide in axial direction is created by a rotation of the derailleur wheel.

Embodiment 110. The derailleur according to any of embodiments 106-109, wherein movement of the derailleur wheel in axial direction is initiated by an electric actuator.

Embodiment 111. The derailleur according to embodiment 110, wherein the electric actuator is configured to be wirelessly controlled.

Embodiment 112. The derailleur according to embodiment 110 or 111, wherein the electric actuator is powered by an electric power storage element, such as a battery or an ultra-capacitor.

Embodiment 113. The derailleur according to embodiment 102, comprising a solar cell electrically connected to the electric power storage element for charging the electric power storage element.

Embodiment 114. The derailleur according to any of embodiments 106-113, comprising a tensioner for tensioning the endless drive member.

Embodiment 115. The derailleur according to embodiment 114, wherein the tensioner includes the derailleur wheel.

Embodiment 116. The derailleur according to embodiment 115, wherein the tensioner is the derailleur wheel.

Embodiment 117. The derailleur according to embodiment 115 or 116, wherein the tensioner includes a tensioning wheel rotatable about an axis.

Embodiment 118. The derailleur according to embodiment 115 and 117, wherein at least one of the derailleur wheel and the tensioning wheel is movable in axial direction.

Embodiment 119. The derailleur according to any of embodiments 106-118, wherein the base member is movable in axial direction of the derailleur wheel.

Embodiment 120. The derailleur according to any of embodiments 106-119, wherein the base member is rotatable with respect to the frame.

Embodiment 121. The derailleur according to any of embodiments 110-120, wherein the electric actuator is connected to the base member.

Embodiment 122. The derailleur according to any of embodiments 117-121, wherein the tensioning wheel is rotatably mounted to the base member.

Embodiment 123. The derailleur according to any of embodiments 106-122, wherein the derailleur wheel and the tensioning wheel have between 10 and 20, preferably between 12 and 18, teeth.

Embodiment 124. The derailleur according to any of embodiments 114-123, wherein the tensioner is configured to be connected to a frame or dropout of the vehicle.

Embodiment 125. The derailleur according to any of embodiments 114-124, wherein the tensioner is configured to rotate with respect to a frame or dropout of the vehicle.

Embodiment 126. The transmission system according to embodiment 125, comprising a damper for damping a rotating of the tensioner with respect to the frame or dropout in at least one rotational direction, or in both rotational directions.

Embodiment 127. The transmission system according to any of embodiments 114-126, wherein the tensioner is configured to allow removal of a driven wheel from the vehicle.

Embodiment 128. A human-powered vehicle or light electric vehicle, such as a bicycle, comprising a transmission system according to any of embodiments 1-105, and/or a derailleur according to any of embodiments 106-127.

Embodiment 129. A method for shifting a transmission according to any of embodiments 1-105 from a current system transmission ratio to a target system transmission ratio, wherein the first transmission is selectively operable according to N different first transmission ratios, wherein the second transmission is selectively operable according to M different second transmission ratios, and wherein the transmission system is selectively operable according to N*M different system transmission ratios; the method comprising:
successively upshifting or downshifting the first transmission through the first transmission ratios by a first integer number of transmission ratio steps,
successively upshifting or downshifting the second transmission through the second transmission ratios by a second integer number of transmission ratio steps,
wherein for any current system transmission ratio and for any target system transmission ratio within the N*M system transmission ratios, the second integer number is at most M−1.

Embodiment 130. The method according to embodiment 129, wherein the second transmission is upshifted or downshifted by the second integer number of steps, after the first transmission has been upshifted or downshifted by the first integer number of steps, or vice versa.

Embodiment 131. The method according to any of embodiments 129-130, comprising receiving a first operational shifter input for controlling a selection of gears of the first transmission and receiving a second operational shifter input for controlling the selection of gears of both the first and second transmission.

Embodiment 132. The method according to embodiment 131, including always alternating the gear selection between the two gears of the second transmission at every gear shift in response to the second operational shifter input.

Embodiment 133. The method according to embodiment 132, further comprising simultaneously controlling the first transmission in response to the, e.g. every other, second operational shifter input.

Embodiment 134. The method according to any of embodiments 131-133, wherein, the first and second operational shifter are separate shifting units

Embodiment 135. The method according to any of embodiments 131-134, wherein, the first and second operational shifter are one integrated shifting unit

Embodiment 136. The method according to any of embodiments 131-135, wherein, the first and second operational shifter each have a neutral position and two opposite actuation positions.

Embodiment 137. The method according to any of embodiments 131-136, wherein, the first and second operational shifter are biased towards the neutral position.

Embodiment 138. The method according to any of embodiments 129-137, comprising, in a manual shifting mode, upshift and/or downshift the transmission system in response to receiving a user-initiated upshift and/or downshift command.

Embodiment 139. The method according to embodiment 138, comprising, in the manual shifting mode, upshift and/or downshift the first transmission in response to a first operational shifter input, and upshift and/or downshift the second transmission in response to a second operational shifter input.

Embodiment 140. The method according to any of embodiments 129-139, comprising, in an automatic shifting mode, automatically upshifting and/or downshifting the transmission system in response to determining a difference between a measured cadence and a target cadence.

Embodiment 141. The method according to embodiment 140, comprising, in the automatic shifting mode, executing a fast automatic shifting mode if a measured acceleration of the vehicle is higher than a predetermined acceleration threshold, and executing a slow automatic shifting mode if the measured acceleration of the vehicle is lower than the predetermined acceleration threshold.

Embodiment 142. The method according to embodiment 141, comprising, in the fast automatic shifting mode, automatically upshifting and/or downshifting the transmission system in response to determining a difference between a measured cadence and a target cadence, by skipping system transmission ratios by only actuating the first transmission.

Embodiment 143. The method according to embodiment 142, comprising, in the fast automatic shifting mode, actuating the second transmission for fine-tuning the measured cadence towards the target cadence.

Embodiment 144. The method according to embodiment 141, 142 or 143, comprising, in the slow automatic shifting mode, automatically upshift and/or downshift the transmission system in response to determining a difference between a measured cadence and a target cadence, by not skipping any system transmission ratios.

Embodiment 145. The method according to any of embodiments 129-144, comprising, in a semi-automatic shifting mode, upshifting the first and/or second transmission in response to user-initiated upshift commands, and automatically downshifting the transmission system in response to determining a difference between a measured cadence and a target cadence.

Embodiment 146. The method according to embodiment 145, comprising, in the semi-automatic shifting mode, automatically downshifting the transmission system in response to determining a difference between a measured cadence and a target cadence, by skipping system transmission ratios by only actuating the first transmission.

Embodiment 147. The method according to embodiment 146, comprising, when automatically downshifting, actuating the second transmission for fine-tuning the measured cadence towards the target cadence.

Embodiment 148. A method for shifting a transmission system to a target transmission ratio, the transmission system comprising a first transmission and a second transmission in series, wherein the first transmission is configured to switch between a plurality of discrete transmission ratios having a step-size between adjacent transmission ratios, and wherein the second transmission is a continuously variable transmission, CVT, having a ratio-coverage similar to or smaller than the step-size, the method comprising:
shifting the first transmission to a transmission ratio that deviates from the target transmission ratio by less than the ratio-coverage of the CVT;
determining a deviation ratio of the target transmission ratio divided by the transmission ratio set by the first transmission; and
shifting the CVT to the deviation ratio.

Embodiment 149. The method of embodiment 148, wherein the transmission ratio set by the first transmission is always smaller than, or equal to, the target transmission ratio.

Embodiment 150. The method of embodiment 148 or 149, comprising, in a first mode, when shifting to the target transmission ratio requires shifting multiple steps of the first transmission, refraining from shifting the CVT while shifting the multiple steps of the first transmission.

Embodiment 151. The method of embodiment 148, 149 or 150, comprising, in a second mode, when shifting to the target transmission ratio requires shifting multiple steps of the first transmission, shifting the CVT between shifting each two adjacent steps of the multiple steps of the first transmission, so as to obtain a continuous transmission ratio change.

Embodiment 152. The method according to embodiment 150 and 151, comprising, executing the first mode if a measured acceleration of the vehicle is higher than a predetermined acceleration threshold, and executing the second mode if the measured acceleration of the vehicle is lower than the predetermined acceleration threshold.

Embodiment 153. The method according to any of embodiments 148-152, comprising measuring a cadence and a vehicle speed, and automatically maintaining the measured cadence at a target cadence, or at least within a target cadence interval, by automatically renewing the target transmission ratio on the basis of the measured cadence and vehicle speed.

It will be appreciated that methods defined herein as having certain steps, may encompass additional steps not specifically recited herein.

Although the invention has been explained further herein using examples of embodiments and drawings, these do not limit the scope of the invention as defined by the claims. Within said scope, many variations, combinations and extensions are possible, as will be appreciated by the skilled person.

For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1-31. (canceled)

32. A transmission system comprising:
a multi-speed first transmission operative between a transmission system input and a transmission system output; and
a multi-speed second transmission connected in series with the first transmission;
wherein a ratio-coverage of the first transmission is larger than a ratio-coverage of the second transmission;
wherein a transmission ratio step size between successive transmission ratios of the second transmission is smaller than a transmission ratio step size between successive transmission ratios of the first transmission; and
wherein the first transmission and the second transmission are configured for a human-powered vehicle or light electric vehicle.

33. The transmission system of claim 32, wherein the second transmission is non-coaxial with the first transmission.

34. The transmission system of claim 32, wherein the second transmission includes at least one of an offset gear transmission, a belt or chain transmission, a continuously variable transmission, a derailleur and sprockets, or a planetary gear system having a central axis offset relative to a central axis of the first transmission.

35. The transmission system of claim 32, wherein the first transmission includes a planetary gear system having three or more sun gears.

36. The transmission system of claim 32, wherein the first transmission has more different ratios than the second transmission.

37. The transmission system of claim 32, wherein the first transmission has at least four different ratios, and the second transmission has at most four different ratios.

38. The transmission system according to claim 32, wherein the first transmission comprises or is an integrated hub transmission, or is integrated in a crank unit.

39. The transmission system according to claim 32, wherein the second transmission comprises two to four sprockets and an endless drive member selectively engaged with either one of the sprockets, or the second transmission is integrated in a crank unit.

40. The transmission system according to claim 39, comprising at least one of a derailleur wheel or chain guide, which can be actuated to shift the endless drive member from one of the sprockets to another of the sprockets.

41. The transmission system according to claim 40, wherein the sprockets are axially movable relative to first transmission to shift the endless drive member from the one of the sprockets to the other of the sprockets.

42. The transmission system according to claim 32, wherein the ratio-coverage of the first transmission is at least 450%.

43. The transmission system according to claim 32, wherein the transmission ratio step size of the first transmission is between 18-40%, and the transmission ratio step size of the second transmission is between 5-20%.

44. The transmission system according to claim 32, wherein the second transmission comprises a continuously variable transmission (CVT) controlled to be operated according to a plurality of predetermined discrete transmission ratios, and having a ratio-coverage similar to or smaller than the transmission ratio step size between two adjacent transmission ratios of the first transmission.

45. The transmission system according to claim 32, wherein at least one of the first transmission or the second transmission is configured for upshifting and downshifting under load.

46. The transmission system according to claim 32, further comprising a control unit configured to at least one of upshift or downshift the transmission system.

47. The transmission system according to claim 46, wherein the control unit is configured to at least one of upshift or downshift the transmission system to a next higher or next lower system transmission ratio according to at least one of an upshift sequence through system transmission ratios, or a downshift sequence through the system transmission ratios, wherein the at least one of the upshift or downshift sequence comprises a synchronous shift step of synchronously changing the transmission ratio of the first transmission and the transmission ratio of the second transmission; and a non-synchronous shift step of selectively changing either the transmission ratio of the first transmission or the transmission ratio of the second transmission.

48. The transmission system according to claim 47, wherein the at least one of the upshift or downshift sequence comprises alternating the synchronous shift step and the non-synchronous shift step.

49. The transmission system according to claim 46, wherein the control unit is configured to operate in an automatic shifting mode, in which the control unit is configured to automatically at least one of upshift or downshift the transmission system in response to determining a difference between a measured cadence and a target cadence.

50. The transmission system according to claim 49, wherein the control unit is configured to:
in the automatic shifting mode, determine at least one of:
to execute a fast automatic shifting mode in response to a measured acceleration of the vehicle being higher than a predetermined acceleration threshold, or
to execute a slow automatic shifting mode in response to the measured acceleration of the vehicle being lower than the predetermined acceleration threshold,
in the fast automatic shifting mode, at least one of automatically upshift or downshift the transmission system, by skipping system transmission ratios by only actuating the first transmission, in response to determining a difference between the measured cadence and the target cadence,
in the fast automatic shifting mode, actuate the second transmission for fine-tuning the measured cadence towards the target cadence, and
in the slow automatic shifting mode, at least one of automatically upshift or downshift the transmission system by not skipping system transmission ratios in response to determining the difference between the measured cadence and the target cadence.

51. The transmission system according to claim 46, wherein the control unit is configured to operate in a semi-automatic shifting mode, in which the control unit is configured to upshift at least one of the first transmission or the second transmission in response to user-initiated upshift commands, and to automatically downshift the transmission system in response to determining a difference between a measured cadence and a target cadence.

52. A human-powered vehicle or light electric vehicle comprising the transmission system according to claim 32.
